(19) United States
(12) Patent Application Publication
(10) Pub. No.: US 2008/0071633 A1
(43) Pub. Date: Mar. 20, 2008

(54) Subscriber management system and method

(76) Inventors: Emrah Ozkan, Vienna, VA (US); Ibraz Anwar, Ashburn, VA (US); Nancy Dube, Herndon, VA (US); Ingrid Lustig, Koln (DE)

Correspondence Address: KED & ASSOCIATES, LLP, P.O. Box 221200, Chantilly, VA, 20153-1200, US

(21) Appl. No.: 11/727,174

(22) Filed: Mar. 23, 2007

Related U.S. Application Data
(60) Provisional application No. 60/785,284, filed on Mar. 24, 2006.

(51) Int. Cl. G06Q 30/00

(52) U.S. Cl. 705/26

(57) ABSTRACT

A subscriber management system controls the real-time supply of multimedia information from one or more home countries to a target country. The system includes a memory to store a plurality of software modules, an interactive web-based application, and a processing subsystem to manage supply of the multimedia information from the home countries to subscribers in the target country. The processing subsystem integrates the functionality of the software modules to control all phases of service including setup, shipping, installation, billing, and subscriber termination for non-payment, if necessary.

### RELATED APPLICATIONS

This application claims benefit to U.S. Provisional Patent Application Ser. No. 60/785,284, filed on Mar. 24, 2006, the contents of which are incorporated herein by reference.

### FIELD

The present invention relates to information management systems, and more particularly to a system and method for managing subscriber services for providing multimedia content over one or more communications networks.

### BACKGROUND

Traditionally, programming from other countries was only provided in the U.S. in recorded form (e.g., on video tape) for playback at a later date. These services have not been provided in real-time, and certainly not based on the selection of subscriber preferences. Persons of other countries (e.g., immigrants, foreign citizens, employees on work visas, etc.) have therefore been at a substantial disadvantage in being able to view programs from their home countries. Moreover, while various subscriber services exist in the United States for viewing domestic multimedia programming, no existing subscriber system is available which integrates the full complement of services and information management functions required to control the supply of multimedia content from different countries of the world into the U.S.

### SUMMARY OF THE INVENTION

The present invention is a system and method for managing subscriber services that include providing multimedia content over one or more communications networks. The invention is especially well-suited to manage the real-time supply of multimedia content emanating from one or more home countries in to a target country. This will advantageously allow persons who presently reside in the target country to view programs from their home countries.

In accordance with one embodiment, the subscriber management system and method may control access to ethnic pay television services operating on a direct-to-home (DTH) platform. Such a system will, for example, allow broadcasters from around the world to distribute their video and audio channels to ethnic audiences to the United States. While these channels are preferably provided in real-time, other embodiments contemplate near real-time or taped broadcast applications. The system may also provide content from so-called Free-to-Air programmers.

The multimedia content may correspond to individually selected channels from one or more home countries, or bundles of channels from the same or different countries depending on the preferences of the subscriber. In addition to television channel programming, the content to be managed by the system and method of the present invention includes occasional-use programming, special events, and pay-per-view programming. These services may be supplied directly from a satellite carrying the content, or indirectly through one or more a cable television system.

In alternative embodiments, the system and method may be modified to also provide multimedia content originating from the target country. This programming may be ordered and supplied individually (e.g., on a channel-by-channel basis), or in predetermined bouquets of channels including those from one or more of the home countries. The system may further be modified to provide IP TV services.

In terms of infrastructure, the system and method may receive content through a plurality of interconnected communication paths that include fiber-optic and satellite transoceanic transmissions that can access signals, for example, from any European and most Asian satellite locations. According to one embodiment, the path may include teleport facilities located in Europe, Asia, and the Middle East. The downlink and uplink, digitizing, and multiplexing equipment required to supply the content may have redundant back-up units that are available continuously.

### BRIEF DESCRIPTION OF THE DRAWINGS

FIG. 1 is a diagram showing an example of the how the subscriber management system of the present invention may be implemented.

FIG. 2 is a diagram showing how content providers in the home countries may supply programming signals through teleports integrated throughout the satellite communications network of FIG. 1.

FIG. 3 is a diagram showing an embodiment of the subscriber management system which integrates at least six functions related to providing multimedia content from home countries to the target country in accordance with the present invention.

FIG. 4 is a diagram showing an example of a login screen generated by the system.

FIG. 5 is a diagram showing an example of a home screen generated by the system.

FIG. 6 is a diagram showing an example of a login error screen generated by the system.

FIG. 7 is a diagram showing an example of an access rights screen generated by the system.

FIG. 8 is a diagram showing an example of a password change screen of the system.

FIG. 9 is a diagram showing an example of a customer add screen generated by the system.

FIG. 10 is a diagram showing an example of customer modify screen generated by the system.

FIG. 11 is a diagram showing an example of a customer search screen of the system.

FIG. 12 is a diagram showing an example of an add smart card screen of the system.

FIG. 13 is a diagram showing an example of another add smart card screen of the system.

FIG. 14 is a diagram showing an example of a smart card activation screen of the system.

FIG. 15 is a diagram showing an example of a smart card command log screen of the system.

FIG. 16 is a diagram showing an example of an assign smart card screen of the system.

FIG. 17 is a diagram showing an example of a smart card search screen of the system.

FIG. 18 is a diagram showing an example of a smart card management screen of the system.

FIG. 19 is a diagram showing an example of a smart card modify screen of the system.

FIG. 20 is a diagram showing an example of a channel management add screen of the system.

FIG. 21 is a diagram showing an example of a channel management modify screen of the system.

FIG. 22 is a diagram showing an example of another channel management modify screen of the system.

FIG. 23 is a diagram showing an example of modify channel screen generated by the system.

FIG. 24 is a diagram showing an example of another channel management modify screen of the system.

FIG. 25 is a diagram showing an example of a service center management modify screen of the system.

FIG. 26 is a diagram showing an example of a screen for managing service centers of the system.

FIG. 27 is a diagram showing an example of another service center management modify screen of the system.

FIG. 28 is a diagram showing an example of another service center management modify screen of the system.

FIG. 29 is a diagram showing of another service center management modify screen of the system.

FIG. 30 is a diagram showing an example of an equipment/weight matrix screen generated by the system.

FIG. 31 is a diagram showing an example of an equipment option modify screen of the system.

FIG. 32 is a diagram showing an example of a shipping matrix screen of the system.

FIG. 33 is a diagram showing an example of another shipping matrix screen of the system.

FIG. 34 is a diagram showing an example of another shipping matrix screen of the system.

FIG. 35 is a diagram showing an example of shipping cost management screen of the system.

FIG. 36 is a diagram showing an example of a shipping management screen of the system.

FIG. 37 is a diagram showing an example of a shipping modify screen of the system.

FIG. 38 is a diagram showing an example of an orders shipped screen of the system.

FIG. 39 is a diagram showing an example of an outstanding installation screen of the system.

FIG. 40 is a diagram showing an example of an installation modify screen of the system.

FIG. 41 is a diagram showing an example of an installation scheduling screen of the system.

FIG. 42 is a diagram showing an example of an installation history screen of the system.

FIG. 43 is a diagram showing an example of a print invoices screen generated by the system.

FIG. 44 is a diagram showing an example of a payments screen generated by the system.

FIG. 45 is a diagram showing an example of an administrative user add screen.

FIG. 46 is a diagram showing an example of a change administrative user screen of the system.

FIG. 47 is a diagram showing an example of a select channel screen generated by the system.

FIG. 48 is a diagram showing an example of a channel select screen generated by the system.

FIG. 49 is a diagram showing an example of an Authorize.net test transaction add screen generated by the system.

FIGS. 50(a) and 50(b) are diagrams showing an example of the software modules that may be included in one embodiment of the subscriber management system of the present invention, and which further shows a flow diagram showing steps included in one embodiment of a method for managing subscriber services in accordance with the present invention.

FIG. 51 is a diagram showing the structural features that may be included in one embodiment of a subscriber management system of the present invention.

### DETAILED DESCRIPTION

The present invention is a system and method for managing subscriber services that include providing multimedia content over one or more communications networks. The multimedia content includes audio files and video programming from one or more (“home”) countries supplied to another (“target”) country where traditionally such content is not available, or at least is not available on a real-time basis. For illustrative purposes, the following description of the system and method is provided in the case where the target country is the United States. However, those skilled in the art can appreciate that the target country may be any country in the world.

The system and method are preferably implemented using an interactive web-based application that coordinates virtually all phases of the subscriber-service management process through a graphical user interface. Through this application and its attendant software modules, subscriber information may be entered and searched in one or more system databases, subscriptions of subscribers may be managed continuously and on a real-time basis, customer service may be offered (e.g., through the telephone, e-mail, live chat, skype, or other means), orders may be tracked, and installation may be scheduled and managed, functions associated with customer fulfillment may be performed. In addition, the application may perform billing, collections, transactions, accounting, report generation, signal activation/deactivation, and channel management.

According to one embodiment, the following types of content may be managed by the system and method of the present invention: programming from television channels broadcast or otherwise provided by state or private entities in the one or more home countries; content (music, news, etc.) broadcast by radio stations in the one or more home countries; pay-per-view or on-demand sources that offer movies, sports, concerts, special events, etc., in the home countries; and/or Internet websites that transmit webcasts, downloads, streaming audio/video files, podcasts, etc., from those countries. The programming may be provided continuously and/or in real-time, or on a more limited time basis depending, for example, on the nature of the subscription.

Providing this content is considered to be extremely desirable by persons who, for example, are immigrants to the United States, naturalized citizens, employees of foreign countries that have work visas, persons visiting the United States on vacation or for business, or anyone else who takes an interest in the programming that is offered in countries other than the United States. Accordingly, the ability for a company to access a single system to manage these services to subscribers in the target country is advantageous from a convenience, cost, and administrative standpoint.

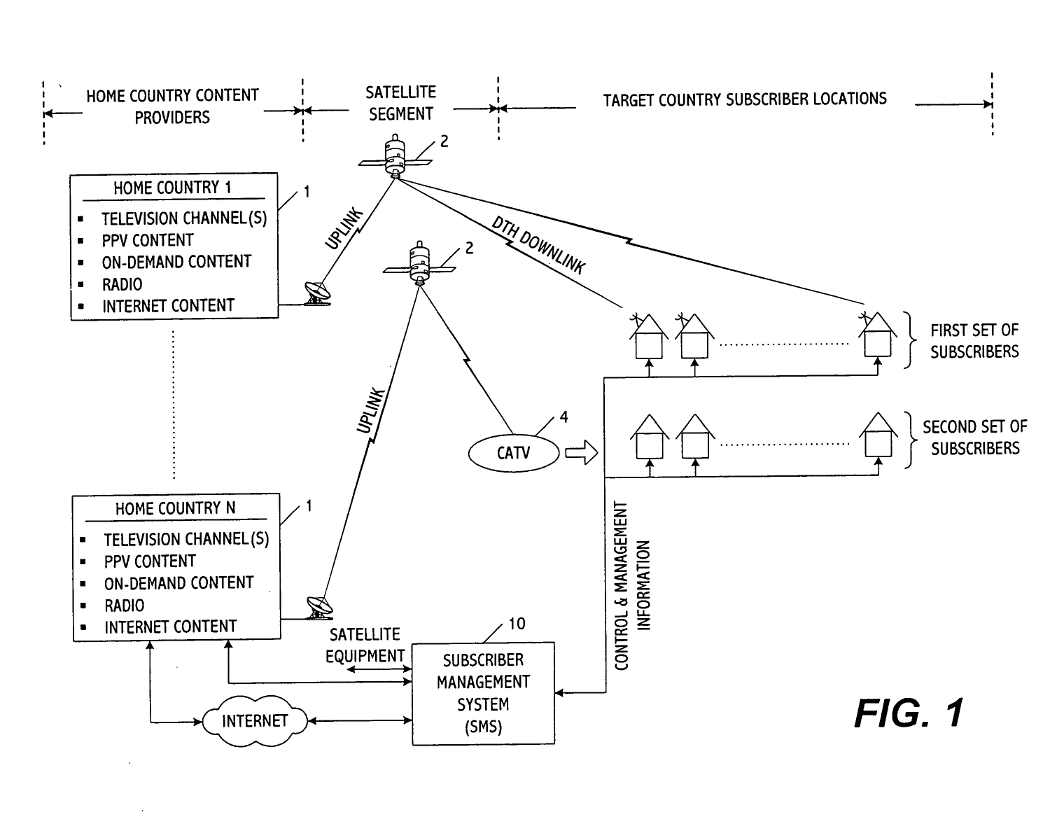

FIG. 1 shows an example of the how the subscriber management system of the present invention may be implemented. As shown in FIG. 1, the system 10 may be disposed between content providers 1 in one or more home countries and a plurality of subscriber locations in the target country. The content providers in each home country may provide programming from one or more television channels that may be individually selected by subscribers or are provided in predetermined channel bundles, or both, depending on the specific subscription purchased. Additionally, or alternatively, each content provider may provide radio, pay-per-view or on-demand, and/or Internet content supplied, for example, from one or more servers in a corresponding home country.

The subscriber locations are coupled to the content provider(s) in one or more home countries through a predetermined communications link. In a direct-to-home (DTH) or direct-broadcast-satellite (DBS) application, the communications link passes through one or more satellites 2 (e.g., an AMC-4 satellite provided by SES Americom at an lattitude of 101 degrees West) for direct broadcast to the subscriber locations (e.g., a first set of subscriber locations 3₁) in the target country. In a cable television (CATV) system application, the communications link may pass through a satellite along a path that leads to a cable television head end 4. The head end then re-transmits the content to the individual subscriber locations (e.g., a second set of subscriber locations 3₂) in the target country. The system may also be configured to provide IP TV services, either through a DTH or DBS signal path or a cable system headend.

The subscriber management system (SMS) is coupled to equipment at each subscriber location for managing the content supplied by the home-country providers. The physical connection may be, for example, a fiber-optic or coaxial cable or another type of connection. Preferably, the SMS bi-directionally communicates with equipment at the subscriber locations to perform the management services described herein. The subscriber equipment may include, for example, a set-top box (STB) equipped with circuits/software for demodulating, decrypting, and decoding the programming content either directly received from a satellite or through a cable head end. In a DTH or DBS application, each subscriber location may include a satellite dish and a low-noise amplifier and blocking (LNB) circuit in addition to the set-top box. All of this equipment may be programmed, installed, and activated in accordance with management functions performed by the SMS.

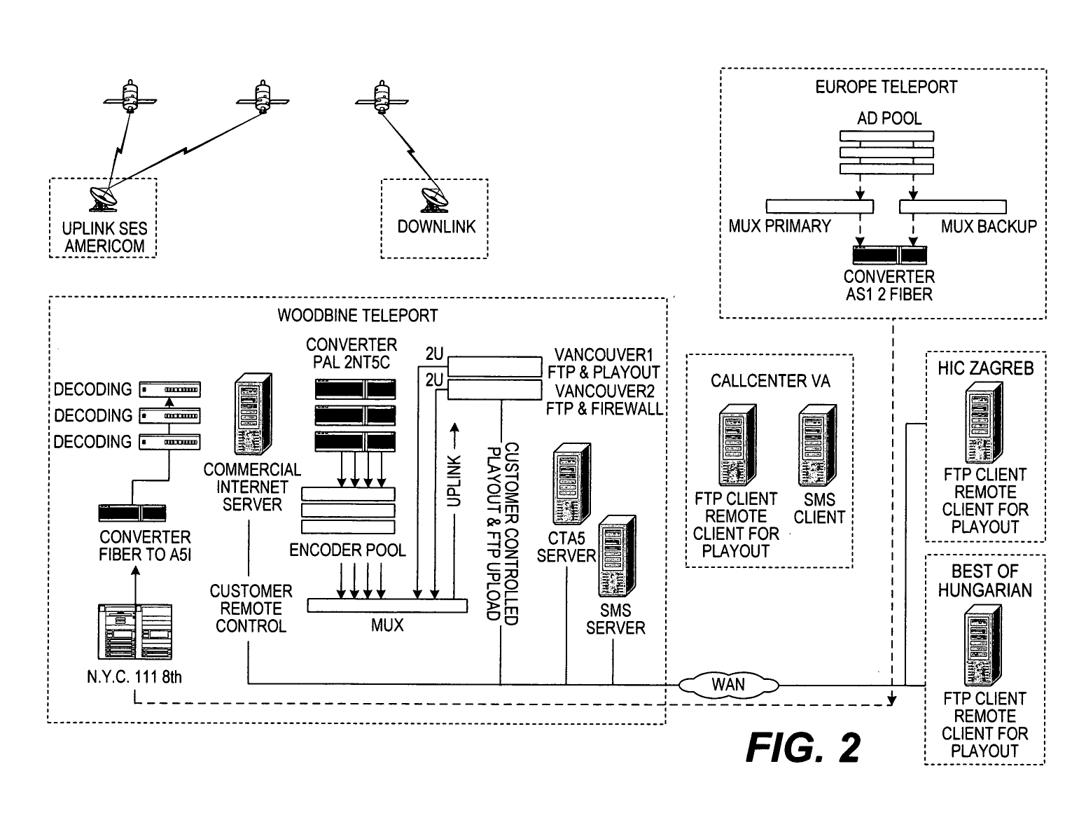

FIG. 2 shows an example of how content providers in the home countries may supply programming signals through teleports integrated throughout the satellite communications network of FIG. 1. In this example, a teleport 20 receives satellite signals in the target country and is equipped with hardware and software for performing decoding, decrypting, and signal conversion functions on the content in the received signals. The teleport equipment may be coupled to a call center 25 having operators capable of accessing the SMS system of the present invention. The call center may include one or more file transfer protocol (FTP) client servers 26 which interface with video server 27 and/or video processing equipment 28 at the teleport through a wide area network (e.g., the Internet) 29) for controlling the distribution and/or playback of video supplied by the content providers in the home countries.

As shown in FIG. 2, the FTP server in the call center may also be linked (e.g., via Internet) to teleports 30, 40, and 50 in other home countries for providing management services, to provide a redundant path for ensuring that the transmitted signal content reaches the subscriber locations, and/or for performing one or more other processing functions. The teleports in the home countries may also be directly linked to teleport 20 in the target country for performing various control and service management functions.

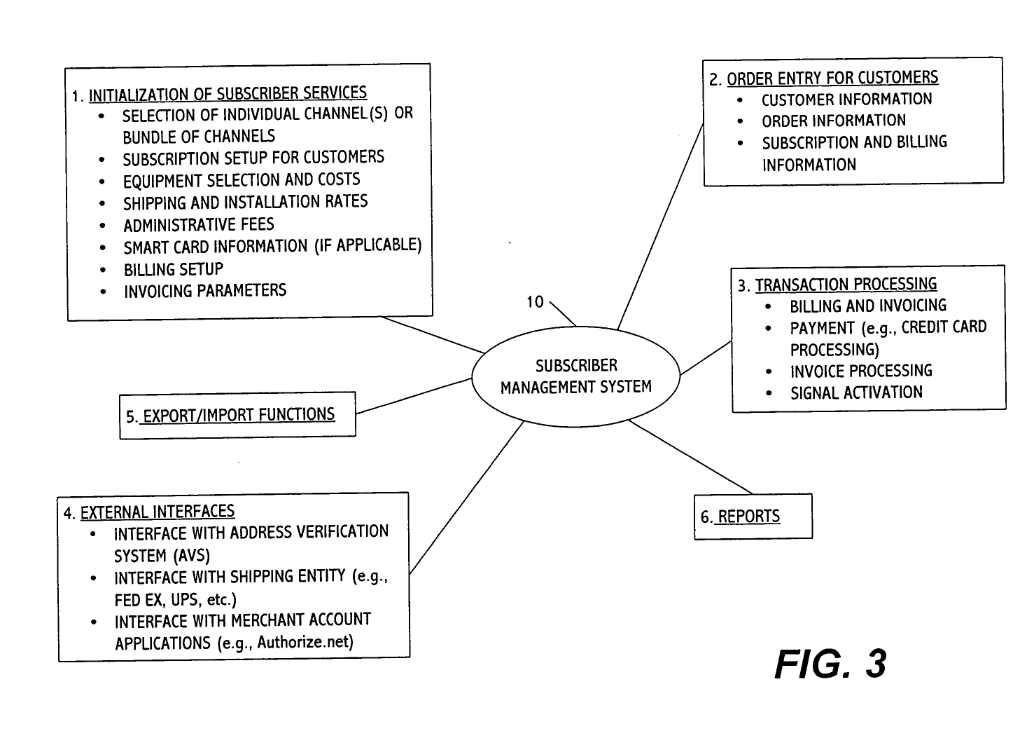

FIG. 3 shows a more detailed embodiment of the subscriber management system which integrates at least six functions related to providing multimedia content from home countries to the target country in accordance with the present invention. These functions include:

1. Initialization of Subscriber Services

a. Selection of channel(s), logo, contact information & other related information

b. Subscription-setup

c. Equipment costs for subscriber

d. Shipping and installation rates

e. Administrative fees

f. Smart Card Information (if applicable)

g. Billing setup

h. Invoicing parameters

2. Order Entry for Customers or Subscriber of Selected Channels

a. Customer information

b. Order Information

c. Subscription and billing information

3. Transaction Processing

a. Billing and invoicing

b. Payment (e.g., credit card) processing

c. Invoice posting

d. Signal activation

4. External Interfaces

a. Interface with Address Verification System (AVS)

b. Interface with shipping entity (e.g., Fed Ex, UPS)

c. Interface with Merchant Account applications (e.g., Authorize.net)

5. Export/Import Functions

6. Reports

The SMS is implemented by front-end software that generates a sequence of screens on a user graphical interface that allows a user to perform the management functions of the system described herein. Users may access the system through the aforementioned web-based application. The user may include an operator of the system (e.g., a call center operator), customer service personnel, a system administrator, or in some instances even the customer/end-user himself. For security purposes, different user classifications may be given different levels of access to system information and functions.

In providing system access, each channel/broadcaster in a home country may be assigned a specific number of user IDs and passwords that are recorded in the system. This information is always available to the system administrator to ensure the integrity of data. The following access levels may be made available for the SMS in preferably hierarchical form:

| User | Access Security Level |
|---|---|
| System Administrator | Highest level, access to all content, information, |
| | data and code |
| Corporate System | Next highest level - access to all applications |
| Administrator | |
| Channel Administrator | Highest for Channel - access to all broadcast |
| | screens, data overrides, etc. |
| Data Entry Operator | Specified Data Entry Screens only |
| Corporate Operator | Specified Data Entry Screens |
| Shipping Operator | Specified Data Entry Screens only |
| Installer Operator | Specified Data Entry Screens only |

In the above listing, the corporate system administrator or corporate operator may be an employee of a company (e.g., named Home2US throughout the drawings) that manages the database. The other operators or administrators may also be employed by this company or may be separate companies or personnel who work in tandem with the company to provide or enable the multimedia content managed by the SMS of the company.

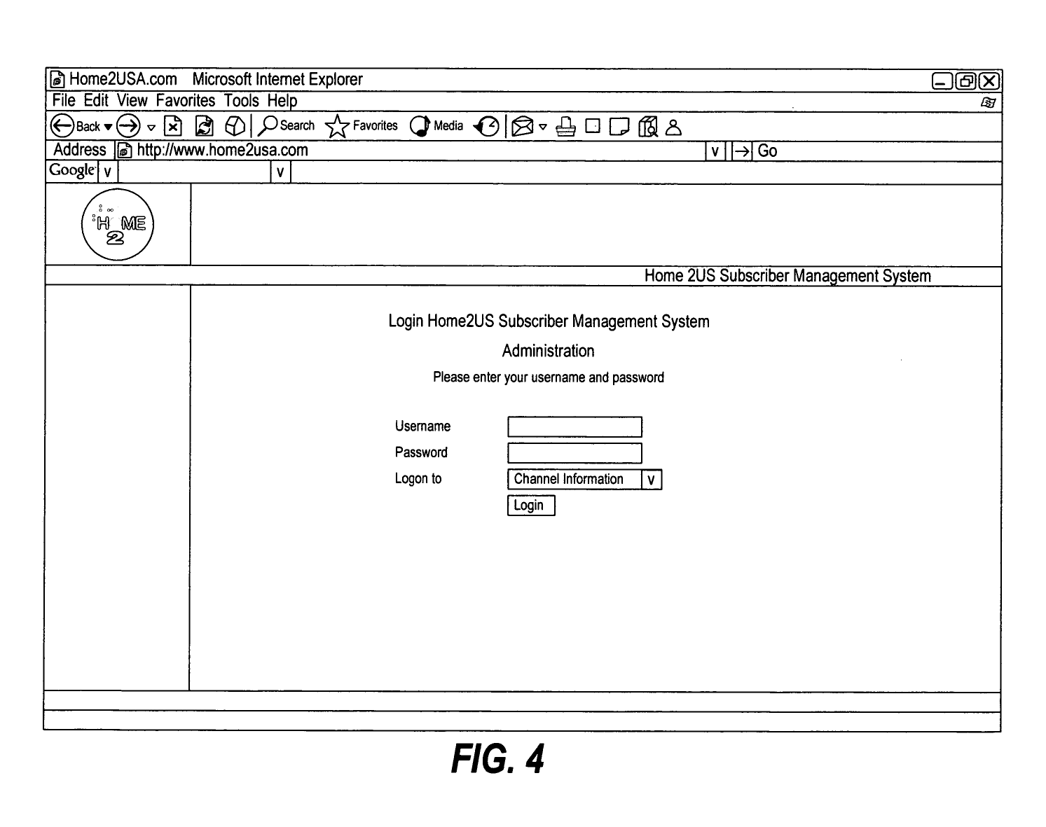

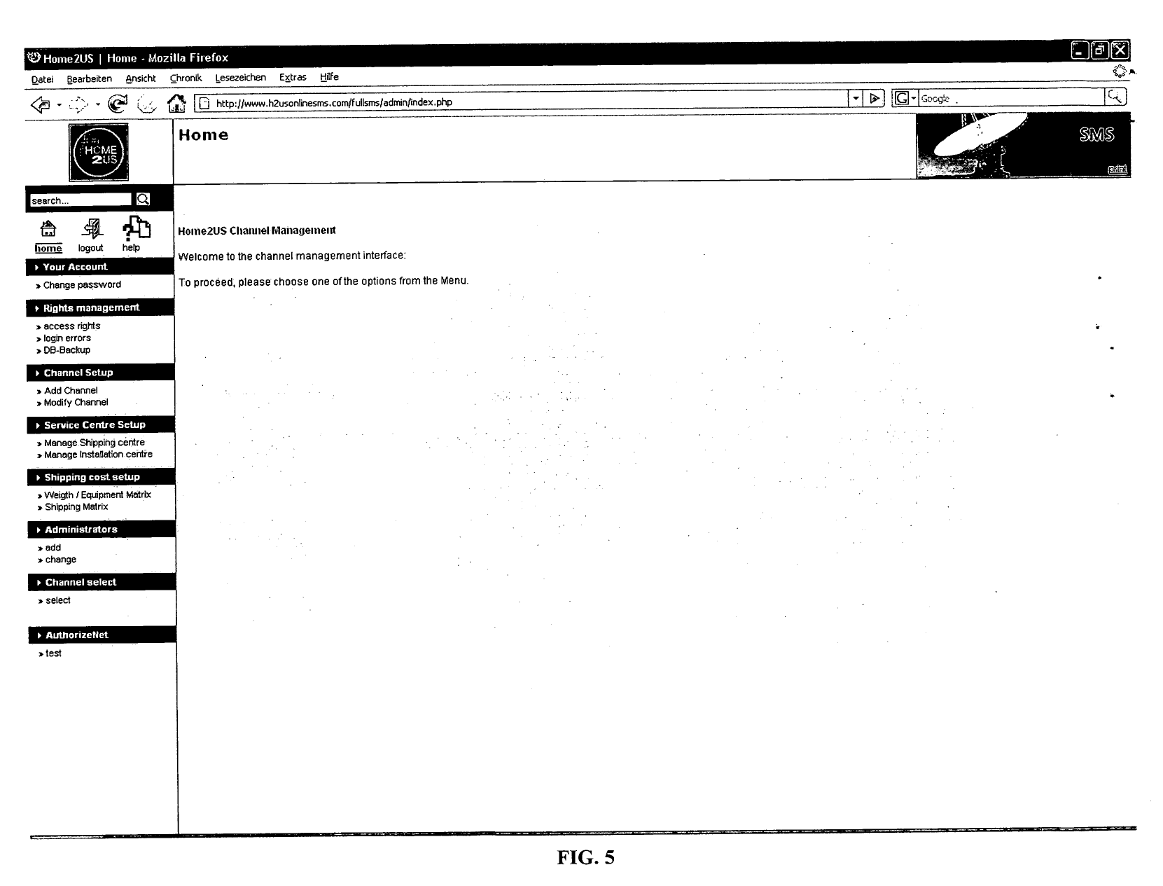

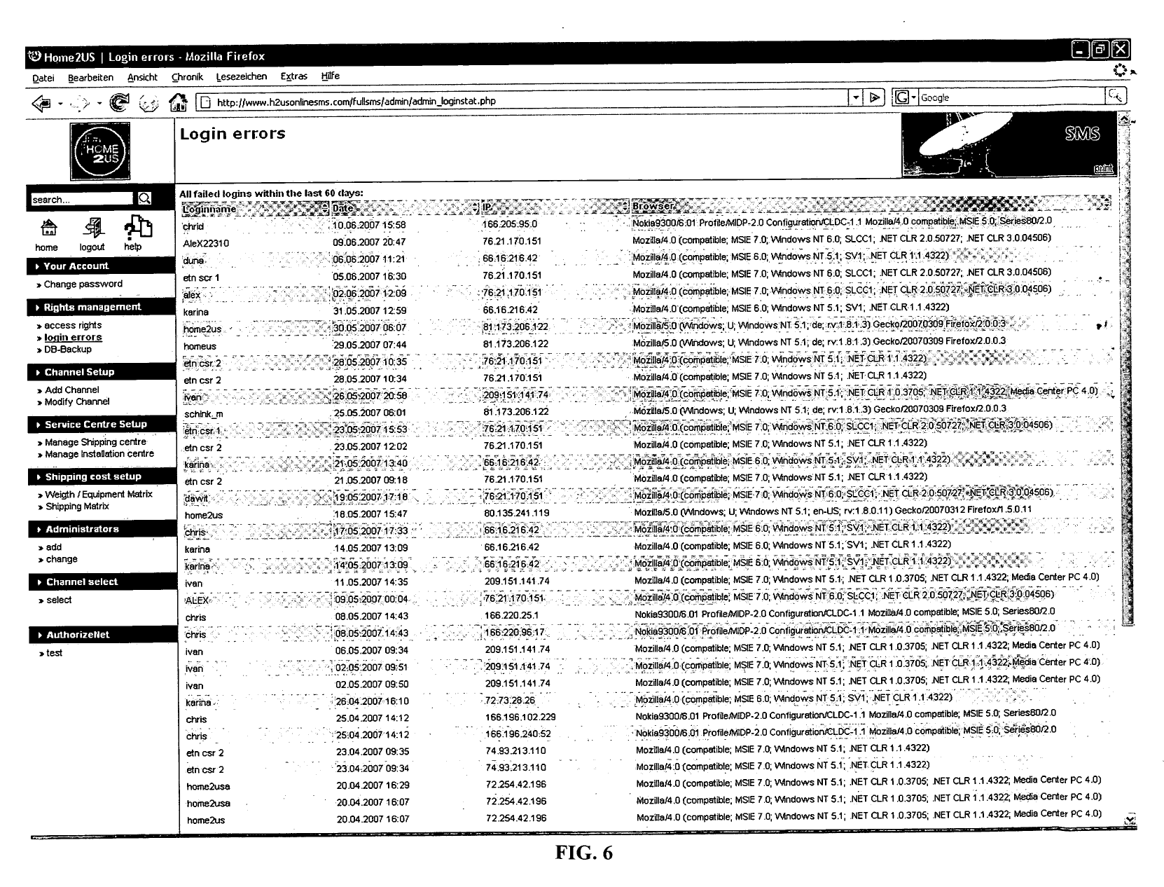

Login Procedure. To access the subscriber management system, the user must first enter the web address for the SMS system in an Internet browser installed at his or her system terminal. The user then enters a pre-assigned User ID and password in a Login Screen generated at this address. (See FIG. 4). The system software will validate the User ID and password and then direct the user to a main (or home) screen, as shown, for example, in FIG. 5. In so doing, system software may keep a record of login errors that occur, as shown, for example, in FIG. 6.

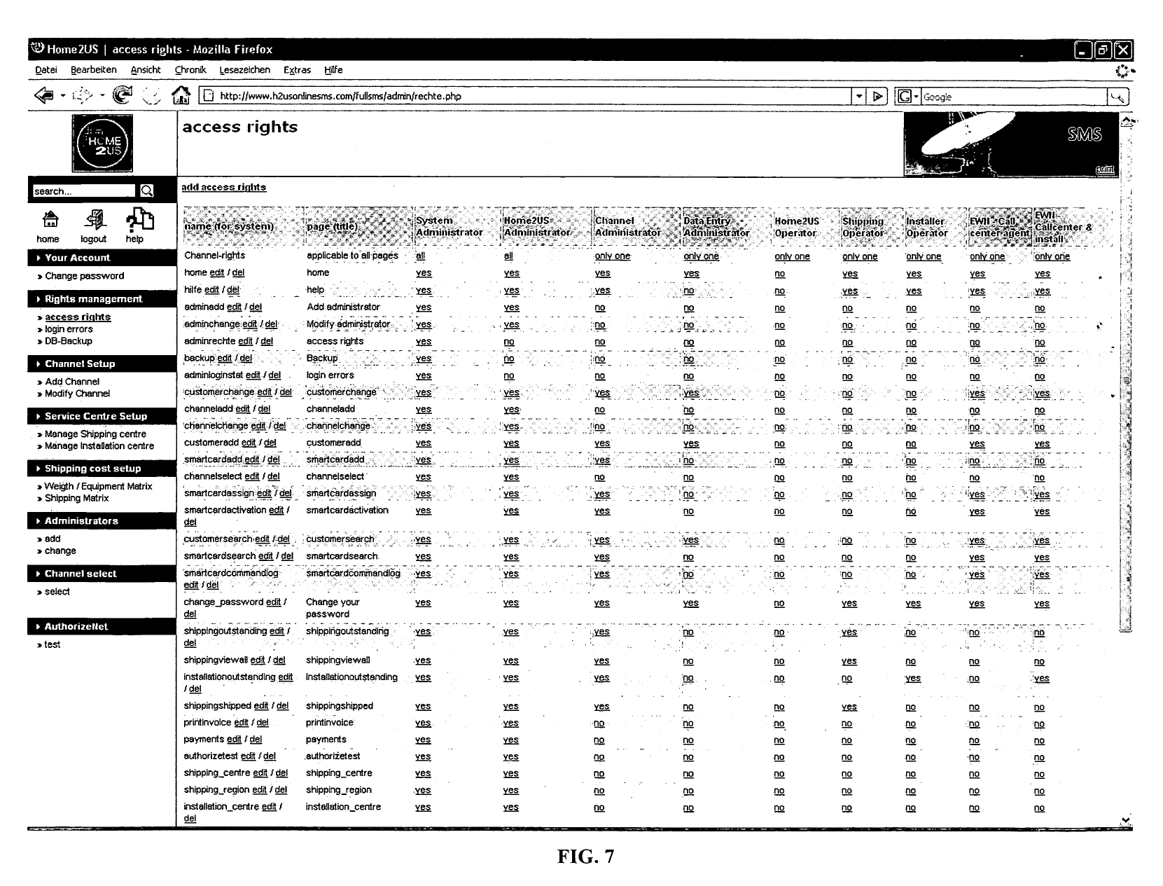

Home Screen Functions. Depending on the access level of the user (which, for example, may be determined based on the entered User ID), one of a plurality of custom menus may be displayed on the home screen. A screen that defines access rights that may be given to each category of users of the SMS is illustratively shown in FIG. 7.

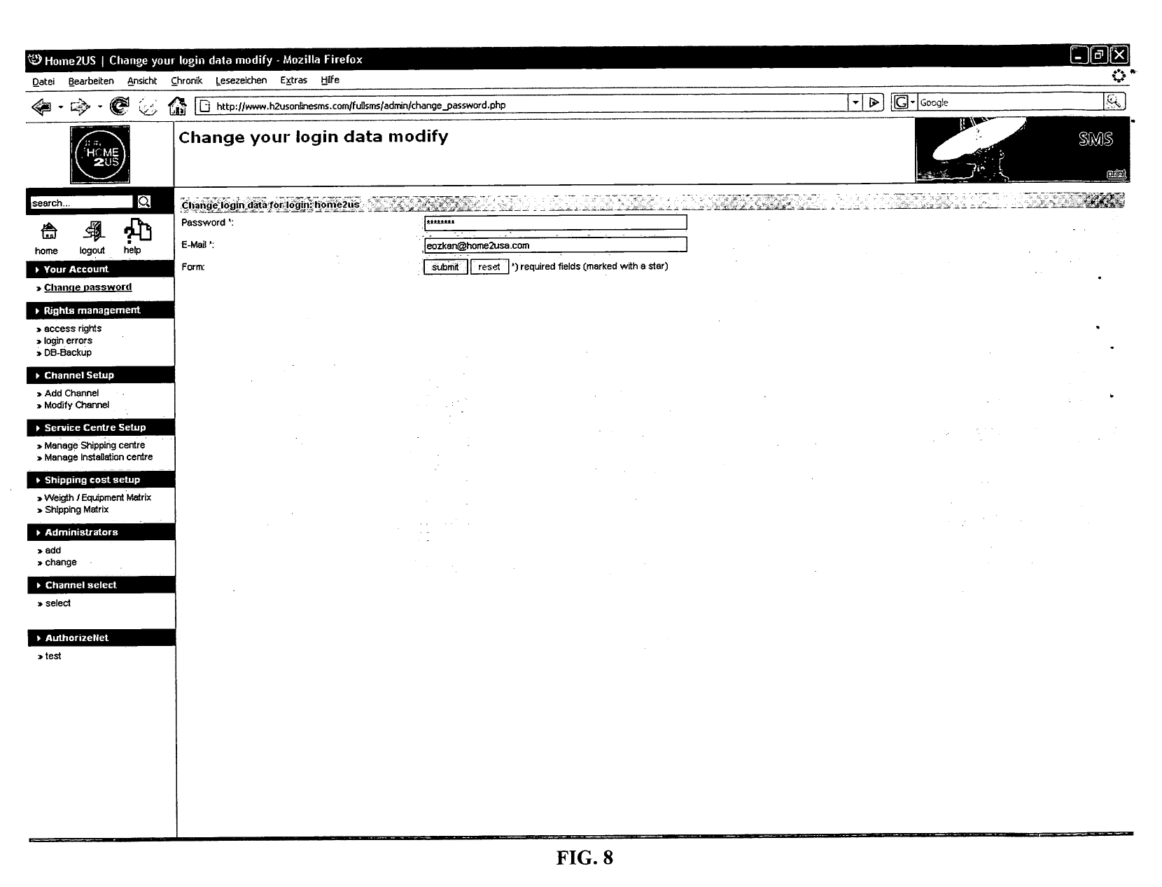

One custom menu may be generated for the subscriber and may include a limited set of predetermined system options which the subscriber is permitted to use. These options include allowing the user to view account information, to view new marketing information and products (e.g., new or existing channel packages), as well as other information of interest to subscribers. The menu may also include an option for allowing the subscriber to change his or her User ID or password using, for example, the screen shown in FIG. 8. The aforementioned type of menu may be provided to subscribers with set-top boxes that are not intended for use with a smart card.

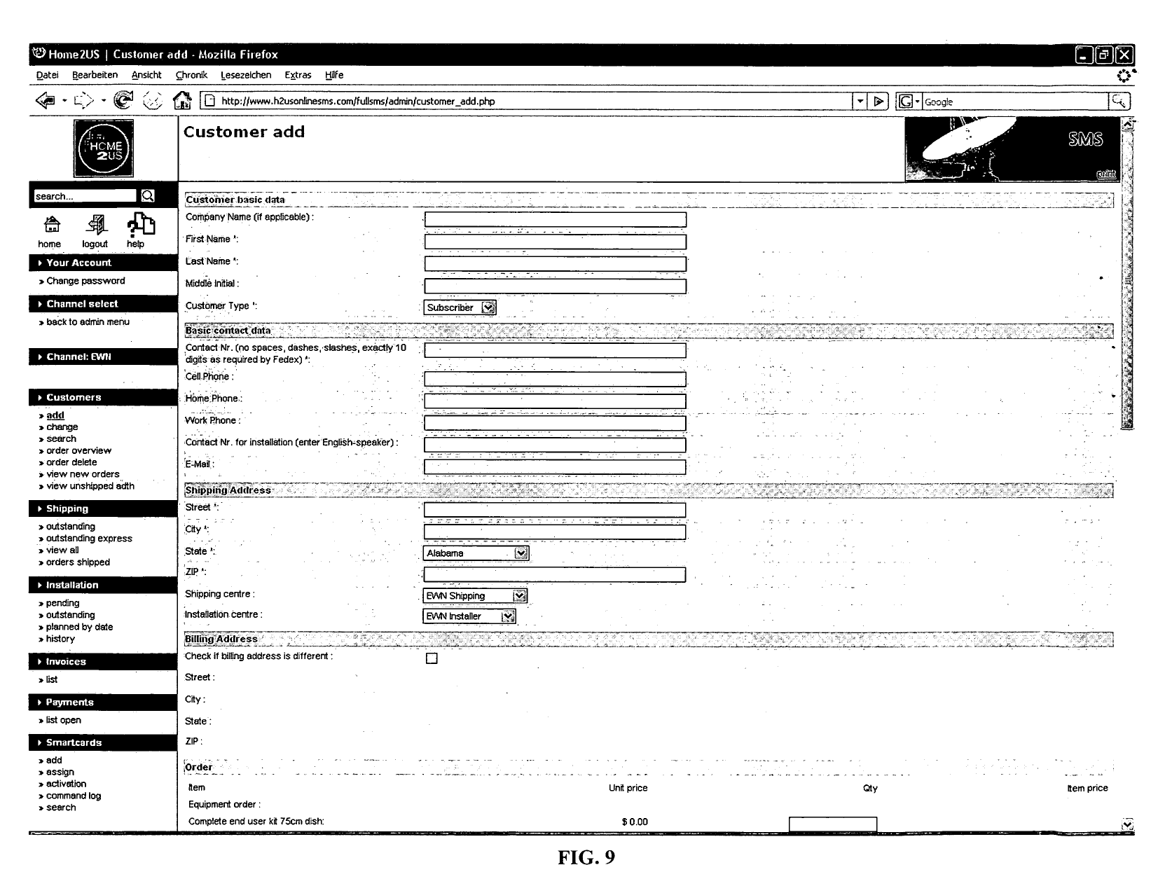

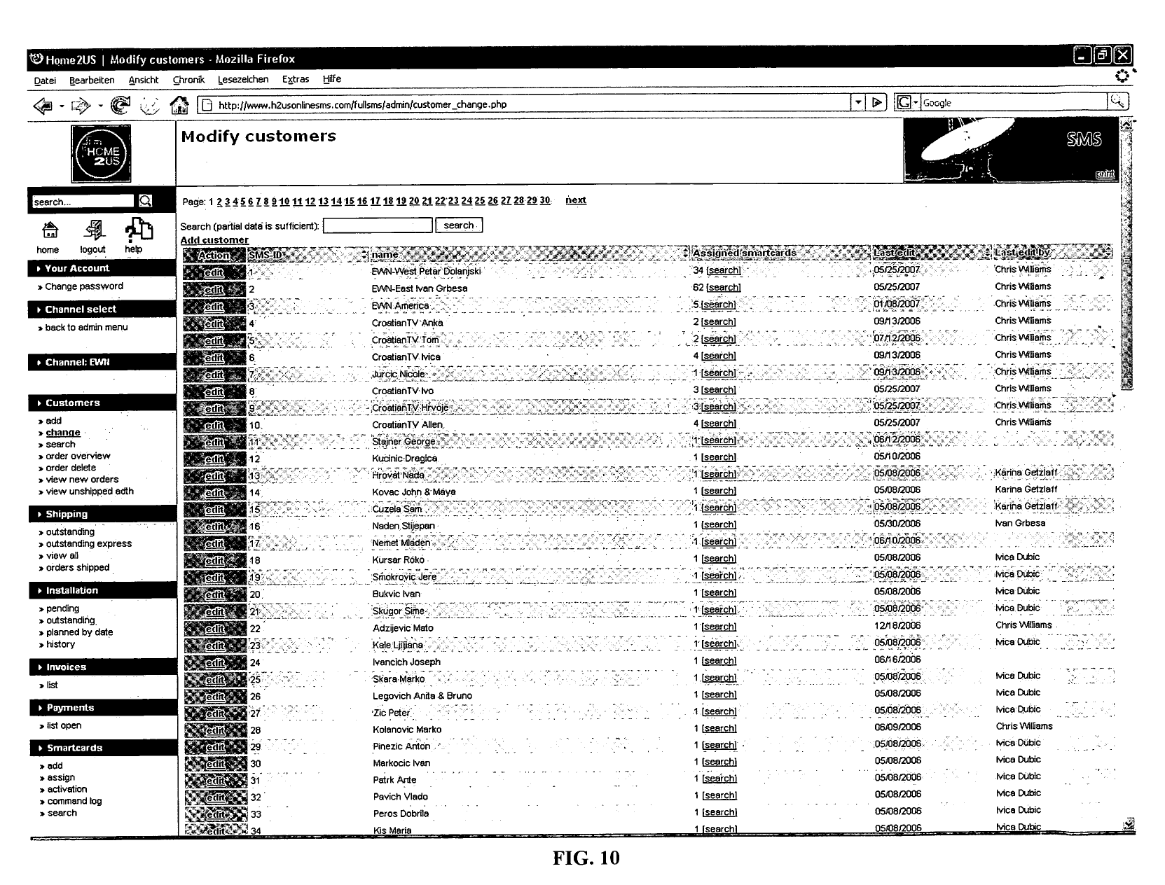

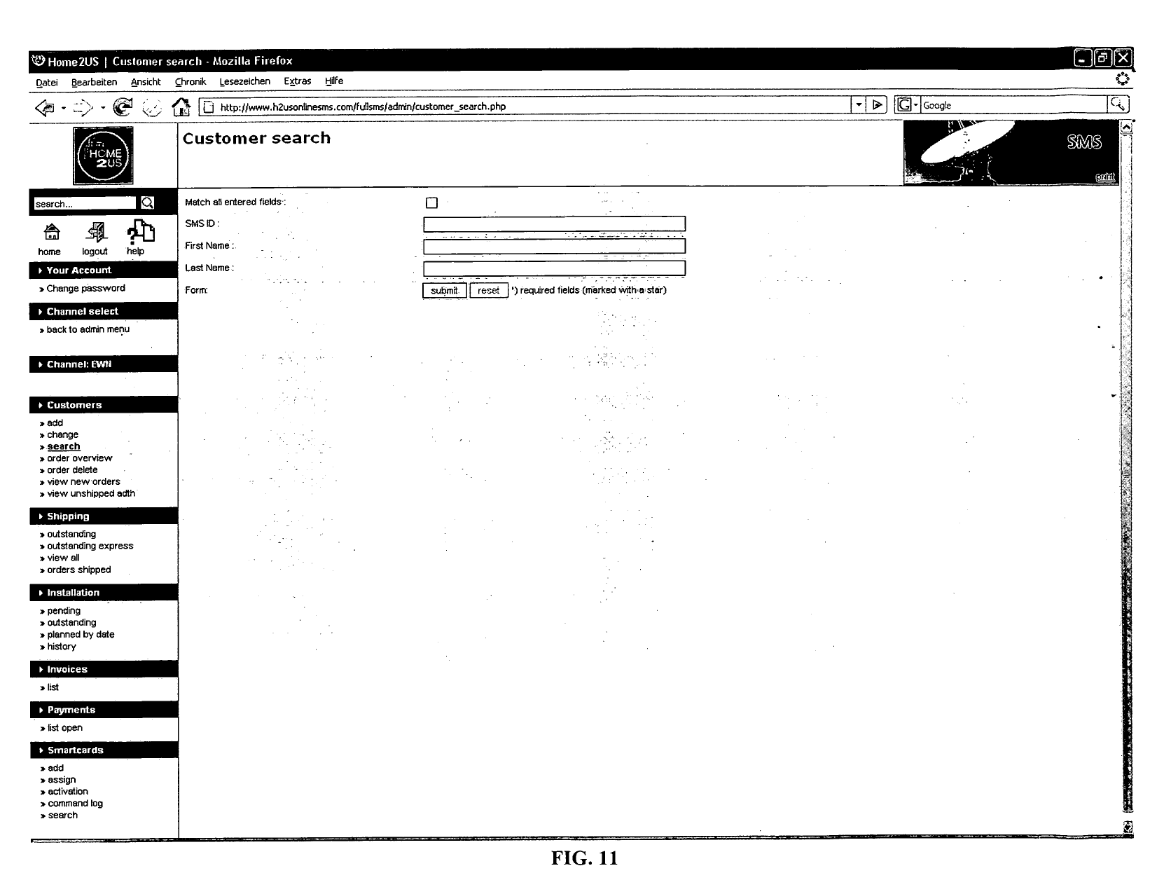

Another custom menu provides options intended for use by an administrator or operator associated with the system. These options include all or a portion of the following, and where applicable reference is made to same screens which correspond to each option:
1. Add Customer—opens a screen for adding a new subscriber to the system (FIG. 9)
2. Modify Customer—provides a tabular listing of all subscribers, and allows information stored for a listed subscriber to be viewed, deleted, or modified (FIG. 10)
3. Search Customer—provides a dynamic search criteria to search for information of a specific subscriber based on one or more user input fields (FIG. 11)
4. Customer Overview—provides a read-only view of information on all subscribers, including:
   (a) Subscription status, e.g., active/inactive
   (b) SMS-ID
   (c) ID of STB Smart Card assigned to subscriber
   (d) Subscriber data
5. Delinquent Customers—provides a list of subscribers who have not paid their bills and are candidates for deactivation

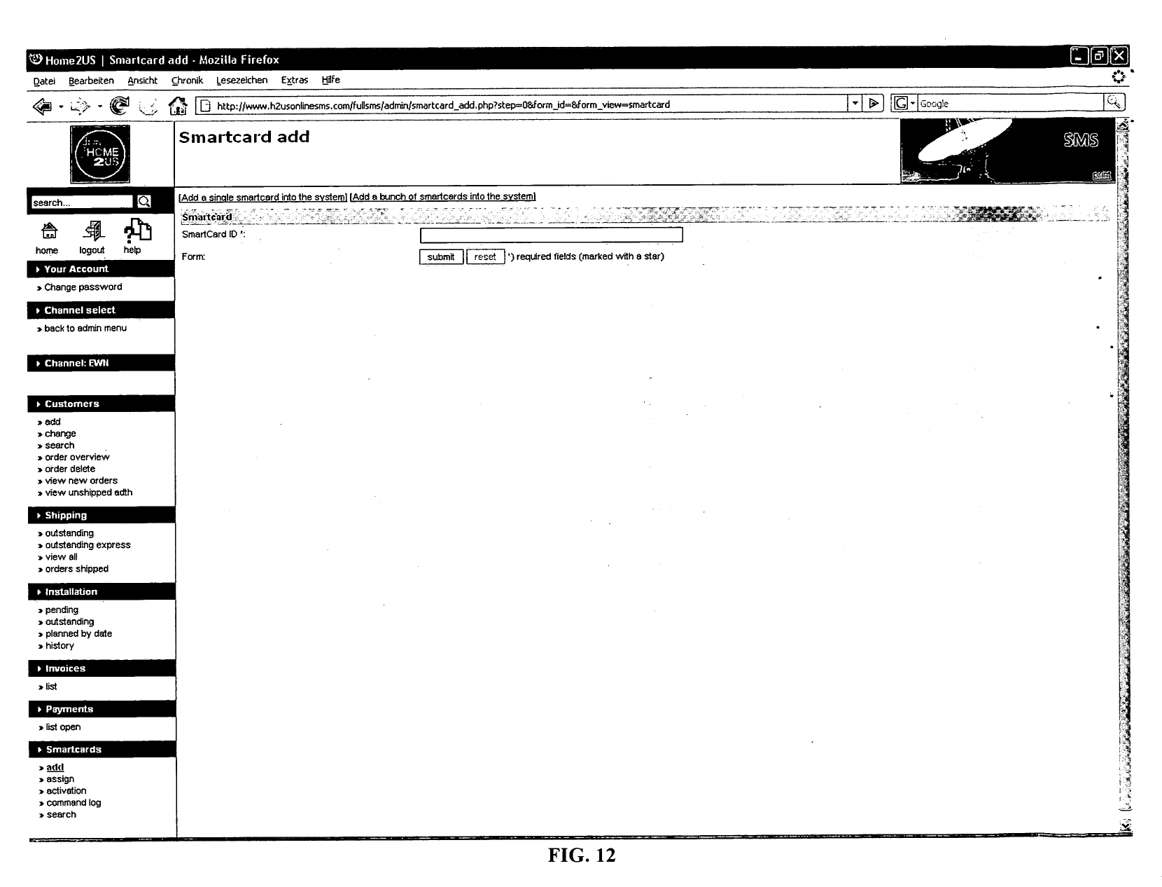

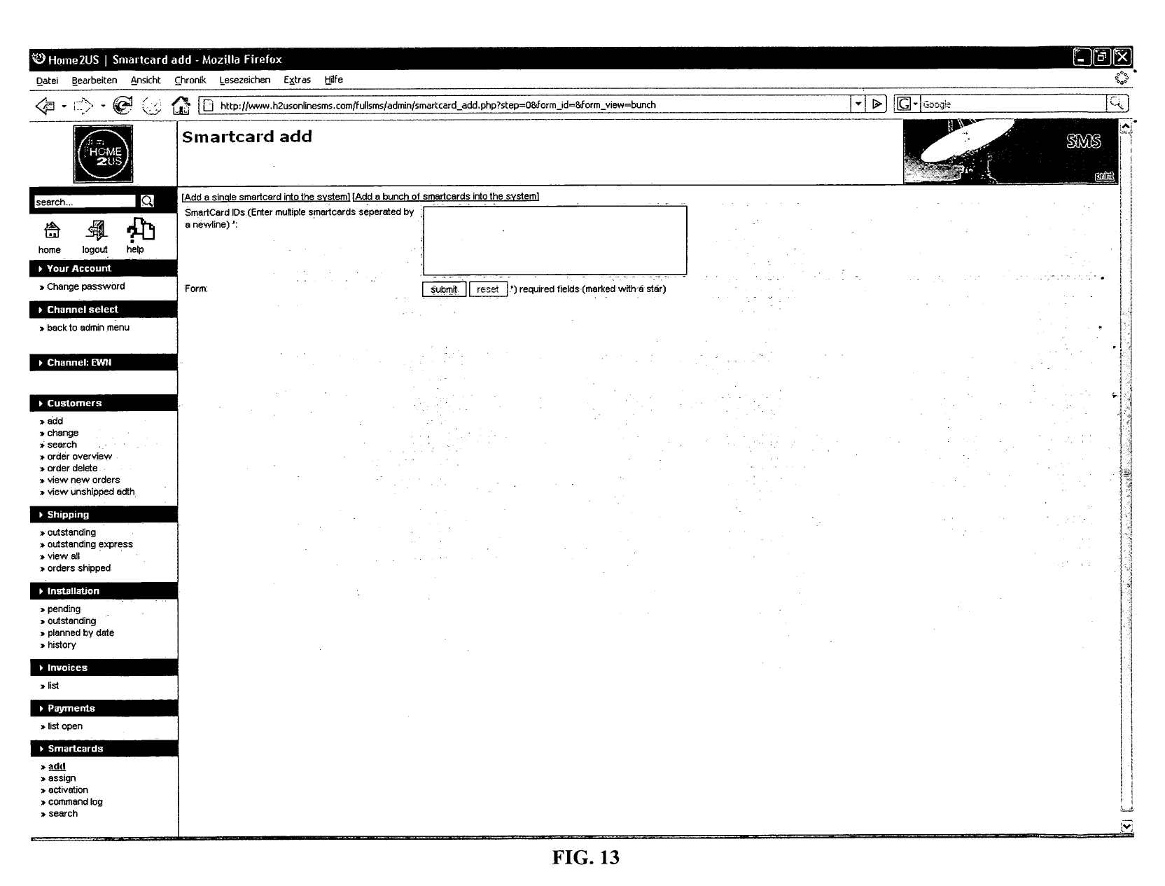

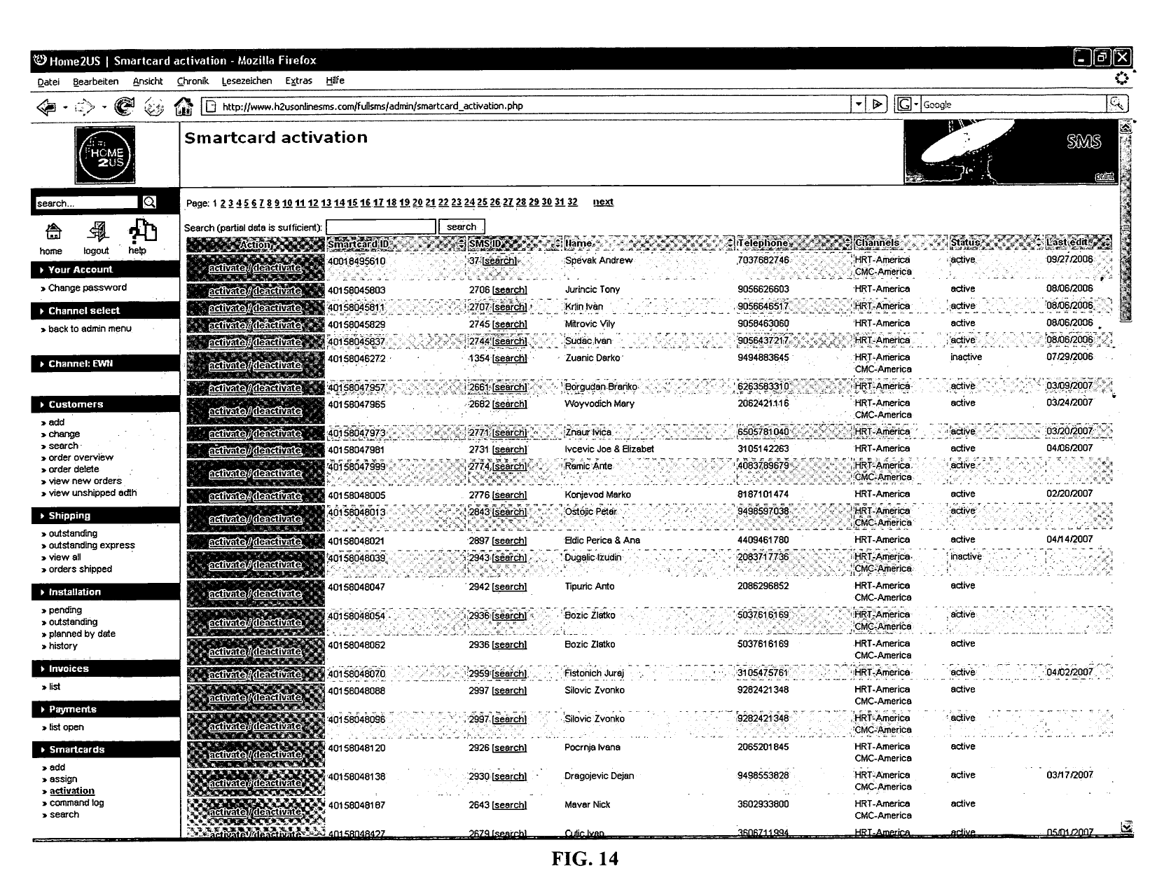

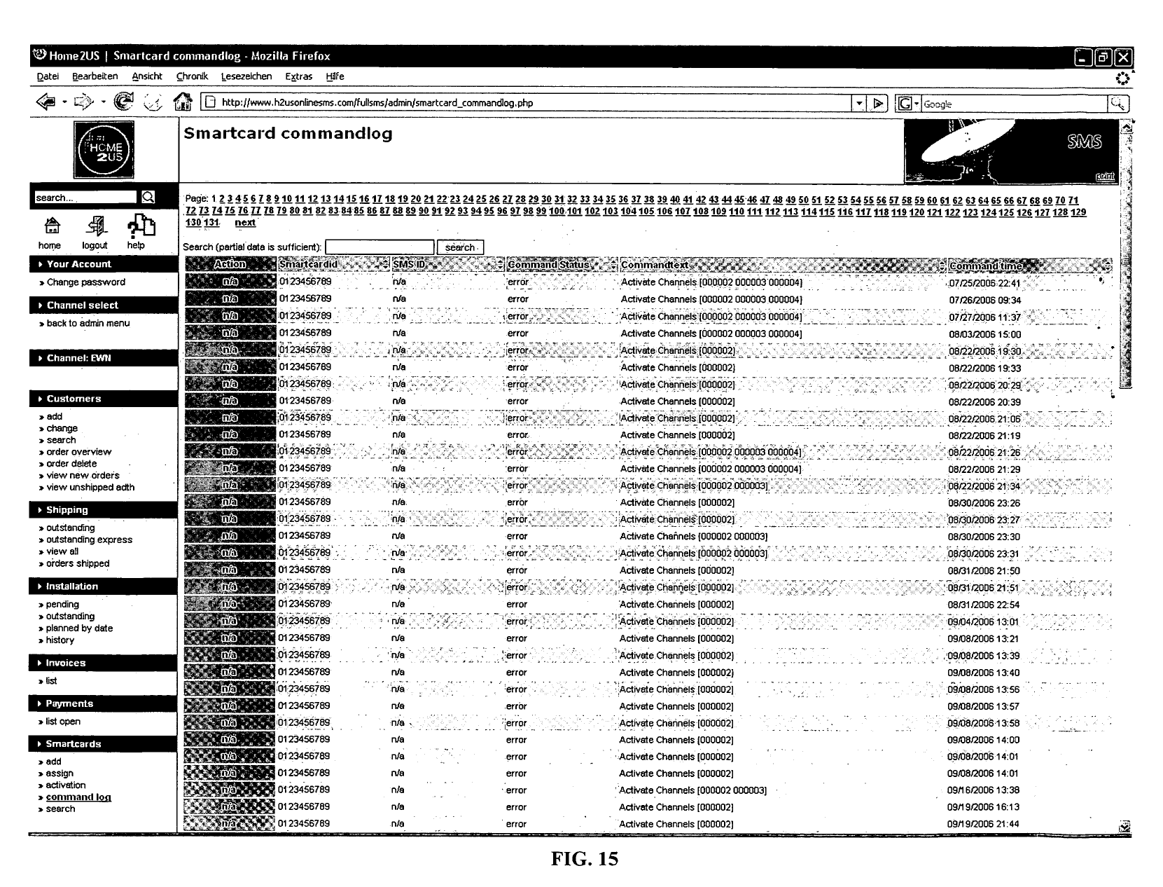

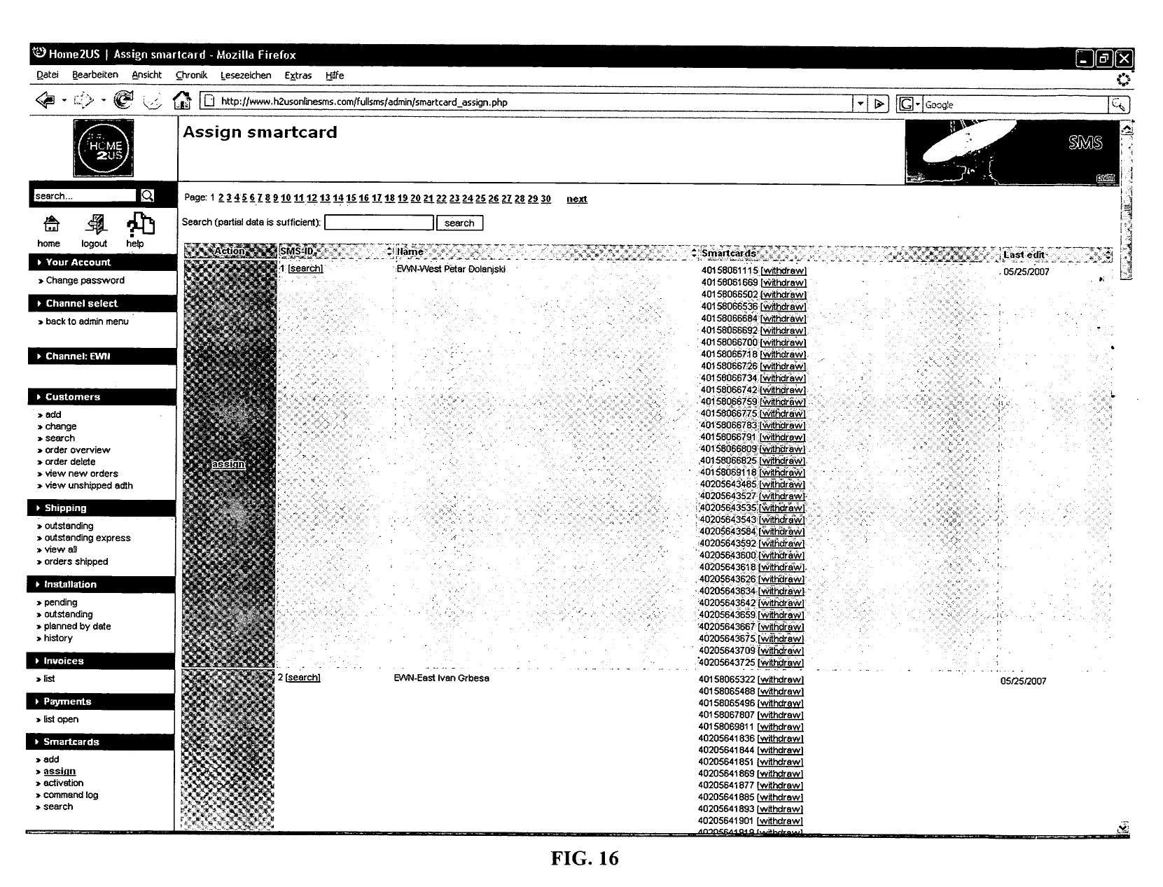

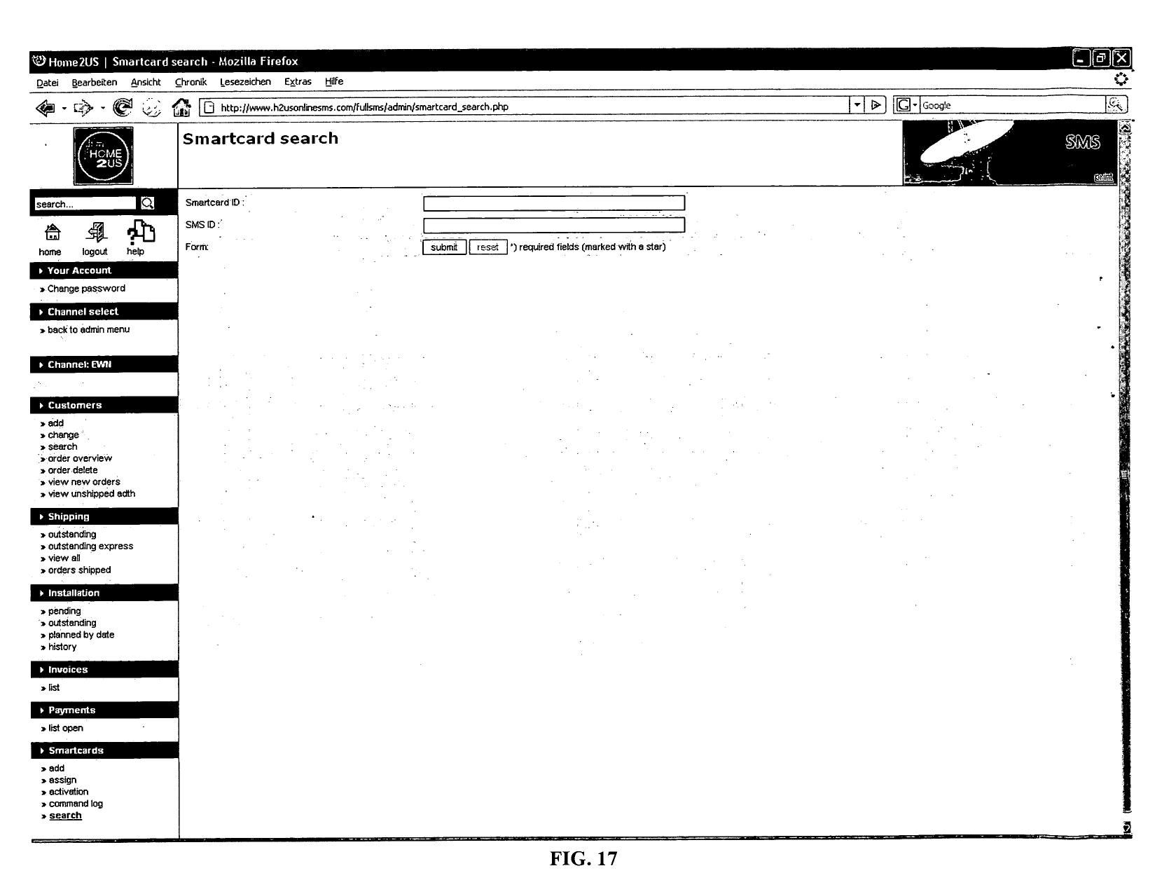

The custom menu may also provide the following options relating to a smart card used by a subscriber for enabling his or her set-top box and/or one or more functions performed therein. Where applicable, reference is made to same screens which correspond to each option.
1. Smart Card Add—add a new smart card to the system. Cards may be added individually (FIG. 12) or in groups (FIG. 13)
2. Activations—activates or deactivates smart cards that have already been assigned to subscribers in the system (FIG. 14)—deactivation of a card may automatically cause the subscription to be canceled or suspended, and may make the card eligible to be reassigned to another subscriber
3. Smart Card Overview—provides a read-only view of the smart cards recorded in the system, their assignments, and their activation status (FIG. 15)
4. Assign Smart Card—allows a smart card to be assigned to a subscriber, to be deleted from the system, and/or to have its status (e.g., active or inactive) changed (FIG. 16)
5. Search Smart Card—provides a dynamic search screen to search for a customer name and/or subscription information based on a known SMS ID or Smart Card ID (FIG. 17)

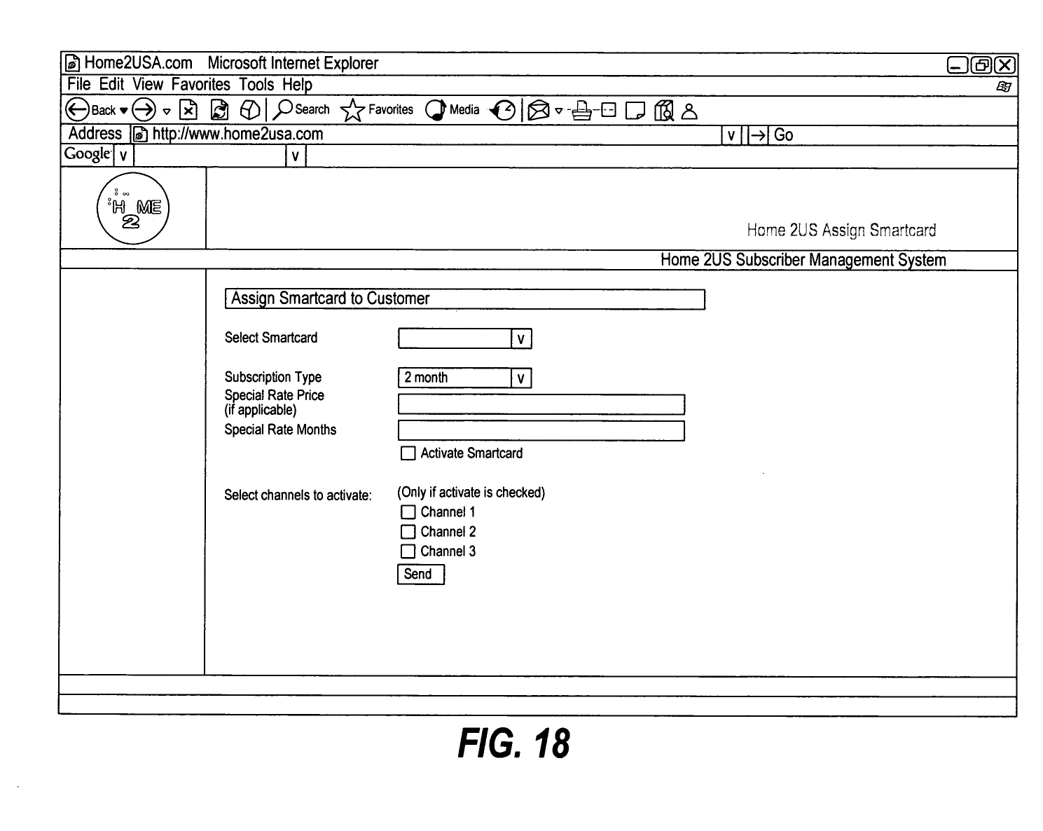

As an alternative to or embedded within one of the aforementioned screens, a screen may be provided to allow a combination of the aforementioned options to be performed for a smart card. As shown in FIG. 18, such a screen may include options and/or drop-down menus that allow a user to assign a smart card to a particular subscriber, select a subscription type corresponding to that smart card, activate the smart card, and select one or more channels that are to be authorized for viewing when information is read from the smart card inserted into the slot of a set-top box.

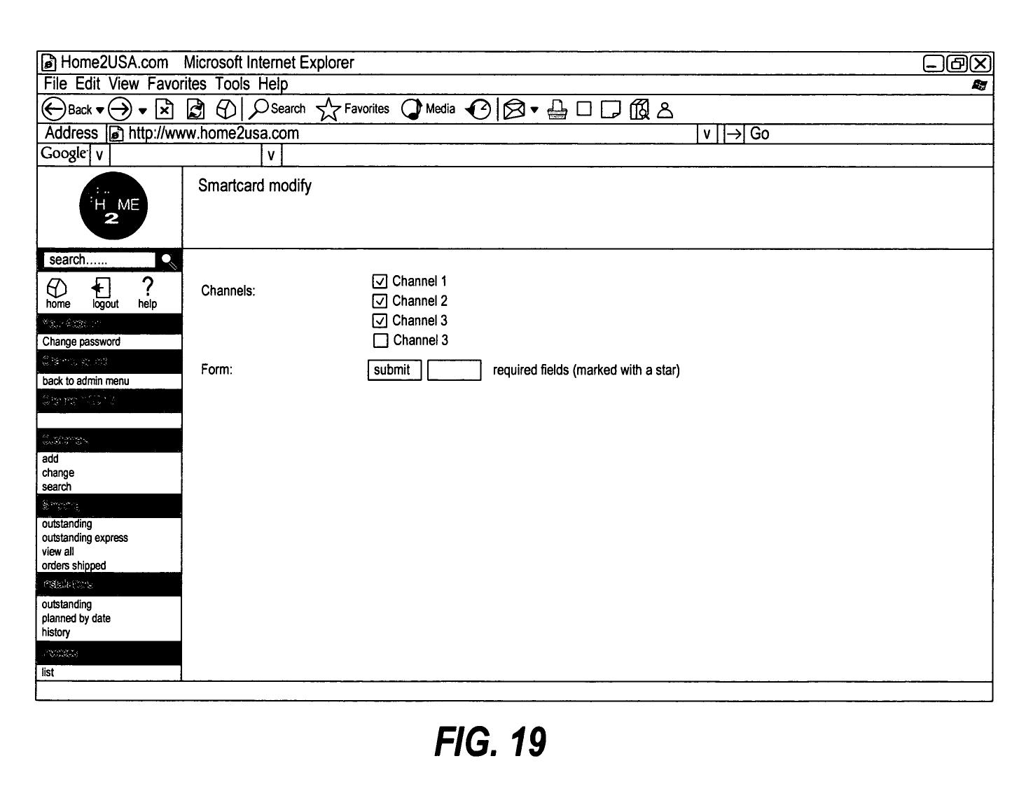

In the example screen shown, any combination of three Korean television channels (identified as TAN Channel 1, Channel 2, and Channel 3) may be selected and authorized for viewing based on information recorded on the smart card and subsequently read by a subscriber set-top box. FIG. 19 shows another example of a screen that will allow information associated with the smart card to be modified in terms of the channels to be selected for authorization. Although a limited number of channels are shown in the screens of FIGS. 18 and 19, a complete listing of all the channels offered by the system for all home countries may also be provided for selection.

Based on the selections made by the custom menu options discussed above, a software module associated with the system will encode smart cards with channel information, access authority information, and other information which, when input into a receiving slot of a set-top box, causes the box to provide the requested programming assigned to that smart card. Channels not authorized by the card may be scrambled to prevent unauthorized access to them by subscribers.

Alternatively, a Conditional Access Vendor may program the smart cards and send them to the SMS provider, e.g., Home2US. Each batch of smart cards sent to Home2US by the Conditional Access Vendor is preferably accompanied by a file with smart card numbers in a csv format or an excel file. The application should have a function to read the file so that the entire batch of smart card numbers can be entered into the SMS. When creating a subscription for a customer, the SMS can select the smart card number for a particular customer, for example, from a drop down menu without the need to type it in. The system may also automatically assign to the specific customer (e.g., based on his initial order) the smart card once the card is shipped from a warehouse. In an exemplary application, the warehouse will scan the equipment serial number as well as the smart card number and import this information into the system.

Furthermore, when logging on as System Administrator or Home2US Administrator, the user may be prompted to select a channel from a drop down box. Once a channel is selected, the user will be able to view/modify the multiple rate screens. According to one embodiment, the only exception where Read Access may be available is in the Channel Subscription Setup. This data is the responsibility of the Channel.

### 1. Initialization of Subscriber Services

After a subscriber account has been set up, the subscriber management system may initialize subscriber services through a selection of the one or more channels from a complete channel list offered by the system. Through the SMS, the selection of channels may be customized for each subscriber. For example, an asian subscriber may select one channel from Korea, one channel from Japan, and one channel from Europe. Or, the subscriber may select from a bouquet of channels that have been pre-selected in the system to appeal to the particular interests of each subscriber. According to one embodiment, the SMS may allow the selection of the customer's requested channels at the same time the account is set up, or at the same time a first order from the customer is placed.

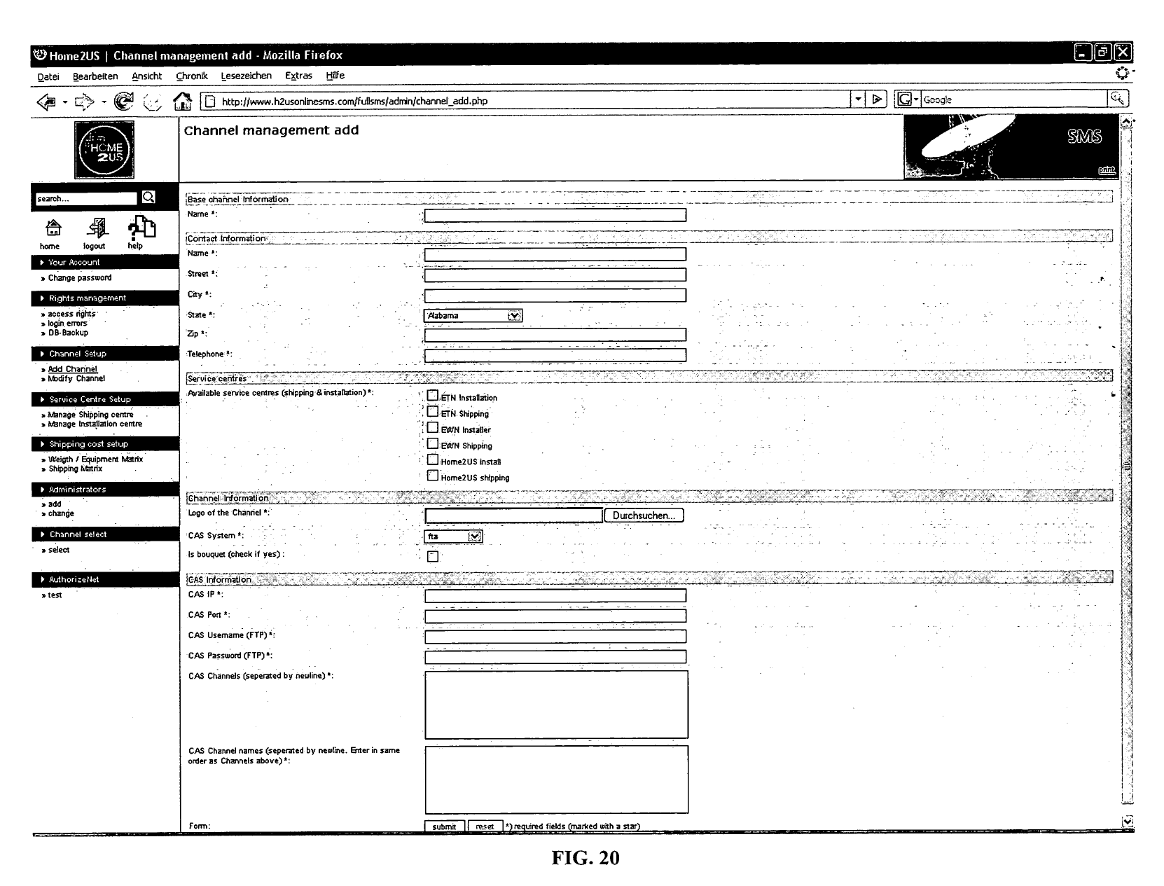

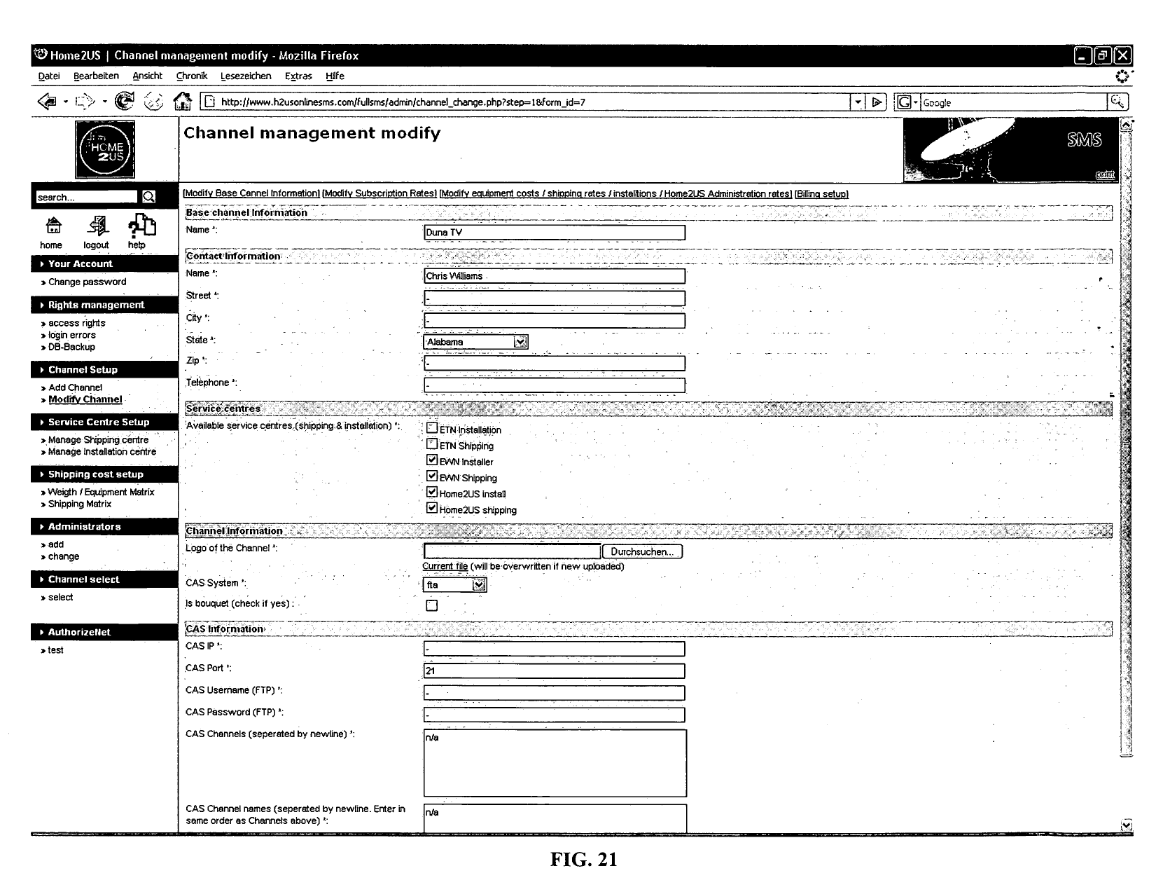

Channel Information. During the selection process, information specific to each selected channel is captured in a screen such as shown, for example, in FIGS. 20 and 21. This screen includes fields to display and/or for allowing a user to enter contact information for the channel, to designate a logo to be displayed in association with the channel, to specify a conditional access system (CAS) system for the channel along with information relating to the CAS (e.g., IP address, port, username and password for FTP files for the CAS, CAS channels, etc.), to enter/display information relating to administrator, users etc., and to enter/display pertinent operational information regarding one or more call centers that may provide information or perform functions associated with the channels offered by the system in connection with subscribers.

In setting up a channel for a subscriber, the system may allow a user (e.g., administrator) to select, for example, one of the following CAS system standards:

1. None

2. Viaccess

3. Irdeto

4. Simulcrypt.

By selecting Simulcrypt, the system may be configured to support both Viaccess and Irdeto condition access systems. In other words, subscribers with Viaccess-compatible set-top boxes may use Viaccess and subscribers with Irdeto STBs may use Irdeto smart cards.

At the time of activation/deactivation, the system may be set up to be transparent to the CAS being used. Accordingly, back-end processing may be performed that will tell the system and the selected CAS which application program interface (API) needs to be invoked when an activation/deactivation command is executed. As those skilled in the art can appreciate, an API is a set of routines that an application (e.g., the SMS) may use to request and carry out a variety of lower-level services. The API may also designate a set of calling conventions that define how services are to be invoked through a software package/module.

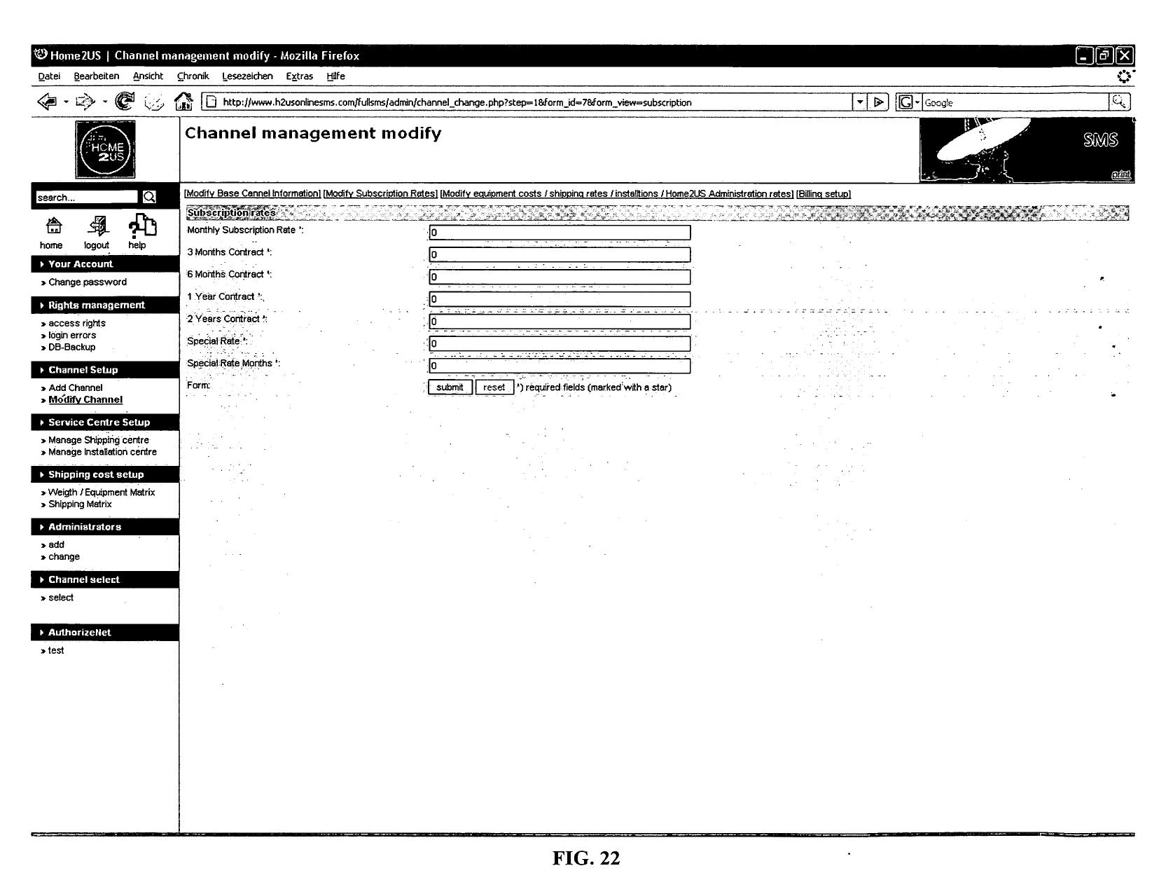

Channel Subscription Setup. During initialization (e.g., the setup procedure), the SMS may display a screen such as shown in FIG. 22 to allow for selection of one of a plurality of subscription rates/packages. Example of these rates/packages are provided below.

| Fields | | Cost |
|---|---|---|
| Monthly | Operator | $xx.xx |
| Subscription Rate | | |
| 3 Month Contract | Operator | $xx.xx |
| 6 Month Contract | Operator | $xx.xx |
| 1 Year Contract | Operator | $xx.xx |
| 2 Year Contract | Operator | $xx.xx |
| Special Rate | Operator | $xx.xx |

Additional rates may be added to reflect price changes, and stems should be able to accommodate such requests. The following users may have access to this screen:

| | |
|---|---|
| System Administrator | Read/Write |
| Home2US Administrator | Read/Write |
| Channel Administrator | Read/Write |

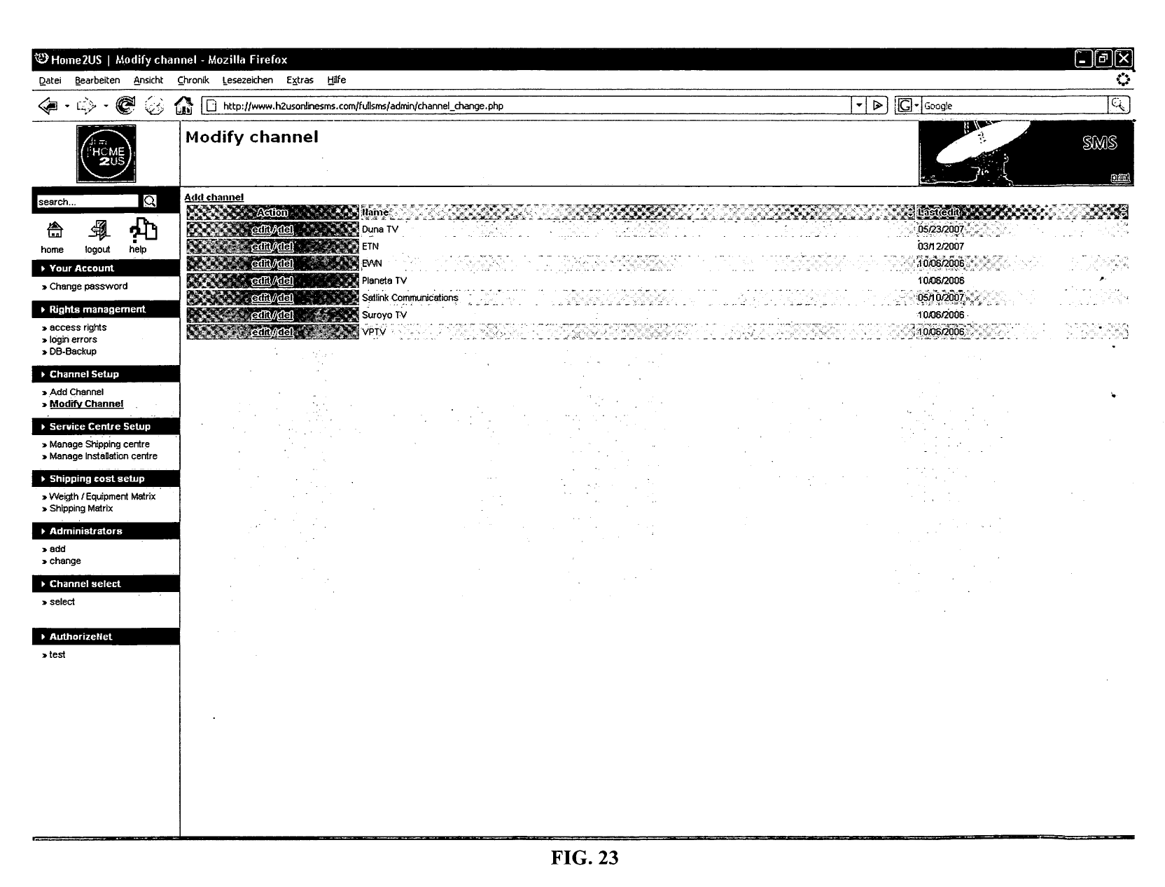

FIG. 23 shows a screen that may be displayed by the SMS to allow a user to modify or add a new channel to the subscription of an existing subscriber of the system. In this screen, the selected channels and their corresponding home countries are shown along with a date when the subscription to the channel(s) was last modified.

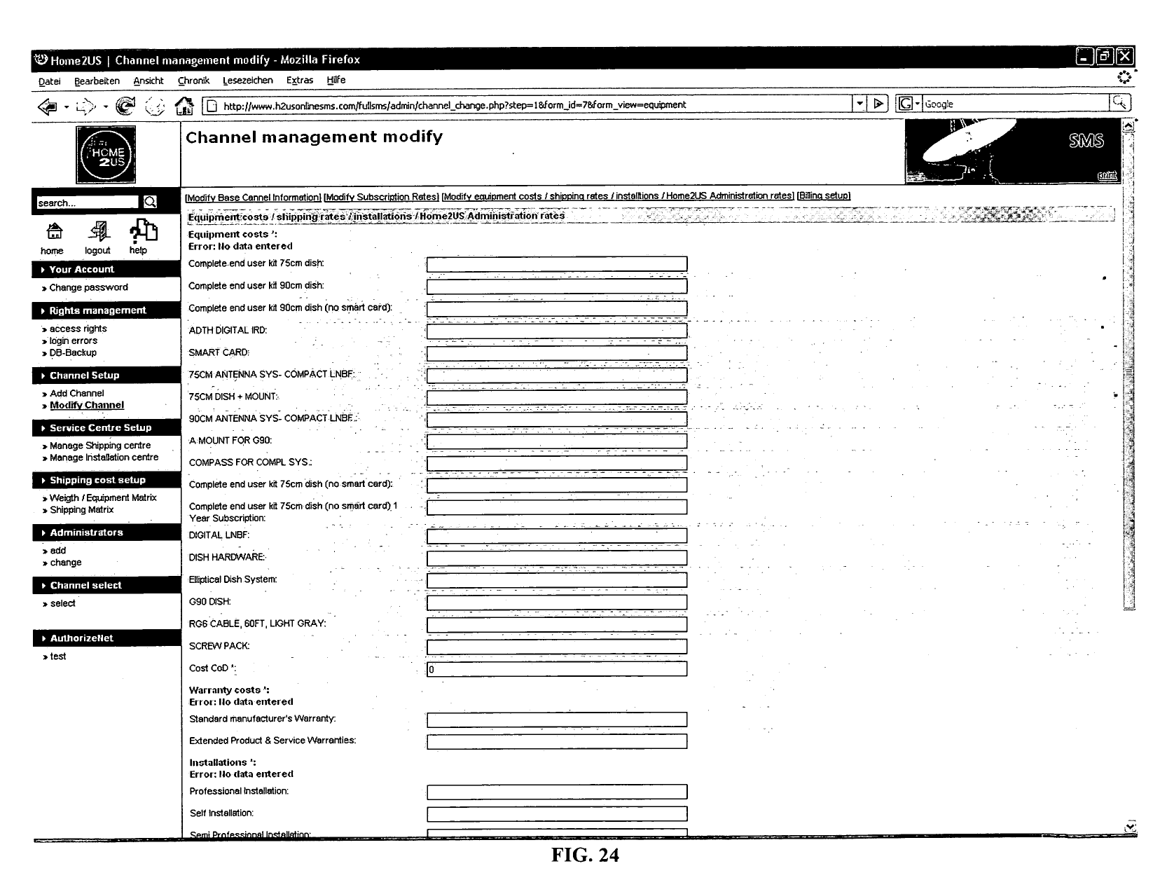

Equipment Costs. During initialization, the SMS may display a list of equipment required to allow the subscriber to receive the channels that he has selected. As shown in FIG. 24, this screen may also include a cost of each piece of equipment. Using this information, a user may provide a new subscriber with a cost estimate for setting up service, taking other internal fees and charges into consideration. A sample of this equipment is also listed below, along with cost information for a self-installation kit and a smart card for use with the set-top box.

| Fields | | Cost |
|---|---|---|
| IRD Receiver | Operator | $xx.xx |
| Standard LNB | Operator | $xx.xx |
| Dual LNB | Operator | $xx.xx |
| Triple LNB | Operator | $xx.xx |
| Quad LNB | Operator | $xx.xx |
| Self Install Kit | Operator | $xx.xx |
| Satellite Antenna | Operator | $xx.xx |
| Smart Card | Operator | $xx.xx |

Shipping and Installation Information. The SMS may also manage the shipping and installation of all equipment required for accessing SMS multimedia services. This is a particularly advantageous feature of the present invention, as traditionally shipping and installation of hardware was performed separately and certainly not integrated within a common SMS as contemplated herein. As example of shipping options and a field for showing their associated costs, which may be conveyed to a subscriber as part of a cost estimate, is shown as follows:

| Fields | | Price |
|---|---|---|
| Regular Shipping | Operator | $xx.xx |
| 2^{nd} Day | Operator | $xx.xx |
| Overnight | Operator | $xx.xx |
| Same Day | Operator | $xx.xx |
| Ground Delivery (Home) | Operator | $xx.xx |
| Ground Delivery (Bus) | Operator | $xx.xx |

In providing the above information, the SMS may allow the user (e.g., Administrator) to set different rates for the same or different types of equipment and/or shipping for different channels. These rates may be set at the time of setup. For example, using the SMS, a user may set an IRD price of $65 for Channel 1 and a different price for the IRD for Channel 2.

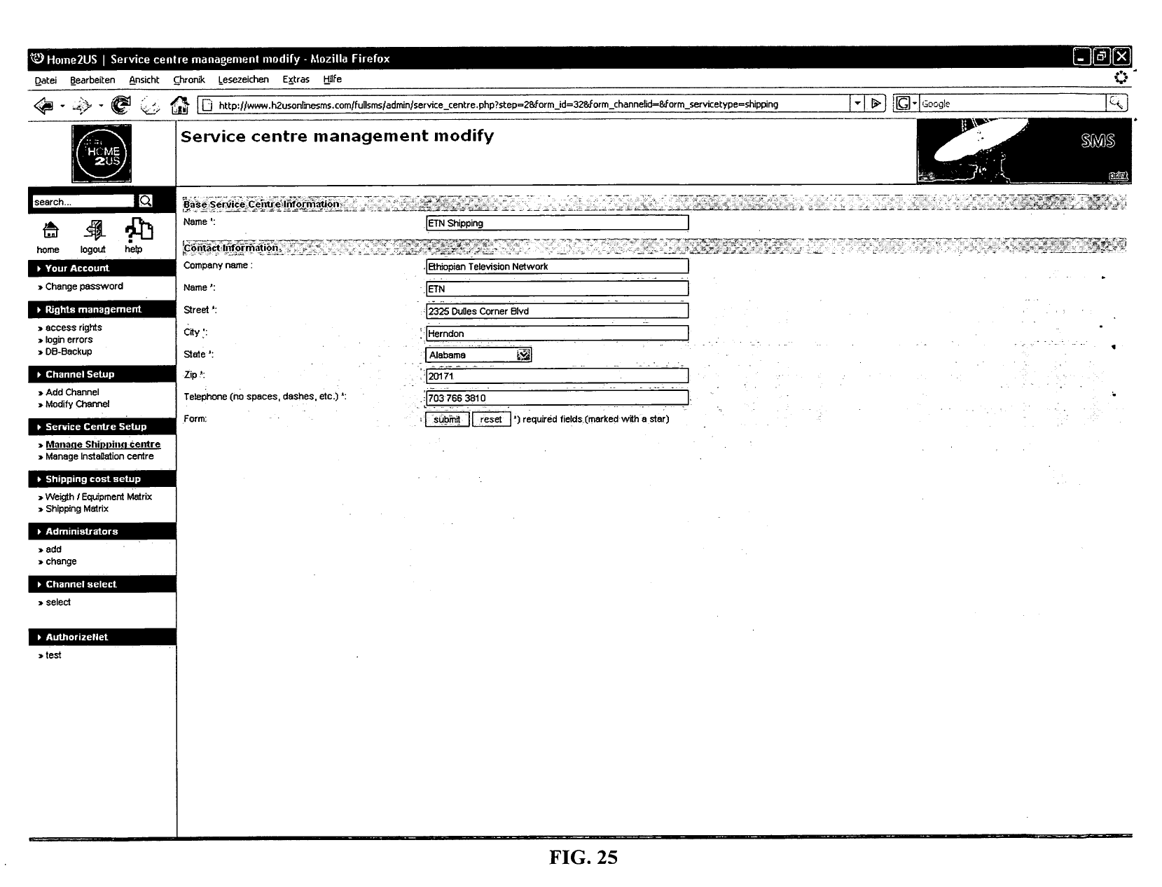

The SMS may provide this information in a separate or same management screen as the shipping information as shown in FIG. 24. In addition to this screen, the SMS may generate a screen such as shown in FIG. 25 to allow information on a new shipper to be added to the system, or to allow information to be edited for a shipper who was previously registered in the system. This information may be accessed by users through terminals that are networked to the SMS system, including users at service centers at various regions throughout the target country.

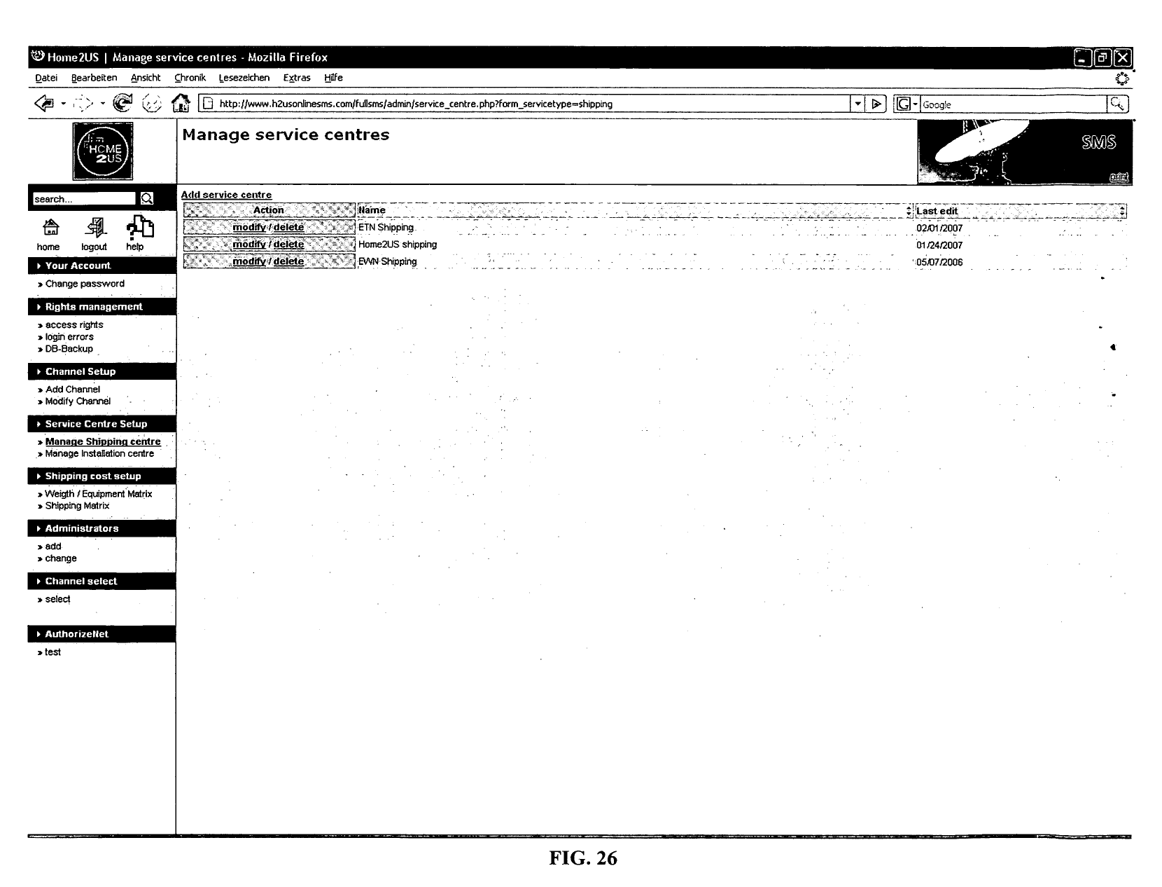

FIG. 26 shows another screen which categorizes shippers according to their regional service areas. This screen may prove especially useful in allowing system users (including service center personnel) to select the company best suited to ship SMS equipment to particular locations throughout the target country. The screens in FIGS. 25 and 26 may also allow system users to manage the information and operation of SMS service centers throughout the country, all as a part of providing a fully integrated system.

The SMS may also provide information on various methods for installing the equipment for receiving SMS services and costs associated with each of those methods. The installation methods may include, for example, professional installation, partial professional installation, and self-installation, as set forth below:

| Fields | | Cost |
|---|---|---|
| Professional Installation | Operator | $xx.xx |
| Partial Professional Installation | Operator | $xx.xx |
| Self Installation | Operator | $xx.xx |

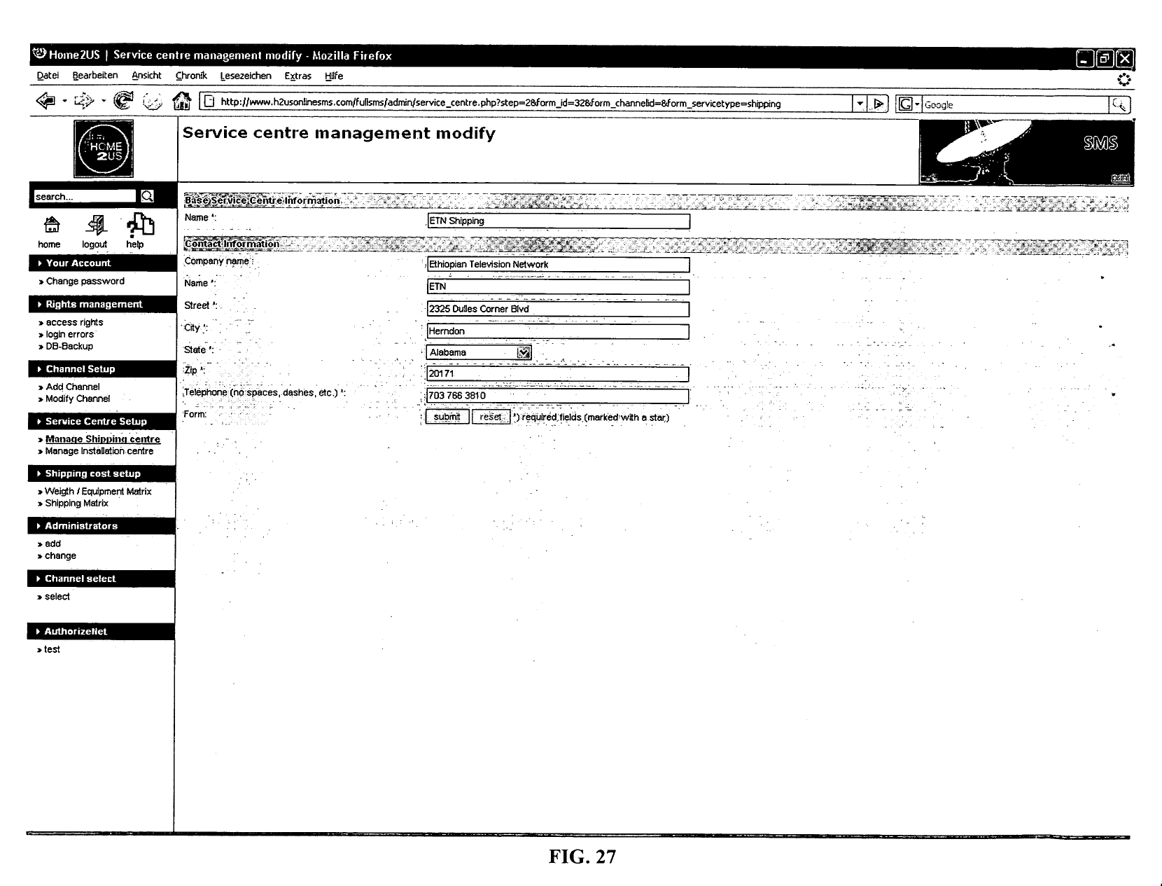

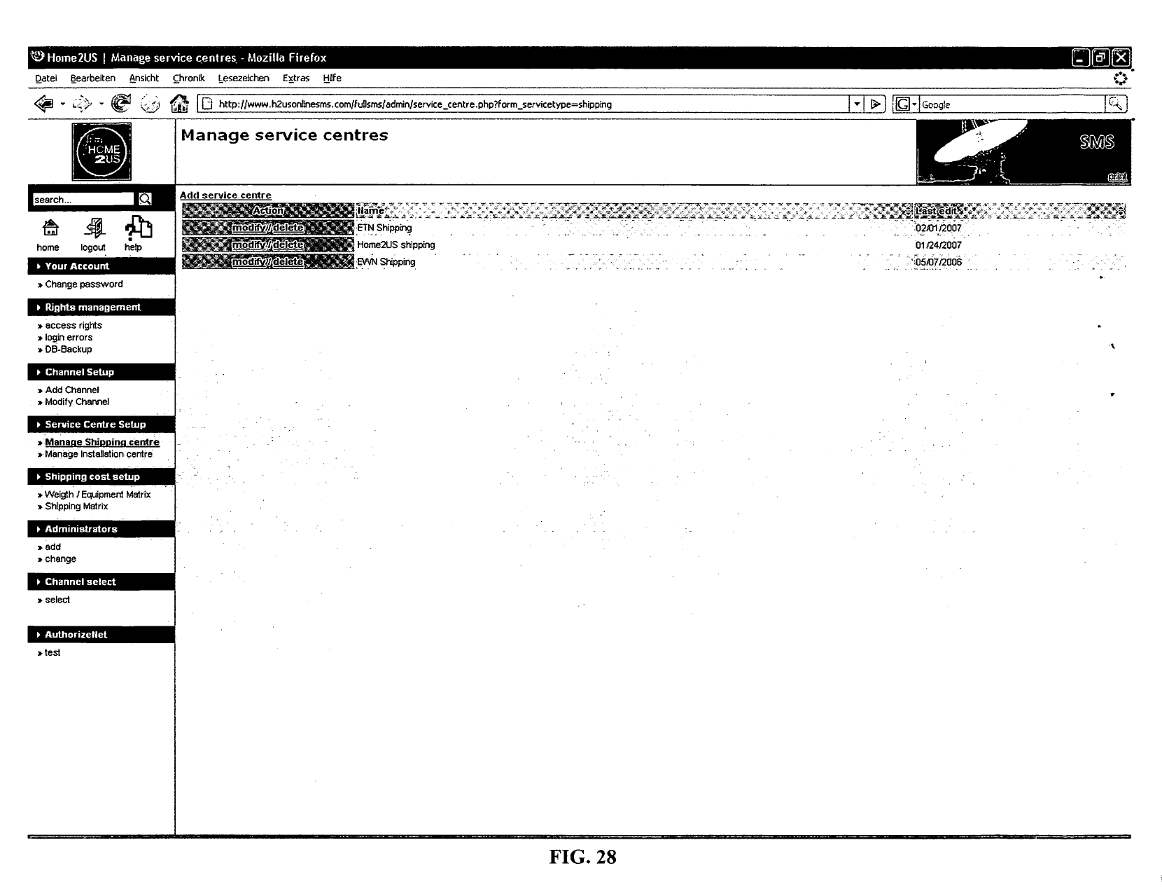

FIGS. 27 and 28 respectively show screens for adding/editing entities that are available to install SMS service equipment and for listing installers based on their regional service areas. These screens may prove useful in selecting the company best suited to install SMS equipment at particular locations throughout the target country.

Administrative Information. The SMS may provide a screen for managing information relating to administrative fees and various service charges, which, for example, may include:

| | | Cost |
|---|---|---|
| Monthly Fee | | per Sub/Month |
| Administrative Late Fee | Operator | $10.00 |
| Change of Service Fee | Operator | $5.00 |
| Duplicate Statement Fee | Operator | $1.00 |
| Disconnect Fee | Operator | $15.00 |
| Re-stocking Fee | Operator | $40.00 |
| NSF fee - 1^{st} time | Operator | $15.00 |
| NSF fee - 2^{nd} time | Operator | $25.00 |
| Activation Fee | Operator | $14.95 |
| Re-activation fee | Operator | $29.95 |
| Cancellation fee | Operator | $15.00 |

The activation fee may only be charged to subscribers who sign a subscription contract for less than a predetermined term, e.g., 1 year. The SMS may provide this information in a separate management screen or in the same screen with the shipping information as shown in FIG. 24. Access rights to the activation information may be provided, for example, as follows:

| | |
|---|---|
| System Administrator | Read/Write |
| Home2US Administrator | Read/Write |
| Channel Administrator | No Access |
| Data Entry Operator (Channel) | No Access |
| Home2US Operator | No Access |
| Shipping Operator | No Access |
| Installer Operator | No Access |

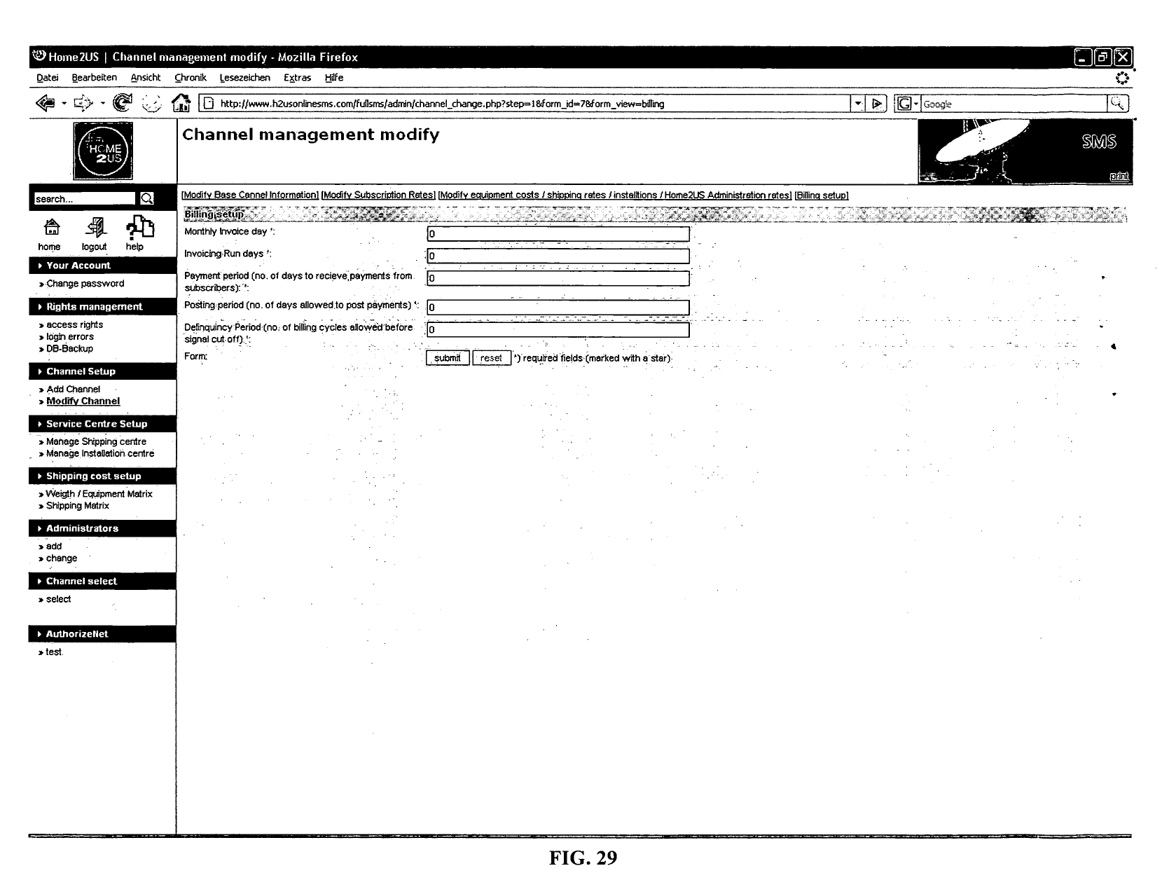

Billing Setup. The SMS may provide a screen for defining billing policies for each channel selected for subscribers. For example, as shown in FIG. 29, the screen may determine the billing cycle, invoice generation, cut-off dates, penalty triggers, and deactivation of a subscriber signal as well as other information. This information may be incorporated within dedicated fields which may designate:

1. Monthly Invoice Day. This field may define a calendar day in each month for initiating invoicing for a specific channel. Preferably, the SMS will automatically alert the operator of this day each month for the purpose of generating monthly invoices.

2. Invoicing Run Days. This field may define information on the number of days the invoicing run is to occur each month. For example, if 5 days are keyed in for a particular channel, the SMS will compute an invoice cut-off date. The system may not allow the operator to generate new monthly invoices after this day. An administrator override may be required if new invoices have to be generated after this date. Starting from the Monthly Invoice Day up to the cut-off day, the system may continue to automatically generate alerts for the operator until such date that the Invoice Run has been completed.

3. Payment period. This field may define information on the number of days permitted for subscribers to make payments. For example, if 15 days are keyed in for the channel, the system will compute a payment due date.

4. Posting Period. This field may define the number of days the operator is permitted to complete the posting of payments into the system. It may commence on the first business day after the payment due date and a calculation may be performed to post a close data based on information input for the channel. Any payment not posted in the system for a customer by the posted close date may result in a late payment penalty.

5. Delinquency period. This field defines the number of pay periods permitted by the channel for its customers to clear their balances with penalty. Based on the information input for the channel, the system will perform a signal deactivation function to, for example, suspend or cancel a corresponding subscription. Having understood the critical date and time parameters defined above, the following table shows fields that may be included on a setup screen of the SMS followed by a navigation process.

Fields

| | | |
|---|---|---|
| Channel | Determined at Login | Non-editable. Show name and |
| Name | | channel logo. |
| Monthly | Operator | Numeric field between 5 and 10 |
| Invoice day | | |
| Invoicing | Computed | Numeric field between 1 and 3 |
| Run days | | |
| Payment | Computed | Numeric field between 10 and 15 |
| period | | |
| Posting | Computed | Numeric field between 3 and 5 |
| period | | |
| Delinquency | Computed | Numeric field between 2-3 |
| Period | | |

The SMS may also provide an application that will support a calendar function to monitor critical dates that trigger different events. This function will take into consideration the regular holiday schedule in the target country (U.S.) and compute dates accordingly. For example, if the due date falls on a weekend, the application will choose the first business day after the weekend as an event trigger. Likewise, if a critical date falls on a scheduled national holiday, the application may choose the first business day after the scheduled holiday.

An example of the procedural steps that may be followed in performing a billing function in the SMS will now be described. In this example, all of the events in the billing application are driven primarily from the Month Invoice day. This is the only day that is defined/entered into the system. All other days are computed fields.
Channel Name: XYZ
Monthly Invoice Day: 5 (5^{th} of every month or following day if it falls on a holiday in a specific month). To illustrate say it is January 5
Invoice Run days: 3 (Invoice cut off date=January 8)
Payment period: 15 (payment due date=January 23)
Posting period: 5 (posting close date−January 28)
Delinquency Period: 2 (2 pay periods allowed to clear balance+penalty payments before deactivation kicks up)

To further explain the delinquency period, assume that customer A did not pay his monthly invoice of $25.00 for February that was due by January 23. The following invoice run in February his invoice will include:

Balance forward from last invoice: $25.00

Late payment charge: $10.00

New subscription charge for March: $25.00

Total Charge $60.00

Payment due date February 23

If the customer does not pay by February 23 and there is no posting against his account up to February 28 (allowing for the posting period), his signal will be deactivated after February 28. The customer has now not paid for February and March (2 pay periods). All invoicing for the subscriber is performed one month in advance.

### 2. Order Entry for Customers or Subscriber of Selected Channels

The SMS also performs functions for entering orders for customers or subscribers for the channels they select. According to one embodiment, when a Data Entry Operator (Channel) logs into the SMS system, the operator is taken to a Master Order Entry Screen for the Channel. In the case of a Channel where Home2US is responsible for entering orders via its Call Center, the Home2US operator will be assigned a Data Entry Operator (Channel) userid and password.

In this embodiment, the Master Order Entry Screen may serve as the main entry point into the SMS application, and may serve to drive the rest of the functions that include shipping/installation, billing and invoicing, order processing and customer service.

The Master Order Entry screen may display a menu with the following three options:

1. Customer Information

2. Order Information

3. Subscription and Billing

Customer Information. When the Customer Information option is selected from the Master Order Entry menu, the following fields may be displayed on a user screen. The user may fill out these fields as necessary to record information relating to a subscriber who ordered services managed by the SMS.

| Fields | | ACTION |
|---|---|---|
| SMS ID | System | Non-editable |
| | Generated | |
| Company | Operator | |
| Name | | |
| Last Name: | Operator | Required |
| First Name: | Operator | Required |
| Middle Initial: | Operator | |
| Shipping | | |
| Address | | |
| Street | Operator | |
| City | Operator | |
| State | Pre-filled Drop | |
| | Down Box | |
| Zip | Operator | |
| Country | Pre-filled Drop | Required - Default value USA |
| | Down Box | |
| Billing Address | Check Box | Select if different from Shipping |
| | | Address |
| Street | Operator | Required only if check box is selected |
| City | Operator | Required only if check box is selected |
| State | Pre-filled Drop | Required only if check box is selected |
| | Down Box | |
| Zip | Operator | Required only if check box is selected |
| Country | Pre-filled Drop | Required only is check box is selected |
| | Down Box | |
| Contact No: | Operator | Required |
| Cell Phone: | Operator | |
| Email Address: | Operator | |
| Customer | Pre-filled Drop | Subscriber/Distributor/Dealer |
| Type: | Down Box | |
| Created by: | System | Hidden |
| | generated on | |
| | Save (userid) | |

Order Information. When the Order Information option is selected from the Master Order Entry menu, the following fields may be displayed on a user screen. The user may fill out these fields as necessary to record an order from a subscriber who ordered services managed by the SMS.

| | | Charges |
|---|---|---|
| Fields | | Non Editable) |
| Order No: | System Generated on Save | |
| Standard STB Kits | Qty-Operator | $xx.xx |
| Receivers | Qty-Operator | $xx.xx |
| Std. LNB | Qty-Operator | $xx.xx |
| Dual LNB | Qty-Operator | $xx.xx |
| Triple LNB | Qty-Operator | $xx.xx |
| Quad LNB | Qty-Operator | $xx.xx |
| Self Installation Kits | Qty-Operator | $xx.xx |
| Shipping Preference | Pre-filled Drop Down Box | $xx.xx |
| Remarks | Operator | |
| Order Entry Date | System generated on Save | |

Subscription and Billing. When the Subscription and Billing option is selected from the Master Order Entry menu, the following fields may be displayed on a user screen. The user may fill out these fields as necessary to record an subscription and billing information for a subscriber who ordered services managed by the SMS.

| | | | Charges |
|---|---|---|---|
| Fields | | | (Non Editable) |
| Subscription Type | Pre-filled Drop | 3 month, 6 month, | $xx.xx |
| | Down | 1 year, 2 year, | Editable for special |
| | | Special Rate | Rate |
| Channel(s) | Check box with | | |
| | available channel, or | | |
| | channels in case of | | |
| | bouquet | | |
| Activation Fee | Pre-filled | Only for subs less | $xx.xx |
| | | than 1 year | |
| Billing Type | Pre-filled Drop | Monthly, 3 months, | $xx.xx |
| | Down | 6 months, 1 year, 2 | |
| | | year | |
| Billing Method | Pre-filled Drop | Mail, electronic | |
| | Down | | |
| Payment Method | Pre-filled Drop | MO, AMEX, | $xx.xx |
| | Down | VISA, MC, | In case of COD |
| | | Cashier's Check, COD | |
| Card Number | Operator | | |
| Expiration Date | Operator | | |
| Verification Code | Operator | | |
| Total Bill | Computed By System | | $xx.xx |

In accordance with one embodiment of the present invention, distributor/dealer orders may be entered through the screens same or similar to the ones used for subscribers with the following field added:

| | |
|---|---|
| Smart Cards for distributor | Operator |

Using this function, the operator may select single or multiple smart cards and move them over into a multiple list box. Each time a smart card is allocated to a single customer or a distributor, it may then be deleted (e.g., automatically) from the master smart card list. When all the smart cards have been allocated from the batch, no smart cards should be left in the system.

The SMS may provide a screen for managing billing information for distributors. This screen may include the following fields:

| | | MO, AMEX, VISA, MC |
|---|---|---|
| Method of Payment | Pre-filled Drop Down | Cashier's check, COD |
| Card Number | Operator | |
| Expiration Date | Operator | |
| Verification Code | Operator | If required |

The following types of users may have access rights to this information:

| | |
|---|---|
| System Administrator | Read/Write |
| Home2US Administrator | Read/Write |
| Channel Administrator | Read/Write |
| Data Entry Operator (Channel) | Read/Write |
| Home2US Operator | Read/Write |
| Shipping Operator | No Access |
| Installer Operator | No Access |

### 3. Transaction Processing

The SMS also performs the following transaction functions related to providing services to subscribers. These functions may also be implemented in association with the report generation function discussed in greater detail herein.

Billing Function. At the heart of the billing activity is the generation of monthly invoicing and the posting of transactions. One business rule that may be implemented is that all invoices are based on a calendar month. If a customer is added to the application in the middle of the month, his bill for the first month will be added to the invoice for the subsequent month. The first bill which the customer receives may therefore be computed by the SMS as follows:
First received bill=number of remaining days of service×(monthly subscription rate/30)+bill for the second month

As an example of this bill calculation, consider Customer A who is entered into the SMS system with a valid subscription on May 15. Customer A will be billed for the remaining days of May+the cost of the subscription for June. Thus, assuming the monthly subscription charge is $20, the first bill that Customer A receives (in June) is: 15×(20/30)+20=$30.

Invoicing Function. The invoicing function generates invoices for customers, e.g., subscribers. This function is automated as much as possible. Based on calendaring as well as information input during implementation of the billing function, the application will prompt the user for an invoice run. An alarm will be triggered on the “invoice run day” and will continue for the remaining “invoice run days” until manually turned off or in case the invoice run has been completed. The alarm may be in the form of a blinking notice that flashes on the screen.

In accordance with one embodiment, customers may be billed in at least two ways: (1) invoice sent by mail or (2) credit card. Additional payment options may also be provided, e.g., direct deposit or on-line bill pay. In generating a bill, an SMS user has the choice of generating invoices by selecting a single, group, or all invoices for customers belonging to category (1) or (2).

For customers to be invoiced, the operator may click a “GENERATE INVOICE” button. The system will then automatically select customers who have to be invoiced, calculate the invoice amounts (being sure to add any previous month's unpaid amount if necessary, late fees etc.), add a line for receipt of last month's payment, and then create corresponding invoices. All customers with invoices ready for printing may be designated with a status of “Invoice Generated” against each row.

A PRINT button will enable printing of the invoices. Similar to invoicing, the SMS user may have the choice of printing invoices by selecting a single, group or all customers with a status of “Invoice Generated” or “Printed” (to all the operator to print an invoice multiple times if required). After making the selection, the user may click the “PRINT” button. The invoices will be printed and the status will return to “Printed.”

For customers who pay with a credit card, invoices may not be generated. A separate option, when selected, will cause a list of all customers in the same tabular format to be displayed. Criteria will then be displayed as follows “select all customers with payment option=credit card.” This screen should have a button “CHARGE CARD.” The SMS user has the choice of selecting single, group, or all customers and select the CHARGE CARD button. The application may interface with an Authorize.net interface and submit the credit card information and expiration date information to charge the customer.

In an Authorize.net application, Authorize.net will be contacted to determine how access can be gained to their API. An interface may then be constructed to their system for the purpose of sending and receiving data from the application. After information is sent to Authorize.net, the application may capture either the transaction number or the status of “ACCEPTED or DECLINED.” Any customer whose is DECLINED will be automatically assessed a Late fee in the next billing cycle and will be designated with the status of DELINQUENT customer if payment is not made.

The status of payments may be reported to customers through their monthly statements. The customer's subscription will be deactivated according to the predefined rules such as those previously discussed. All credit card transactions will generate a STATEMENT for the customer. The format of the statement is discussed below in the Reports section.

Invoice Posting. Receipt of payments is a manual operation and will be initiated on the first day after the “payment due date” and will continue for the duration of the posting period. An alarm or a blinking notice will alert the operator of the posting period. The alarm will continue until manually turned off for the day or until all payments have been posted.

By pressing a Receive Payments on a corresponding screen, a list of all customers will be displayed who have been billed or invoiced. The criteria for selection of records will be “select all customers with a status of Printed.” Each row of data on this screen may have at least the following fields:

| | | | | |
|---|---|---|---|---|
| SMS ID | Name | Status | Amount | Amount Paid |
| (non- | (last name + first | (non-editable) | Invoiced | (operator) |
| editable) | name) | | (non- | |
| | (non-editable) | | editable) | |

Clicking on headers of SMS-ID, name and Status will cause the SMS to automatically sort the data. During the posting period, the operator will manually enter all checks or money orders received in the “Amount paid” field. The operator has the choice of saving a single record, group of records or all of the records in one shot by pressing the “SAVE” button.

Signal Activation. Signal Activation for the first time may be performed after the first payment is received from the customer. The SMS user will post the first payment either against an invoice or a call center will charge the customer's credit card. In most cases, signal activation will be performed automatically by the system or manually by Home2US or a Channel Administrator. The user should be able to select all subscribers who have paid their first bill, which includes charges for hardware, shipping, installation, and subscription.

Furthermore, by selecting “Activation” button on a corresponding screen, a function will be called that interfaces with the CAS (implemented, for example, by Home2US). When a simulcrypt environment is selected, Irdeto and Viaccess are both supported.

The SMS may generate a screen which includes the following fields associated with the signal activation function of the system:

| | | |
|---|---|---|
| SMS ID | Pre-filled | Non-editable |
| Name: | Pre-filled | Non-editable, concatenated field |
| Smart Card No: | Operator | Required |

Additional fields on this screen may include:

| | | |
|---|---|---|
| Subscription Status | Drop Down | Active, Deactivated, Hold |
| Status Date | Operator | Date |

The screen may also have a button for Signal Activation. Clicking this button will cause command interfaces of the SMS with Irdeto or Viaccess APIs to send an activation signal to a Conditional Access Server, such as the one shown in FIG. 2 described within a teleport. If successful, the SMS may automatically start the subscription and designation the Subscription Status for that customer as Active with a corresponding Status Date.

In the event the Account is already Active, the button “Deactivate Signal” may be displayed and an additional choice may be provided for a Hold function. Deactivating the signal through this button will cause the SMS to automatically cancel the subscription. Once again, this command interfaces with the Irdeto or Viaccess APIs to send a deactivation signal to the CAS Server. Activation of this account may be subject to a Reactivation Fee, and the Hold option may temporarily suspend the subscription and stop any invoicing during the Hold Period.

Access rights to the signal activation functions of the SMS may be provided as follows:

| | |
|---|---|
| System Administrator | Read/Write |
| Home2US Administrator | Read/Write |
| Channel Administrator | Read/Write |
| Data Entry Operator (Channel) | Read |
| Home2US Operator | Read/Write |
| Shipping Operator | No Access |
| Installer Operator | No Access |

### 4. External Interfaces

The SMS may provide a number of interfaces for allowing external systems or entities to access the system for providing SMS-related services. These interfaces include:

1. Interface with the Address Verification System (AVS)

2. Interface with Shipping Companies

3. Interface with Installers

4. Interface with Merchant Account Applications

AVS Interface. During data entry performed, for example, in implementing the initialization or ordering functions of the SMS, it is possible that a user will input incorrect addresses into the system. This will adversely affect all parts of the application from shipping and installation to billing and invoicing. Before a customer's information is saved in the system, it is therefore important to verify that address information using an AVS, which, for example, may be the same or similar to one used by credit card companies to verify the authenticity of addresses. This program is available from a number of places including the US Postal Service.

Shipping Interface. The SMS may provide a screen for allowing a shipper (e.g., Fed Ex, UPS, etc.) to access information related to SMS services. When the shipper logs into to the SMS system, a summary screen (like the customer list) may be displayed with information on outstanding shipments of equipment for accessing SMS-related multimedia content, as well as other information. (Clicking on an outstanding shipments icon/link may provide a subset of all outstanding orders with null or blank ship dates).

| Fields | | |
|---|---|---|
| Name: | Pre-filled | Non-editable - concatenated field |
| Street | Pre-filled | Non-editable - with data filled |
| | | during order entry |
| City | Pre-filled | Non-editable - with data filled |
| | | during order entry |
| State | Pre-filled | Non-editable - with data filled |
| | | during order entry |
| Zip | Pre-filled | Non-editable - with data filled |
| | | during order entry |
| Telephone: | Pre-filled | Non-editable - with data filled |
| | | during order entry |
| SMS ID | Pre-filled | Non-editable - with data filled |
| | | during order entry |
| Order Date: | Pre-filled | Non-editable - with data filled |
| | | during order entry |

Only the items that are part of an order may be displayed in this embodiment. The editable fields may also be displayed on this screen:

| | |
|---|---|
| Ship Date | Import function |
| Ship Timestamp | Import function |
| Expected Delivery Date | |
| Tracking Number | Import function |
| Smart Card Number | Operator |
| IRD Serial Number | Operator |

The screen may display an option for importing or exporting information associated with the foregoing fields. The objective of a data export is to export the predetermined fields for shipping. The export function may involve tracking all equipment shipped from a fulfillment center to the subscriber.

The tracked equipment may correspond to satellite receivers shipped to subscribers to fill their orders. This process may work as follows. First, prior to shipping an installation kit to the subscriber, the fulfillment center will scan the serial number of the receiver. This serial number may be reported on the customer ship screen. This will enable Home2US to track receiver shipments going to each subscriber. This function may also be a part of the shipping module.

Installer Interface. The SMS may provide a screen for allowing installers to access SMS information. The installers may either be employees of the company implementing SMS (e.g., Home2US) or third-party entities. According to one embodiment, clicking on an installation option included in any of the aforementioned screens may cause the SMS to generate a screen that lists a subset of orders for a certain period of dates, e.g., a current date, dates for an upcoming week or month, etc. The SMS may also provide information on expected delivery dates linked to the type of installations to be performed on those dates.

Fields that may be included in an SMS screen relating to this information are as follows:

| Fields | | |
|---|---|---|
| SMS ID | Pre-filled | Non-editable filled during order entry |
| Name: | Pre-filled | Non-editable - concatenated field |
| Shipping | | |
| Address | | |
| Street | Pre-filled | Non-editable - with data filled during order entry |
| City | Pre-filled | Non-editable - with data filled during order entry |
| State | Pre-filled | Non-editable - with data filled during order entry |
| Zip | Pre-filled | Non-editable - with data filled during order entry |
| Tele- | Pre-filled | Non-editable - with data filled during order entry |
| phone: | | |
| SMS ID | Pre-filled | Non-editable - with data filled during order entry |
| Order | Pre-filled | Non-editable - with data filled during order entry |
| Date: | | |
| Expected | Import | |
| Delivery | function | |
| Date | | |

Information included in these fields may be exported to the installer, and an import function may then be performed which causes the Expected Delivery Date field to automatically be filled in based on information electronically received from the installer.

The following editable fields may also be included with the screen generated for the installer interface:

| | | |
|---|---|---|
| Installation Sch. Date | Operator | |
| Installer Name | Operator | |
| Installer Company | Operator | |
| Installer Contact Number | Operator | |
| Installation Completion Date | Operator | |
| Remarks | Operator | |
| Created by: | System generated | Store userid |
| Late Updated | System generated | Store date and |
| | | timestamp |

Access rights to the information provided for the installer interface, including the shipping information in the fields listed above, may be provided as follows:

| | |
|---|---|
| System Administrator | Read/Write |
| Home2US Administrator | Read/Write |
| Channel Administrator | Read |
| Data Entry Operator (Channel) | Read |
| Home2US Operator | Read |
| Shipping Operator | No Access |
| Installer Operator | Read/Write |

Merchant Account Interface. The Merchant Account interface may be provided in association with the discussion of Authorize.net in connection with invoice, billing, and payment verifications functions performed in associated with the transaction screens.

### 5. Export and Import Functions

The SMS may perform a variety of import and export functions, many of which are associated with and have been described in connection with the external interfaces described in the previous section. A more detailed explanation of these functions and/or a description of other import or export functions provided by SMS are set forth below.

Export Functions. The data entered into the shipping screen generated for the shipper's interface may be converted into a predetermined (e.g., .csv) format and then imported into the shipping carrier's application. The selected fields in the SMS system are mapped exactly to the fields on the Recipient Information section of, for example, a FedEx application. An example of this Recipient Information is provided below:

Recipient Information

Company Name:

Contact Name:

Address 1:

Address 2:

City:

State:

ZIP:

Telephone:

Your Reference:

The fields in bold are considered to be required fields. For the “Your Reference” field, the SMS-ID may be used. This ID will be printed on each of the mailing labels and will help us cross-reference and track the shipment. (From the SMS database, only records that have a ship date of “Null” may selected. Alternatively, this field may be left blank.) Once the shipper prints off a shipping label, the shipper may create a Microsoft Excel file (interim solution) with data imported back from the shipper, e.g., FedEx. This data import function may be defined as follows.

Import Functions. The purpose of the Import function is to capture the shipping information from the shipper (e.g., FedEx) application and bring it into the SMS. The shipper application report generates a .csv file which may include the following data fields:

Reference Number (SMS ID)

Tracking Number

Date of Shipment

Timestamp

The important function may also include capturing warehouse information in an inventory application. This function would, for example, track the serial number of equipment stored in the warehouse, track the serial number of equipment taken from the warehouse for installation, match a smart card assigned to equipment corresponding to customer orders, as well as other functions. Reports corresponding to this information may also be generated by the system.

The import function of SMS will read the .csv file, match the SMS-ID and put the corresponding tracking numbers and shipment timestamp into SMS for this entry. Access rights to this information may be given to users as follows:

| | |
|---|---|
| System Administrator | Full Access |
| Home2US Administrator | Full Access |
| Channel Administrator | No Access |
| Data Entry Operator (Channel) | No Access |
| Home2US Operator | Full Access |
| Shipping Operator | Full Access |
| Installer Operator | No Access |

A similar interface may be provided for UPS and other shipping companies.

### 6. Reports

The SMS may generate a variety of reports in assisting SMS personnel in managing various the functions and information managed in connection with providing multimedia services to subscribers. A sample listing of these reports includes:

Monthly Customer Invoices

Monthly Statements for Credit card Customers

Outstanding Invoices

Outstanding Shipments

Smart Card Allocation

Distributor Shipment

Search List Report

Outstanding Installations

Installations planned by date

Installation History

Order Shipped

### Additional Features and Functions

The SMS may be implemented to include a variety of additional features. For example, screens that support functions of the SMS performed on multiple records stored in the system database may be presented in tabular form. Examples of these screens include those associated with invoicing, smart card management (e.g., activation/deactivation), credit card processing, invoice posting, and signal activation. When presented in tabular form, each row of data may have a check box to allow for operation on a single record, multiple records, or all records simultaneously. Double clicking on any row of data will open details and information corresponding to records associated with that row. Both of these screens should have the same buttons to perform similar functions.

The SMS may also implement a dynamic search function, the details of which were previously discussed. The dynamic search function allows a user to build a search criteria for specifically sought-after data records. A resulting “WHERE” clause may be generated dynamically as the operator selects one or more items. The data may be displayed in a list format that allows users to see multiple records on one screen.

Examples of data fields that may be used to build the search criteria include:

SMS ID

First Name of customer

Last Name of customer

State

Customer Type

Subscription Type

Ship Date

Installation Completion Date

Subscription Status

The data fields may be displayed as drop-down boxes in column format. This would allow the user to select the fields without having to enter or type a field. The user may also have the option of selecting And, Or, or other Boolean operators for combining data fields in a single search. To perform a search, a SEARCH or a GO button may be provided for selection. Fields to be displayed on the screen in list format include:

SMS ID

Name (Concatenated Field)

Address (Concatenated filed, Address, City, Zip)

Contact

Company

Order No

Ship Date

Installation Type

Smart Card Number

Invoice Number

Last Invoice Paid

Subscription Status

Status Date

If no records matching the search criteria are found, the system may returns a message indicating “0 records found. Please enter another search criteria.” As an example, a search criteria may be formulated for an Order Entry >1/1/04 and <3/2/04 and a Payment Option=Credit. Clicking on search button for this search criteria will cause a data set of customers to be displayed who were entered into the system between Jan. 1, 2004 and Mar. 1, 2004 and who are designated as paying with a credit card. All data displayed from a search may be printed via a Report function discussed in the Reports Section herein.

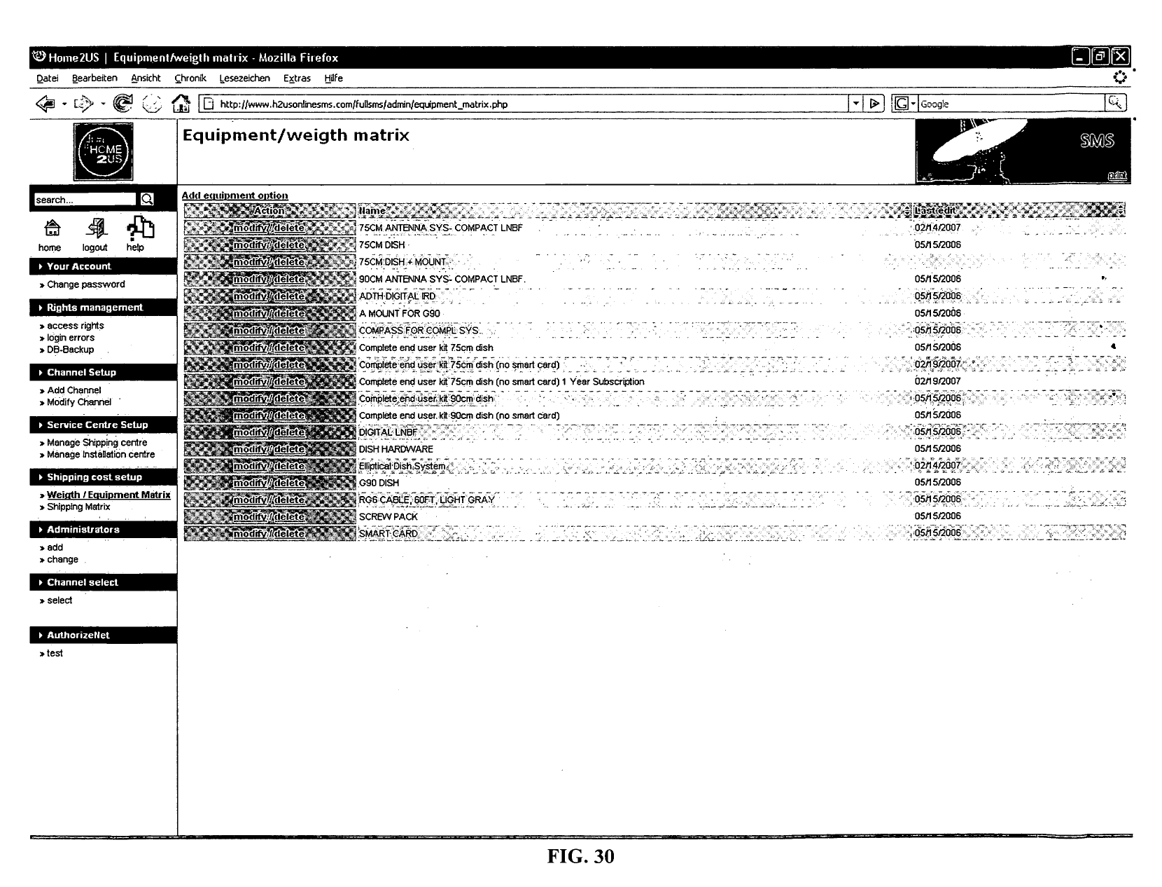

The SMS may generate a number of additional screens for managing the functions of the system. FIG. 30 shows a screen that provides a list of equipment that is required for installation at subscriber locations for receiving SMS multimedia services. This list may include a choice of low-noise amplifier/blocking circuits (e.g., dual, triple, quad, standard, etc.), satellite antenna, smart card, self-install kit, as well as others.

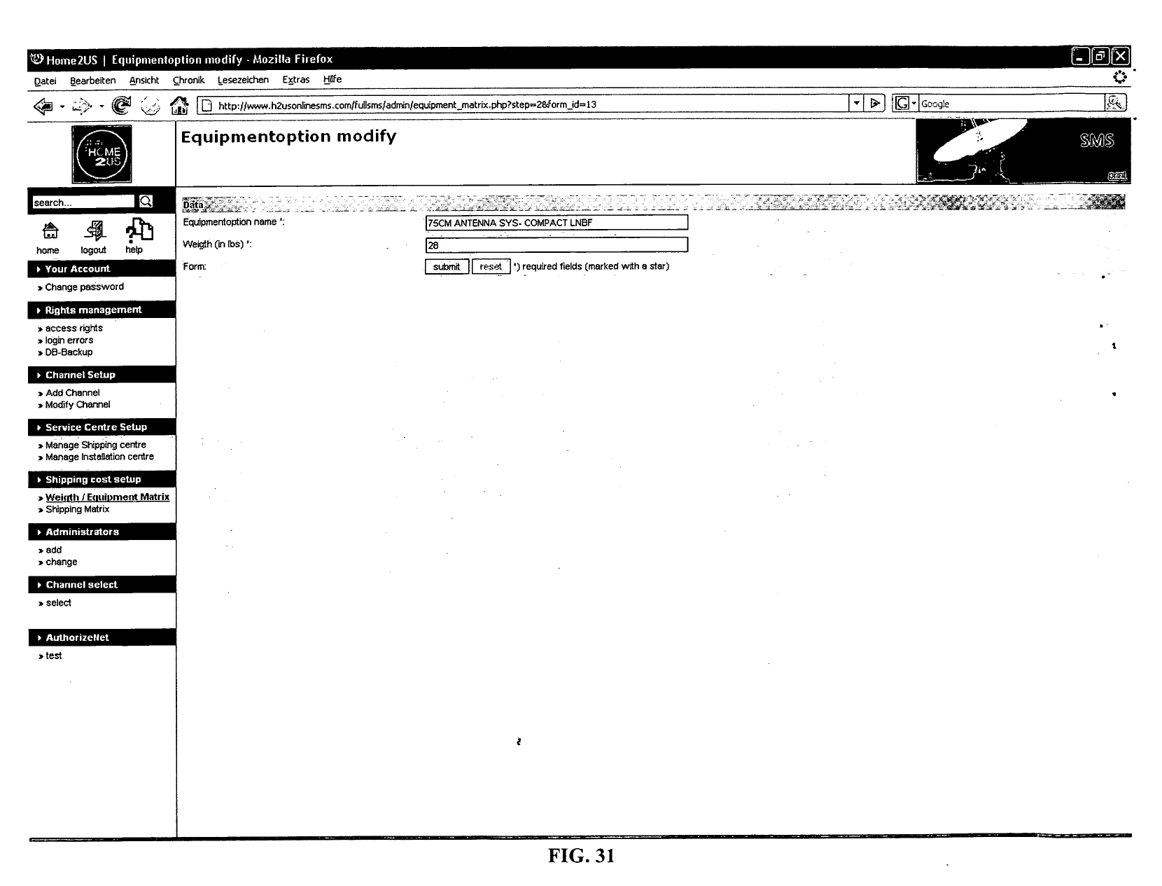

FIG. 31 shows another screen that may be generated when, for example, an equipment option is selected from the screen of FIG. 30. When such a selection is made, information corresponding to the equipment may be displayed along with its weight, as well as other information.

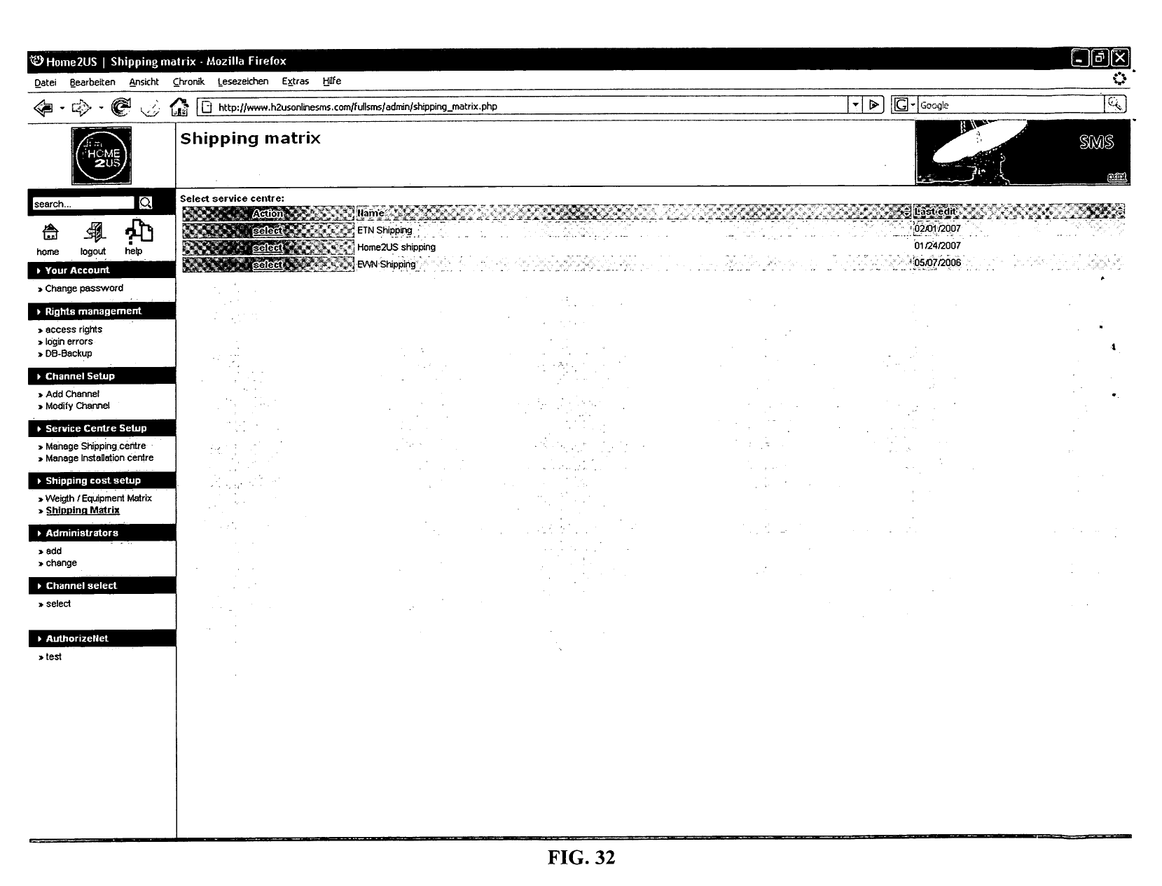

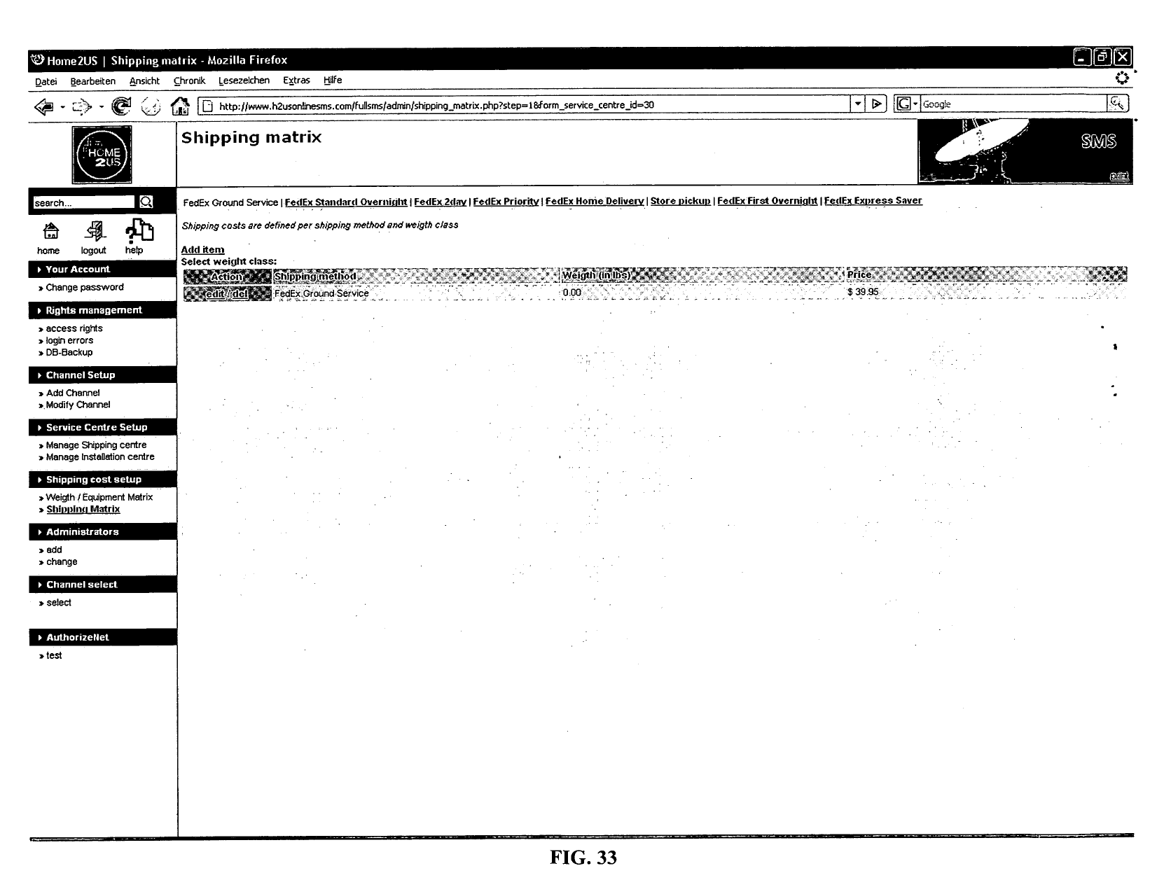

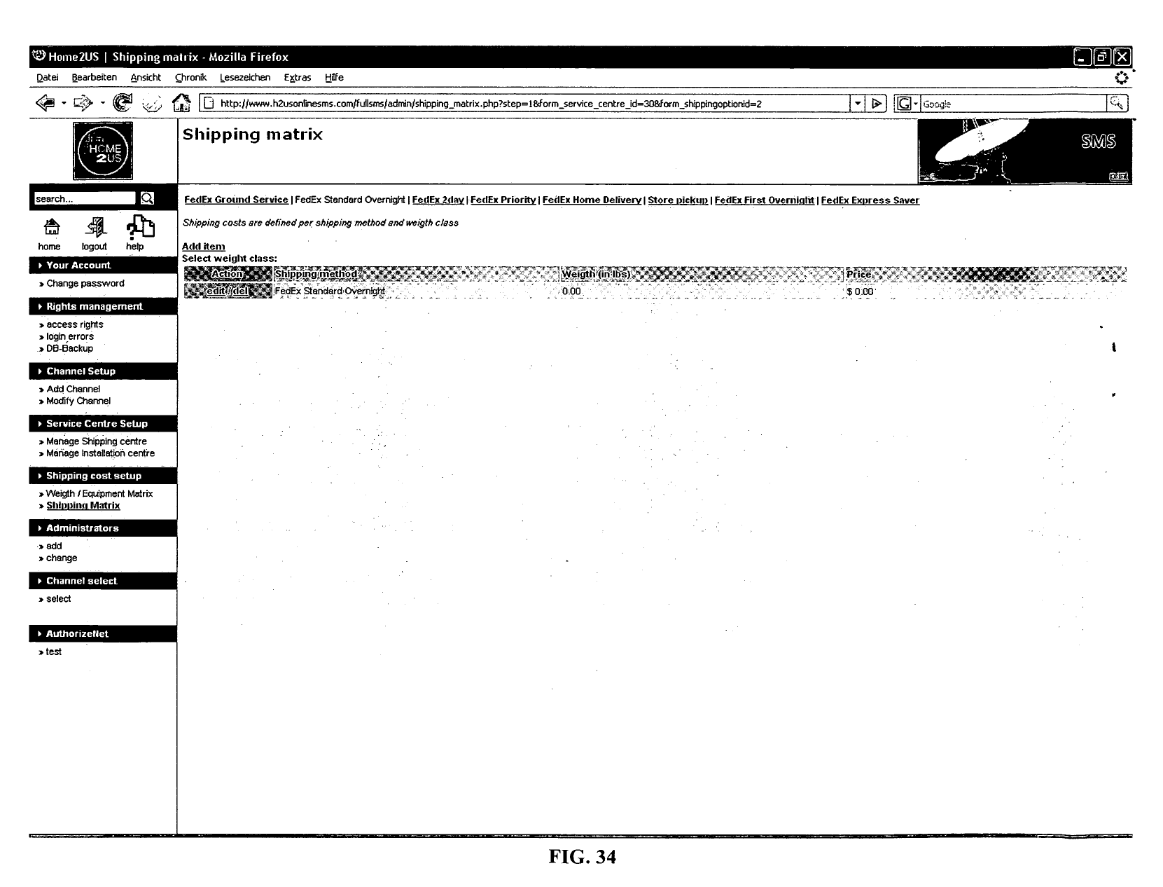

FIG. 32 shows a shipping matrix screen that may be generated by the system, and FIGS. 33 and 34 show screens on the cost charged by various shippers for various shipping methods. According to one embodiment, these screens may be automatically generated based on equipment selected from the equipment/weight matrix list of FIG. 30. For the equipment selected, the system may automatically compute the total weight of all equipment selected and their associated costs for a given shipper (e.g., Fed Ex) as shown in FIGS. 33 and 34. Alternatively, the FIG. 33 may provide information on shipping costs (e.g., through Fed Ex or UPS) for different weight classes.

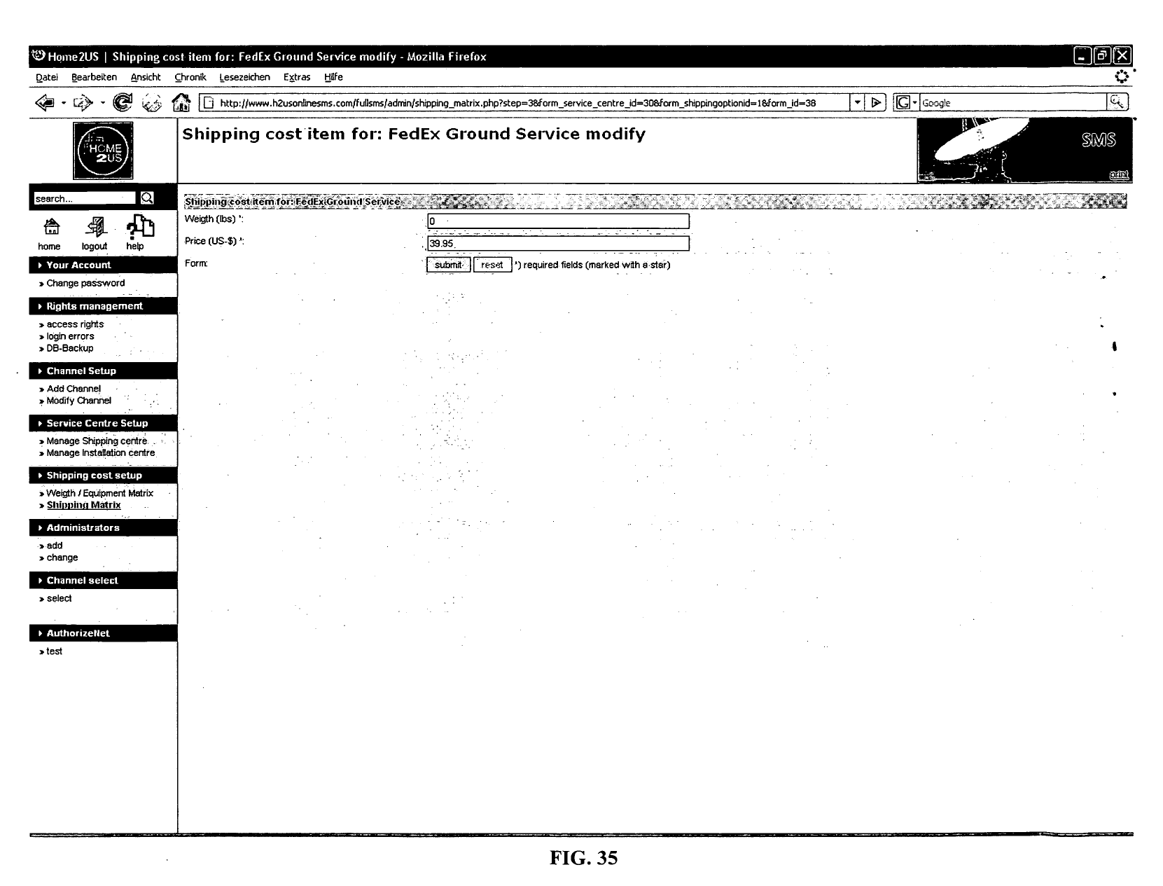

FIG. 35 shows another screen that shows cost-weight information for ordered SMS equipment. The fields shown on this screen may be automatically filled in based on information entered in connection with other displays in the system.

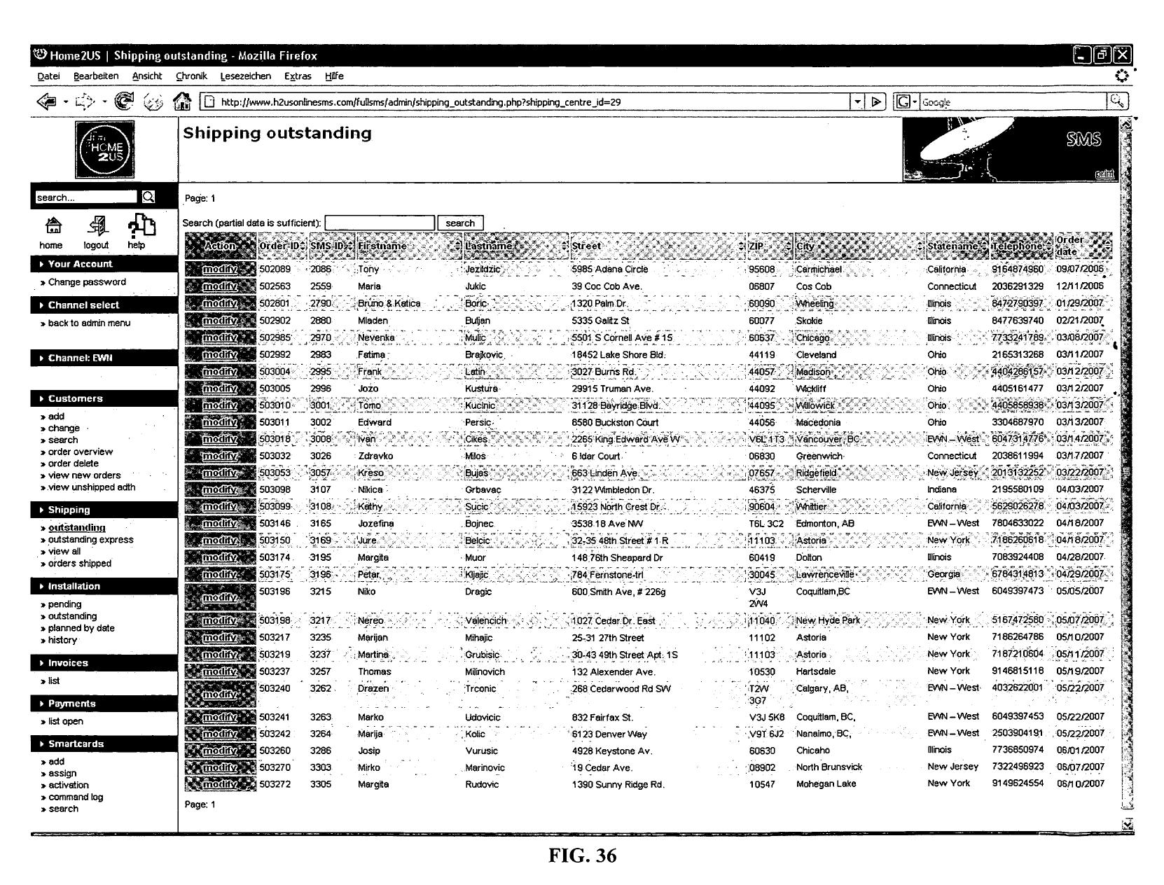

FIG. 36 shows a screen that displays information on outstanding shipping orders. The information may identify subscribers, for example, by name, address, SMS identification code, and order date. The fields shown on this screen may be automatically filled in based on information entered in connection with other displays in the system.

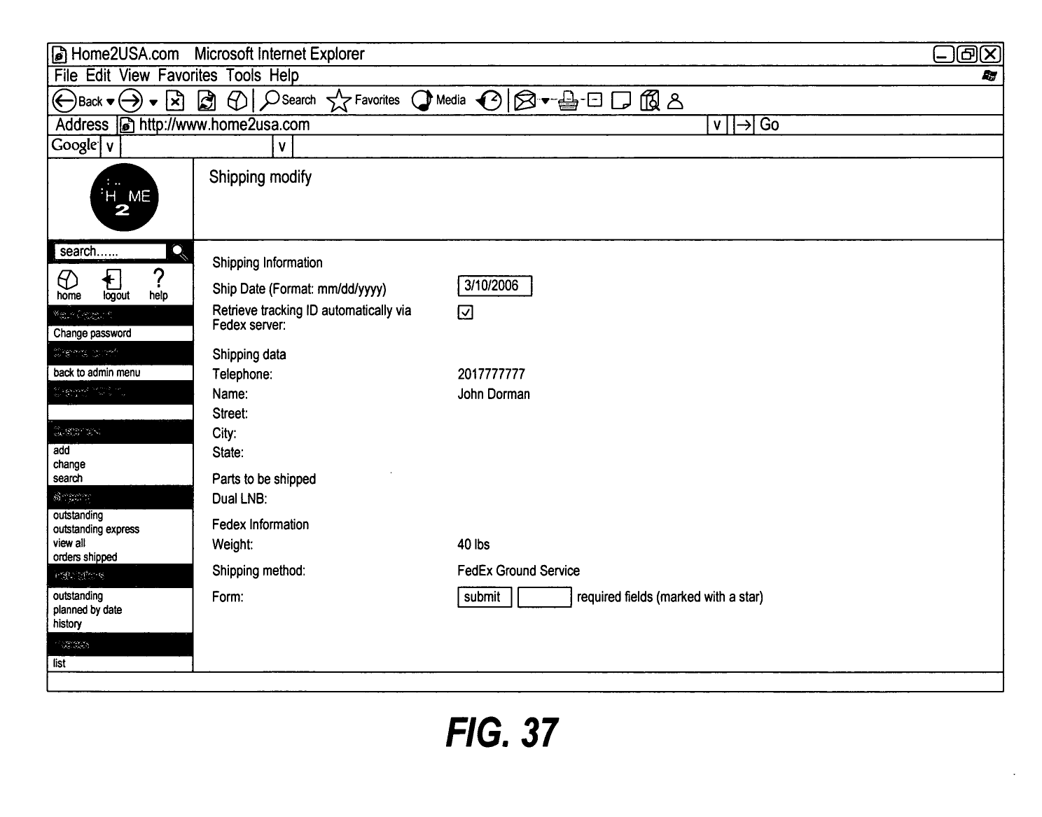

FIG. 37 shows a screen that displays shipping information for a particular subscriber listed in the screen of FIG. 36. The shipping information may include the equipment that was ordered and shipped, the combined weight of the equipment that was shipped, the date and method of the shipment, the shipping address, and tracking information. As with other functions, this SMS screen may be programmed to automatically import the tracking number from a server of the shipper (e.g., a Fed Ex server) to allow customer service personnel to answer any questions a subscriber may have. The fields shown on this screen may be automatically filled in based on information entered in connection with other displays in the system.

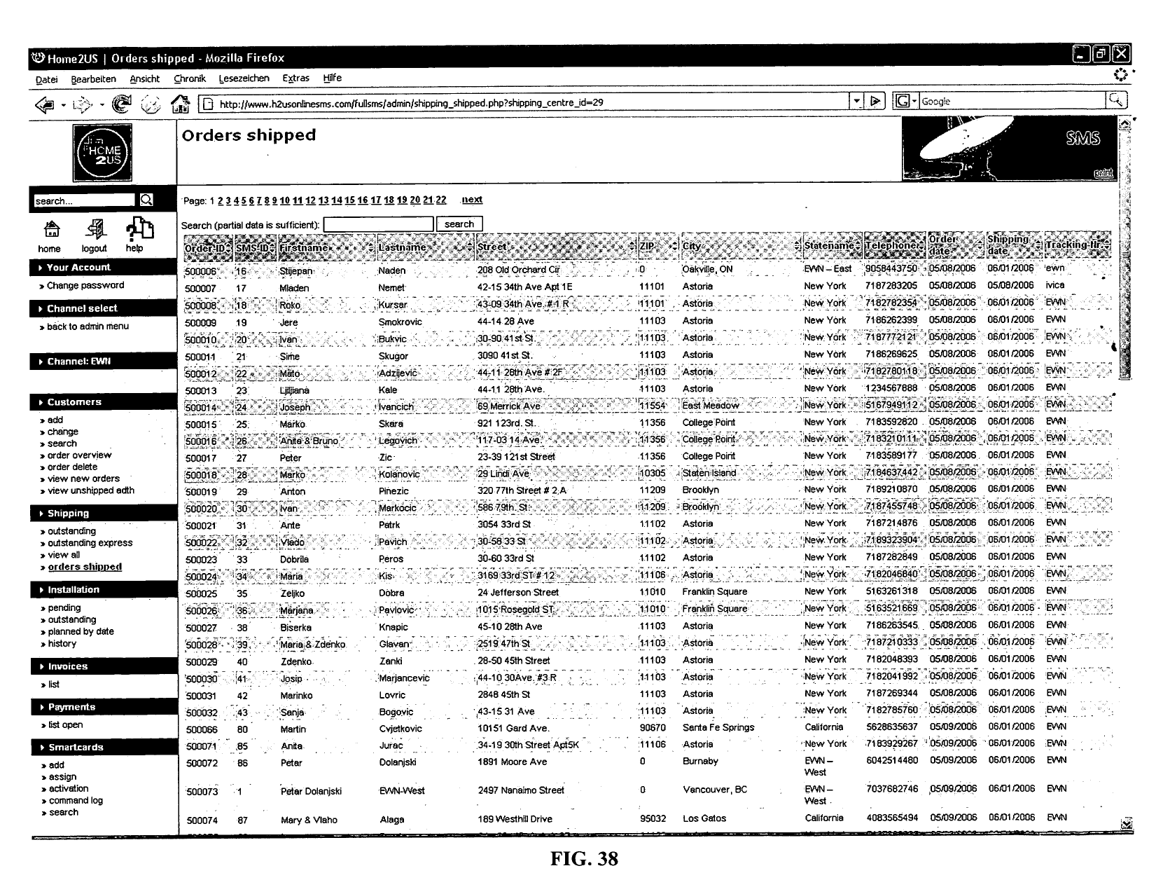

FIG. 38 shows a screen that displays a list of orders that have been shipped, along with the order date, shipping date, tracking number, and other information relating, for example, to the shipping address and subscriber identification. The fields shown on this screen may be automatically filled in based on information entered in connection with other displays in the system.

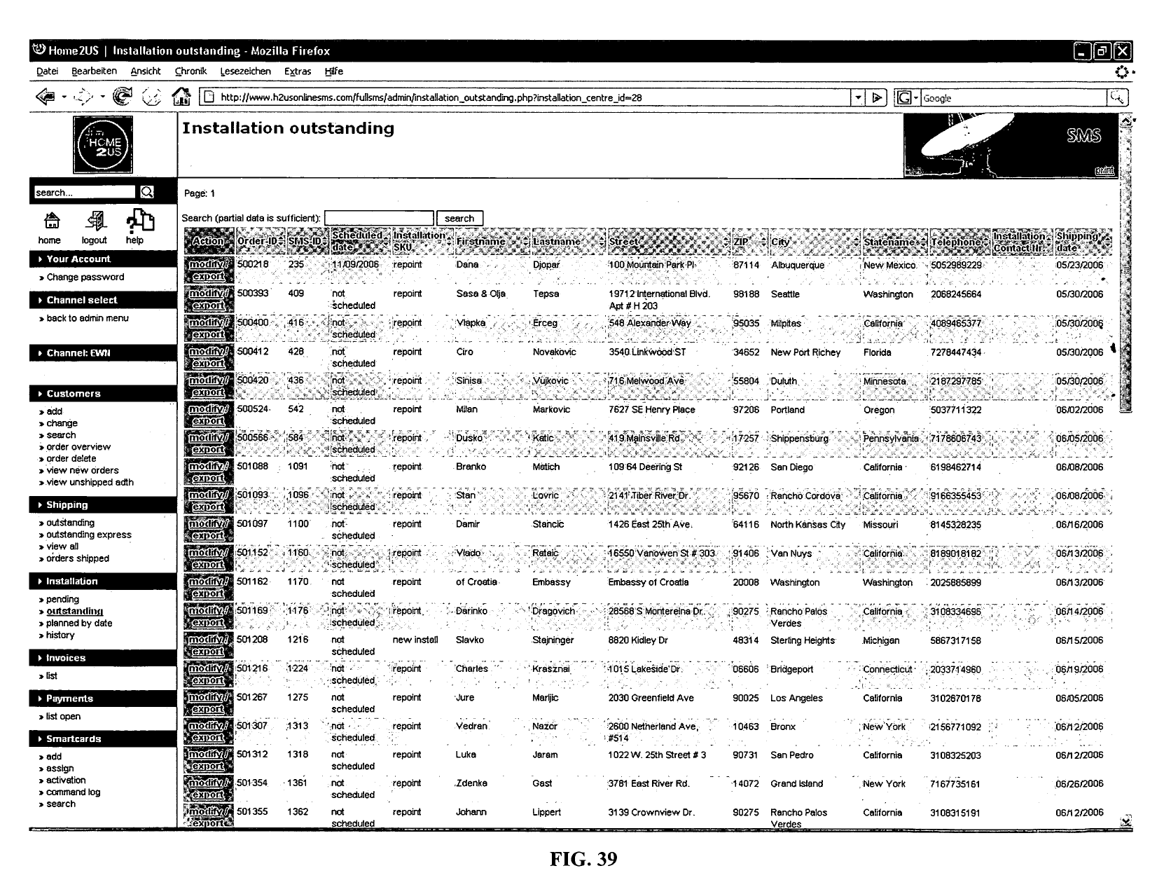

FIG. 39 shows a screen that displays information on outstanding installations to be performed. This information may identify subscribers, for example, by name, address, and SMS identification code. This screen may also display the order and shipping date corresponding to the installation. The order and shipping fields may be automatically filled in based on information entered in connection with other displays in the system.

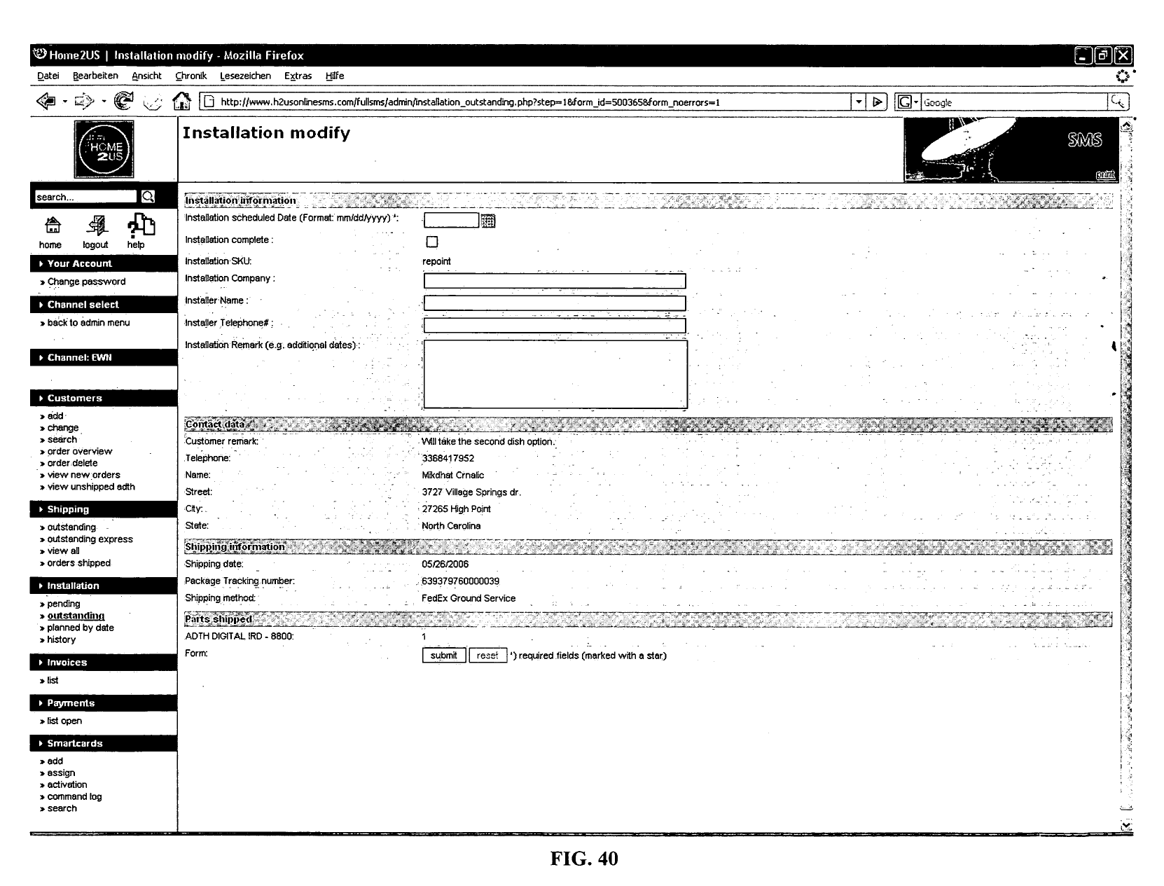

FIG. 40 shows a screen that allows an SMS user to track and/or modify an installation schedule. This screen identifies the scheduled date of installation, an indication whether the installation has been completed, subscriber information, and shipping information. The shipping information may include an identification of the shipper and the shipping method, the shipping date, and a tracking number, as well as the parts that were shipped for installation. The fields shown on this screen may be automatically filled in based on information entered in connection with other displays in the system.

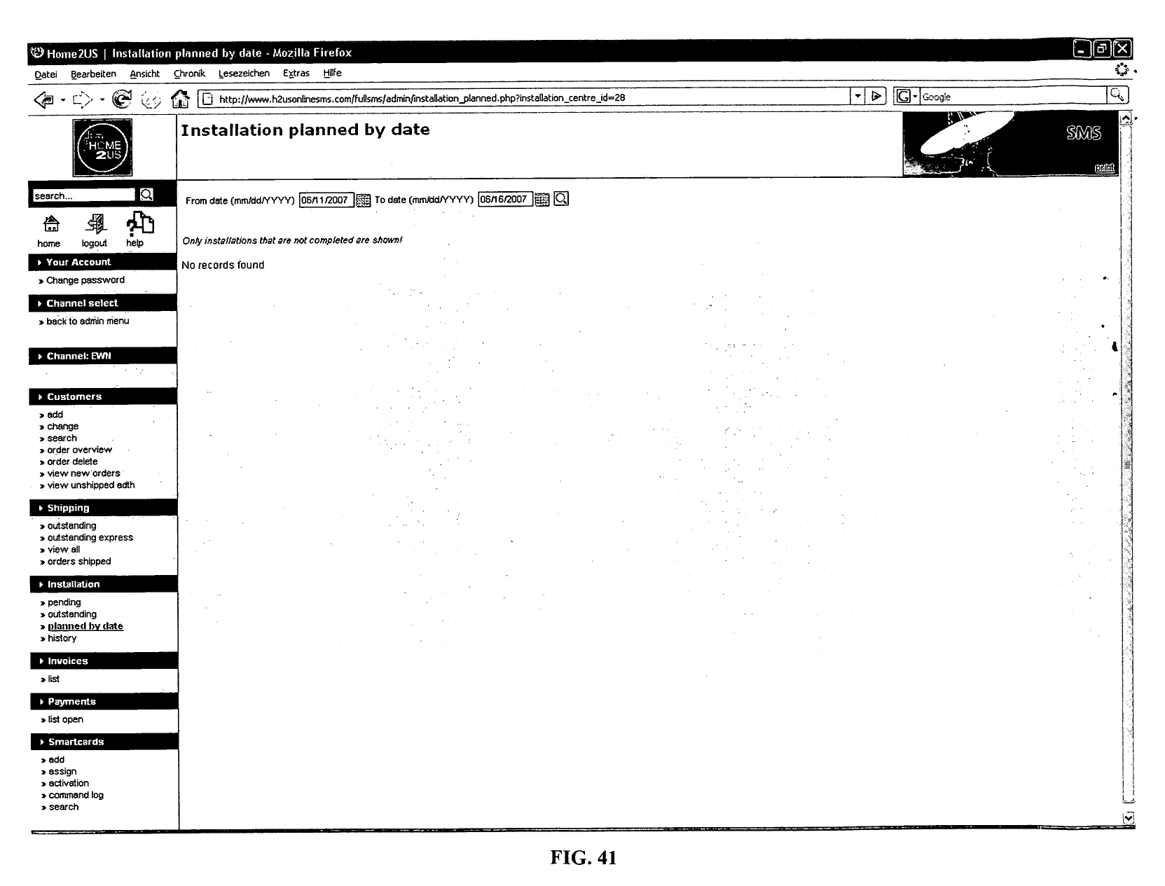

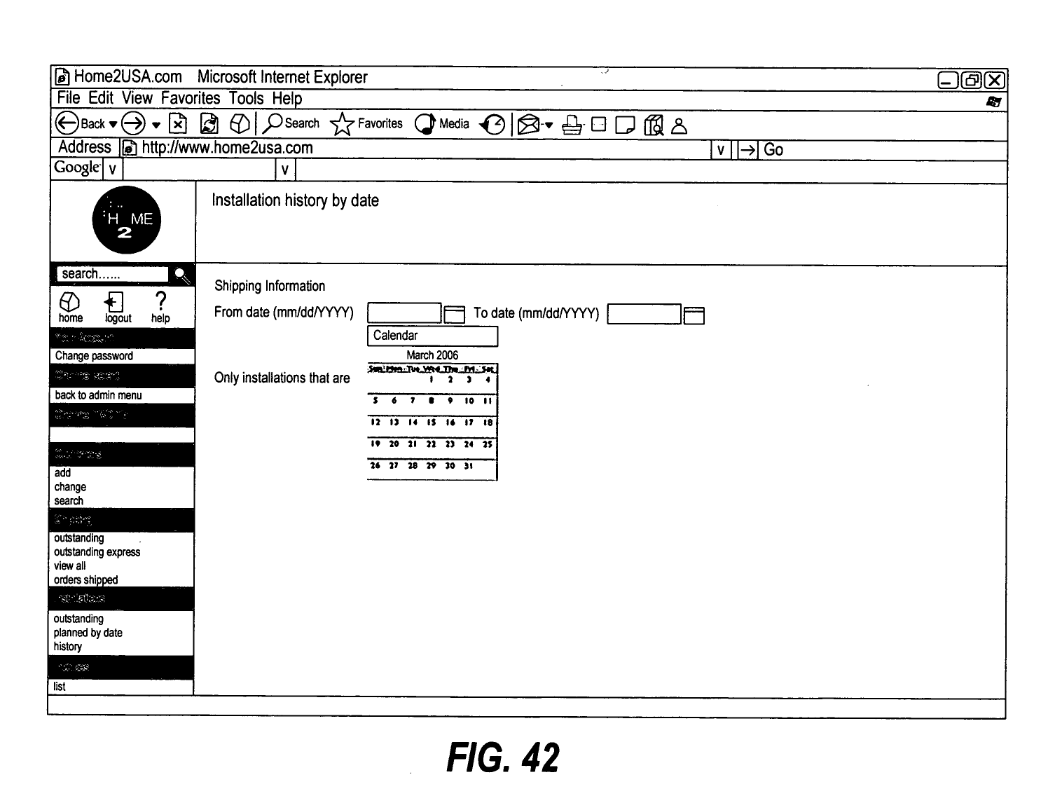

FIG. 41 shows a screen which allows an SMS user to search a range of dates of scheduled installations of equipment, and FIG. 42 allows the user to search a history of installations that have already taken place. These searches may be performed with the assistance of a drop-down window that includes a calendar that will assist a user in defining a date range for the searches.

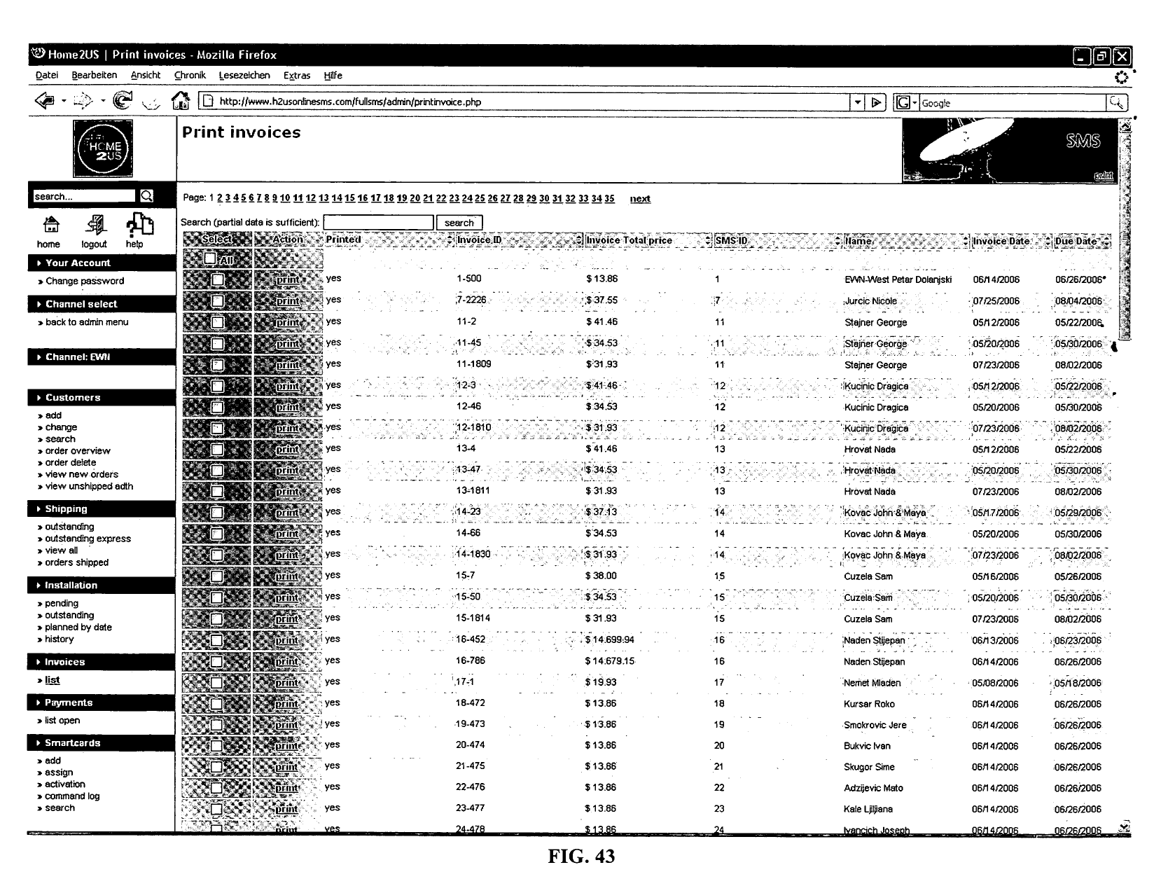

FIG. 43 shows a screen that displays invoice information. This information identifies invoices by invoice number, price, and the subscriber, as well as the date the date of the invoice and the date payment is due. The fields shown on this screen may be automatically filled in based on information entered in connection with other displays in the system.

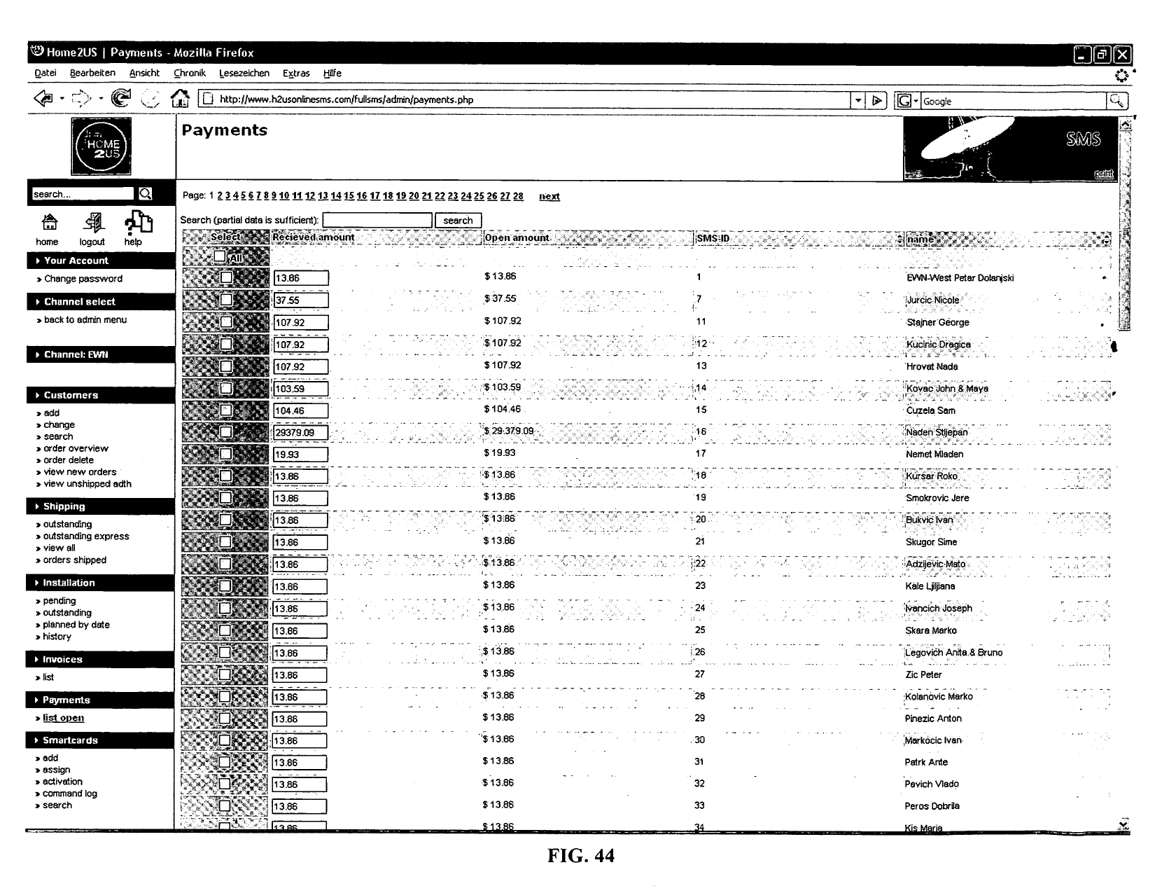

FIG. 44 shows a screen that displays invoice payment information. This information includes the amount of payment received and subscriber identification information. The fields shown on this screen may be automatically filled in based on information entered in connection with other displays in the system.

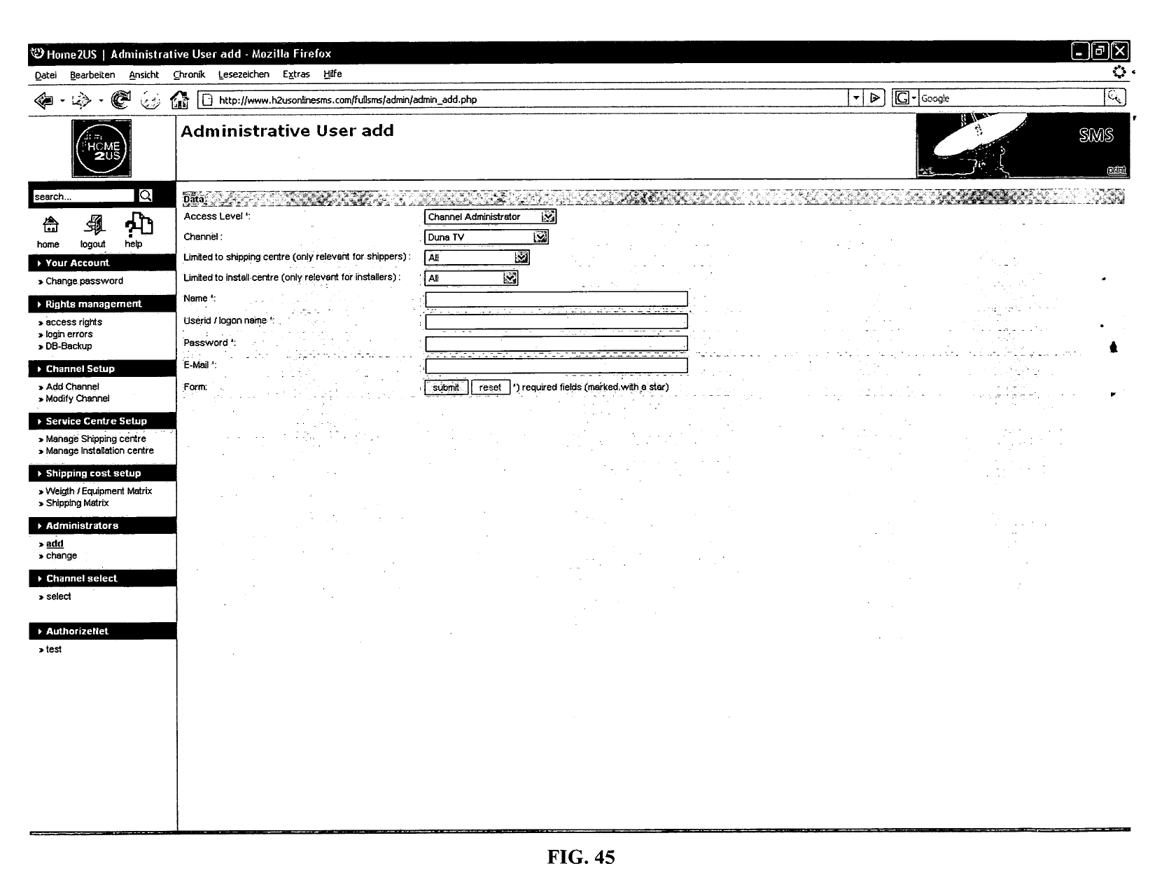

FIG. 45 shows a screen that allows an administrative user to be added to the SMS system. This screen identifies the new user by name, userid and logon, password, e-mail and other pertinent information. The screen also includes fields for designating an access level of the new user, the channel(s) over which the user has control, as well as related shipping and installation information. The fields shown on this screen may be automatically filled in based on information entered in connection with other displays in the system.

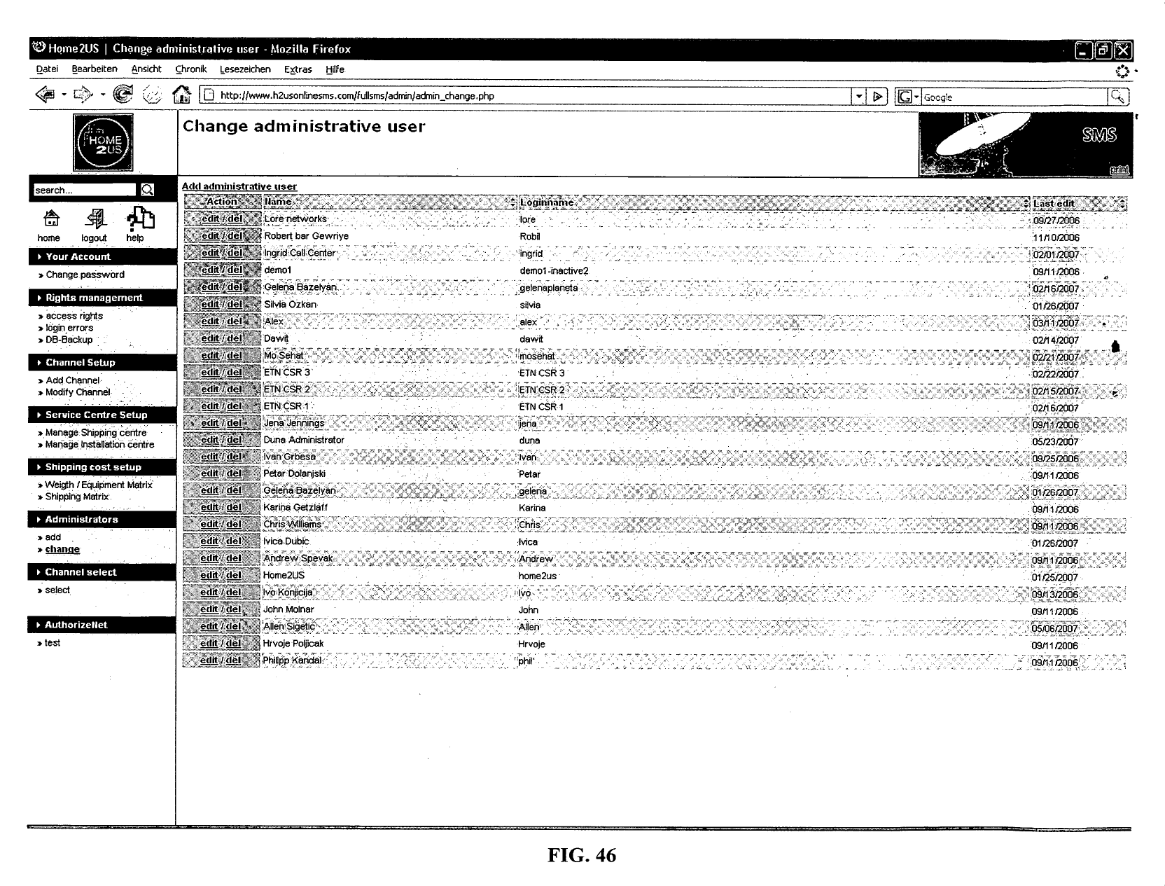

FIG. 46 shows a screen which allows an SMS user to modify information corresponding to administrative users registered in the system.

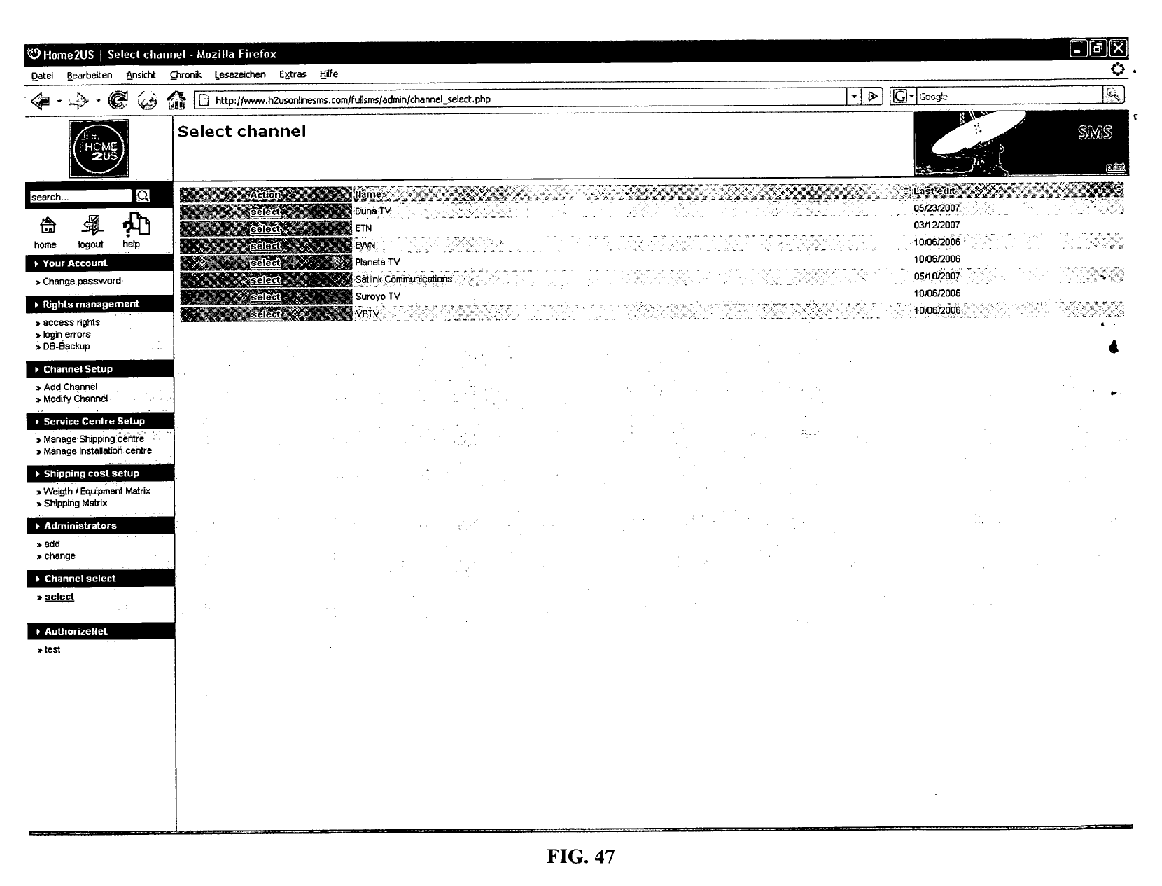

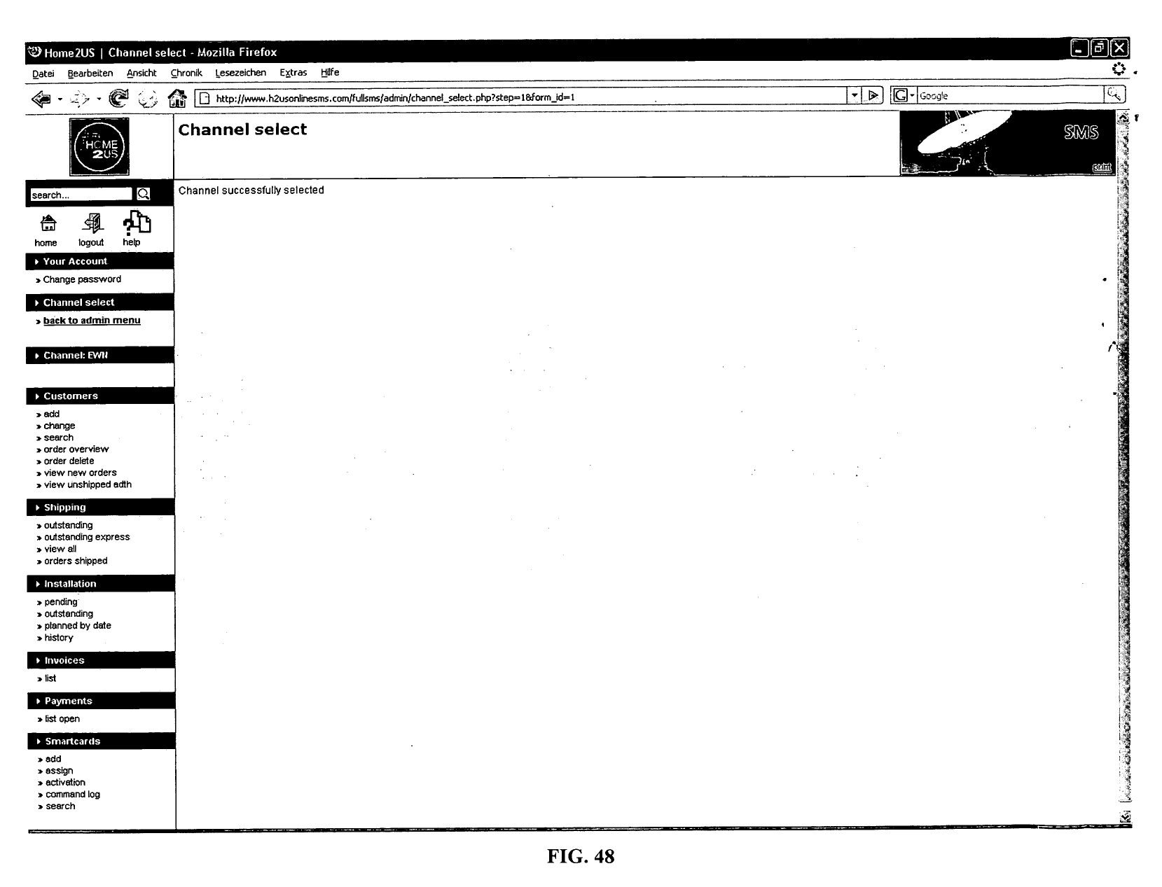

FIGS. 47 and 48 show screens that display channels selected by a particular subscriber. This screen may be provided in lieu of or in combination with other screens previously discussed that provide similar information.

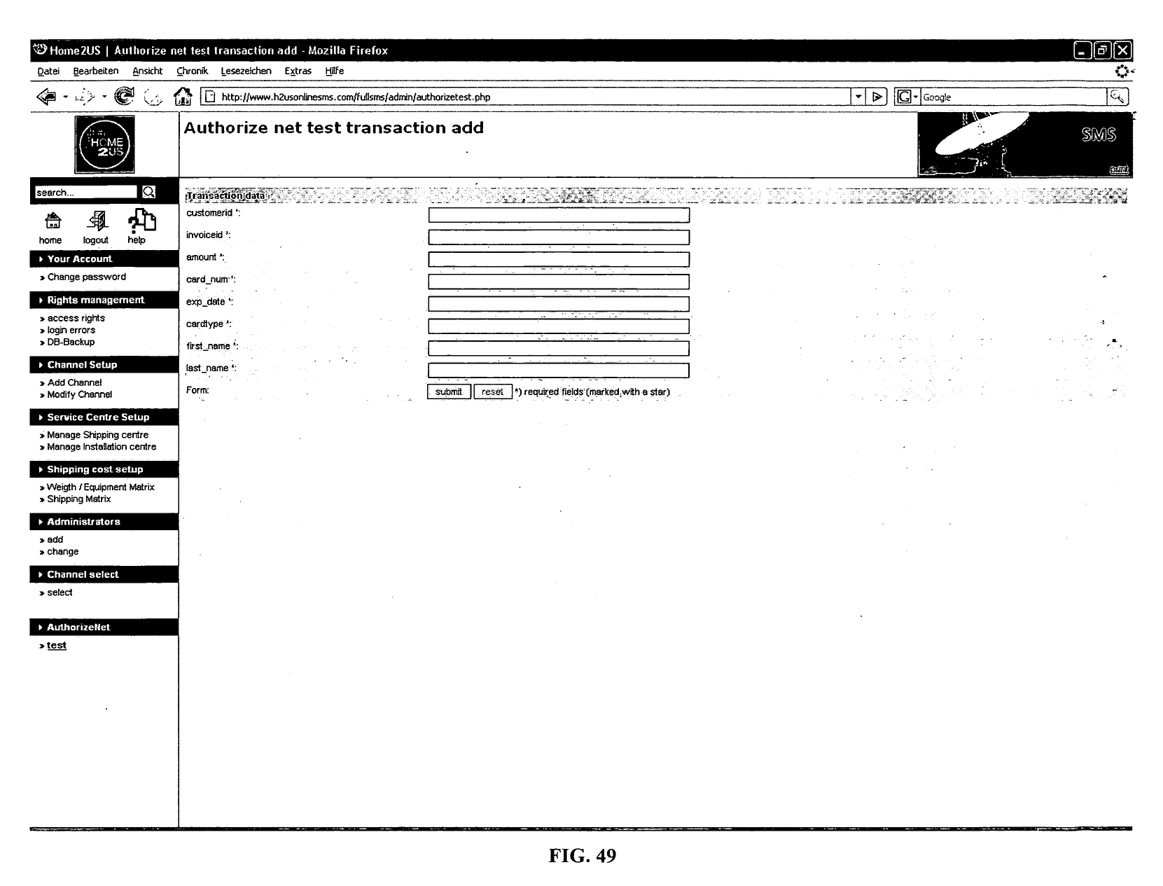

FIG. 49 shows a screen that allows a user to add an Authorize.net (previously discussed) test transaction. This screen includes fields for identifying a customer id, invoice id, amount of the invoice, credit card number and expiration date, card type, and name of the paying subscriber.

FIGS. 50(a) and 50(b) show one embodiment of a bank of software modules that may be used to generate the screens and control operation of the SMS system previously discussed. The software modules include an administrative module 100, a channel module 200, a subscriber module 300, a shipping module 400, an installation module 500, a signal activation module, 600, and a billing module 700. Flow diagrams specifying the process steps that may be performed by each of these modules is also included in this figure.

The administrative module 100 performs access control functions 101, administrative setup functions 102, utilities applications 103, shipping centers setup 104, installation center setup 105, equipment weight matrix functions 106, and matrix/weight shipping functions 107. Screens describing each of these functions are discussed above along with their attendant functions. The administrative module also includes a function 108 for automatically, or manually, interfacing with the channel module for performing additional functions of the system.

The channel module 200 performs channel set up functions 201, subscription rate functions 202, administrative channel rate functions 203, billing policy identification 204, billing cycle functions 205, equipment pricing 206, and shipping price functions 207. Screens describing each of these functions are discussed above along with their attendant functions. The channel module also includes a function 208 for automatically, or manually, interfacing with the subscriber module for performing additional functions of the system.

The subscriber module performs order entry functions 301, shipping preferences function 302, and an installation preferences function 303. Screens describing each of these functions are discussed above along with their attendant functions. The subscriber module also includes a function 304 for automatically, or manually, interfacing with the shipping module for performing additional functions of the system.

The shipping module performs fulfillment functions 401, Shipper (e.g., Fed Ex) integration functions 402, and shipping management 403. Screens describing each of these functions are discussed above along with their attendant functions. The shipping module also includes a function 404 for automatically, or manually, interfacing with the installation module for performing additional functions of the system.

The installation module performs installation scheduling functions 501, installation management functions 502, and provides one or more interactive functions 503 for receiving feedback from subscribers and/or installers on the installation process. Screens describing each of these functions are discussed above along with their attendant functions. The shipping module also includes a function 504 for automatically, or manually, interfacing with the signal activation module for performing additional functions of the system.

The signal activation module performs a function 601 for adding smart cards, a function 602 for assigning smart cards, and a signal activation function 603 which allows a subscriber to access selected channels using the smart card and installed equipment. Screens describing each of these functions are discussed above along with their attendant functions. The signal activation module also includes a function 604 for automatically, or manually, interfacing with the billing module for performing additional functions of the system.

The billing module performs invoicing functions 701, collection functions 702, payment gateway integration functions 703, credit card collection functions 704, transaction posting functions 705, notices delay/delinquency functions 706, statement-generating functions 707, and a function 708 for performing account reconciliation and for generating various reports. The SMS system may allow a user to access each software module in series or a user may be permitted to jump between software modules in any desired order in managing SMS services.

FIG. 51 shows an exemplary embodiment of a system that may be used to manage SMS services in accordance with the present invention. The system includes a central management center 1000 which includes memory 1010 for storing a bank of software modules 1010 such as shown, for example, in FIG. 49, an information database 1020 for storing information used by the SMS to generate the screens and manage the functions described herein, and one or more SMS processors incorporated within a processing subsystem 1030 that executes management functions based on the software modules and information contained in the database and imported from one or more third-party servers.

The system may be at a central location or parts of the system may be geographically dispersed and linked together by a network. The system further includes a variety of communication links, including a link to one or more call centers 1100 having users who interface with SMS multimedia subscribers to perform setup and troubleshooting, to answer payment-related questions, and to handle other subscriber requests. Subscribers may contact the call center through the internet or by phone, and each of the call centers themselves may interface with the SMS management center through an IP connection via, for example, through FTP file transfers.

The system may also perform one or more of the aforementioned import and export functions through external interfaces 1210 and 1220. These interfaces may link the SMS management center to servers 1310 and 1320 hosted by shippers and/or installers of SMS equipment. Corresponding scheduling and status procedures may be performed through these connections, and the shipper and installers may only be given limited access rights to SMS information through these connections.

The system also includes a number of communication links 1400 to the satellite operator teleports 1510 and cable television systems 1520 dispersed regionally throughout the target country. These links may be used to carry signal activation and content authorization and control information for providing SMS multimedia to system subscribers. The system also includes a variety of communication links to billing/invoicing systems 1600, smart card vendors and activation personnel 1700, and equipment suppliers 1800.

The SMS system may have a different configuration in other embodiments. Moreover, the SMS may used for any digital rights management (DRM) application riding over satellite, wireless (GSM, CDMA, IMT, etc.), fiber, or CATV (cable) network, or any other network that utilizes an identifiable smart card that includes a chip set which can be addressed/targeted by a one or bi-directional communication system.

Heretofore, the customer of the SMS has been discussed as corresponding to a subscriber. While this may be the case for some embodiments, other customers of the SMS may be shippers, installers, or other third-party entities that are required to perform functions for implementing SMS services. Selecting the customer type (e.g., subscriber, distributors, shipper, installer, etc.) in an initial portion of any of the aforementioned screens may therefore automatically define a mode of operation of the SMS and/or call other software modules for performing related SMS functions. For example, selecting “Subscriber” as the customer type may automatically cause the SMS to open two other sections for Shipping and installation, and Subscription Info. Such a selection may be made, for example, in association with the Master Order Entry (Distribution/Dealer) of the SMS.

According to an alternative embodiment, the web-based application may include the full array of management functions listed above or a subset (i.e., a so-called “lite” version) of these functions may be provided depending, for example, on the user accessing the system and the level of security to be accorded to that user.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

We claim:

1. A subscriber management system, comprising:
a memory to store a plurality of software modules;
an interactive web-based application accessible through a network connection; and
a processing subsystem to manage the real-time supply of multimedia information transmitted from one or more home countries to subscribers in a target country, the processing subsystem coupled to the memory and web-based application manage functions for supplying said multimedia information based on commands entered by a user of the web-based application,
wherein the processing subsystem integrates:
a first software module to control selection of said multimedia information based on subscriber preferences;
a second software module to control ordering of equipment to be installed at a subscriber location for receiving said multimedia information;
a third software module to control shipping of the selected equipment to the subscriber location;
a fourth software module to control installation of the selected equipment at the subscriber location;
a fifth software module to perform a signal activation procedure that allows the equipment installed at the subscriber location to receive said multimedia information; and
a sixth software module to perform subscriber invoicing and account management functions relating to the supply of said received multimedia information.

2. The system of claim 1, wherein said multimedia information includes real-time programming from a selected number of television channels from said one or more home countries.

3. The system of claim 2, wherein the processing subsystem implements the first software module to control selection of a predetermined combination of television channels from different ones of said home countries.

4. The system of claim 1, wherein the processing subsystem implements the third software module to:
select a shipping company and method for delivering the equipment to the subscriber location,
retrieve information from a system database indicating a weight of the equipment; and
compute a cost of delivering the equipment to the subscriber location based on the retrieved weight information and a rate corresponding to the method of delivery from the selected shipping company, the third module making said selection, retrieving said information, and computing said cost based on information import from a server of the shipping company.

5. The system of claim 1, wherein the processing subsystem implements the fourth software module to schedule installation of the equipment at the subscriber location, the fourth software module importing information from a server of an installer to schedule said information.

6. The system of claim 1, wherein the processing subsystem implements the fifth software module to perform said signal activation procedure based on a smart card assigned to the subscriber required to enable the equipment to receive said multimedia information.

7. The system of claim 1, wherein the fifth software module automatically assigns and activates the smart card during processing of a customer order, or assigns and activates the smart card based on control information manually input by a user.

8. The system of claim 1, wherein the processing subsystem implements the sixth software module to automatically generate an invoice based on subscription information corresponding to the subscriber location, to automatically track an account balance corresponding to the subscriber location, or to automatically cancel a corresponding subscription when said account balance is not paid by a predetermined calendar deadline.

9. The system of claim 1, wherein the processing subsystem controls another software module to control different levels of access to one or more of the first through sixth software modules based on a classification of a user.

10. The system of claim 1, wherein the processing subsystem interacts with at least one of the following to control the real-time supply of said multimedia information to subscribers in the target country:
a teleport which controls access to said multimedia information through one or more satellites; or
a cable television system which controls access to said multimedia information through a headend.

11. A method for integrating the management of subscriber services, comprising:
providing access to a web-based application through a network connection; and
managing the real-time supply of multimedia information transmitted from one or more home countries to subscribers in a target country based on commands received through the web-based application, said managing including:
controlling selection of said multimedia information based on subscriber preferences;
controlling ordering of equipment to be installed at a subscriber location for receiving said multimedia information;
controlling shipping of the ordered equipment to the subscriber location;
controlling installation of the ordered equipment at the subscriber location;
performing a signal activation procedure that allows the equipment installed at the subscriber location to receive said multimedia information; and
performing subscriber invoicing and account management functions relating to the supply of said multimedia information.

12. The method of claim 11, further comprising:
controlling inventories of equipment and smart cards to be shipped to subscribers.

13. The method of claim 11, wherein said multimedia information includes real-time programming from a selected number of television channels from said one or more home countries.

14. The method of claim 11, wherein controlling selection of said multimedia includes selecting a predetermined combination of television channels from different ones of said home countries.

15. The method of claim 11, wherein controlling shipping of the selected equipment includes:
electronically selecting a shipping company and method for delivering the equipment to the subscriber location,
electronically retrieving information from a database indicating a weight of the equipment; and
electronically computing a cost of delivering the equipment to the subscriber location based on the retrieved weight information and a rate corresponding to the method of delivery from the selected shipping company, said electronic selecting, retrieving, and computing being performed based on information import from a server of the shipping company.

16. The method of claim 11, wherein controlling installation of said selected equipment includes electronically scheduling installation of the equipment at the subscriber location based on information imported from a server of an installer.

17. The method of claim 11, wherein said signal activation procedure includes is performed based on a smart card assigned to the subscriber required to enable the equipment to receive said multimedia information.

18. The method of claim 11, wherein said subscriber invoicing an account management functions include automatically generating an invoice based on subscription information corresponding to the subscriber location, to automatically track an account balance corresponding to the subscriber location, or to automatically cancel a corresponding subscription when said account balance is not paid by a predetermined calendar deadline.

19. The method of claim 11, further comprising:
controlling different levels of access to a system that manages the real-time supply of said multimedia information, the different levels of accessed being controlled based on a classification of a user.

20. The method of claim 11, further comprising:
causing the system to interact with at least one of the following to control the real-time supply of said multimedia information to subscribers in the target country:
a teleport which controls access to said multimedia information through one or more satellites; or
a cable television system which controls access to said multimedia information through a headend.
